(19) United States
(12) Patent Application Publication
(10) Pub. No.: US 2026/0100534 A1
(43) Pub. Date: Apr. 9, 2026

(54) BOARD WATERPROOFING CONNECTOR

(71) Applicant: Japan Aviation Electronics Industry, Limited, Tokyo (JP)

(72) Inventors: Yusuke OBATA, Tokyo (JP); Yukuya MORISHITA, Tokyo (JP)

(21) Appl. No.: 19/253,580

(22) Filed: Jun. 27, 2025

(30) Foreign Application Priority Data
Oct. 9, 2024 (JP) 2024-176981
Dec. 12, 2024 (JP) 2024-218094

(51) Int. Cl. H01R 13/52; H01R 12/77

(52) U.S. Cl. CPC H01R 13/5202; H01R 12/774

(57) ABSTRACT

A board waterproofing connector includes a circuit board having a flexible plane conductor, a fitting cover having a fitting portion, and a seal member that demonstrates a sealing property and that is sandwiched between the circuit board and the fitting cover. The fitting cover has a lock portion attached to the circuit board, and the circuit board has a locked portion onto which the lock portion is locked. In a state wherein the seal member is sandwiched between the circuit board and the fitting cover, the lock portion of the fitting cover is locked onto the locked portion of the circuit board such that the seal member waterproofs a space between the circuit board and the fitting cover.

### CROSS-REFERENCE TO RELATED APPLICATION

This application is based on and claims priorities to Japanese Patent Application No. 2024-176981 filed on Oct. 9, 2024, and Japanese Patent Application No. 2024-218094 filed on Dec. 12, 2024, the entire disclosures of which are hereby incorporated by reference herein.

### BACKGROUND OF THE INVENTION

### Field of the Invention

The present disclosure relates to a board waterproofing connector.

### Description of the Related Art

Heretofore, a board waterproofing connector that can waterproof terminals of a circuit board has been known. For example, Registered Utility Model Publication No. 3246222 below discloses a board waterproofing connector including a board-side connector (1) including a base (11) and an extended pipe body (12) coupled to the base (11) and having a protrusion formed on a side surface thereof, in which a lower rubber ring (1121) is sandwiched between a circuit board (300) to which terminals (13) are connected and the base (11), as illustrated in FIGS. 65 to 67.

In the board waterproofing connector disclosed in Registered Utility Model Publication No. 3246222, as illustrated in FIG. 66 in particular, the board-side connector (1) is provided with four connector-side screw insertion holes on the inner peripheral side of the lower rubber ring (1121) on its rear surface. Furthermore, as illustrated in FIG. 67 in particular, the circuit board (300) is provided with board-side screw insertion holes at locations corresponding to the connector-side screw insertion holes. That is, the board waterproofing connector disclosed in Registered Utility Model Publication No. 3246222 below is configured such that, when the board-side connector (1) is fixed to the circuit board (300), the connector-side screw insertion holes provided in the board-side connector (1) and the board-side screw insertion holes provided in the circuit board (300) are aligned, and screws are inserted into the board-side screw insertion holes and the connector-side screw insertion holes from the rear surface side of the circuit board (300) for fixing.

Additionally, for example, U.S. Pat. No. 11,608,895 below discloses a board waterproofing connector including a dispensing seal (100) including a base seal (102) provided inside a cavity (310) as illustrated in FIG. 68. By pressing a connector housing (304) toward a circuit board (302) so as to compress the dispensing seal (100), the board waterproofing connector demonstrates sealing property between the circuit board (302) and the connector housing (304).

Note that the reference numerals regarding descriptions of the related art documents are bracketed to be distinguished from those of embodiments of the present disclosure.

However, in the board waterproofing connector disclosed in Registered Utility Model Publication No. 3246222 described above, when the board-side connector (1) is attached to the circuit board (300), there is a possibility that the circuit board (300) may be deformed by the tightening force of the screws. Moreover, due to the structure for inserting the screws, the periphery of the board-side screw insertion hole provided in the circuit board (300) is not appropriately sealed, and there has been a problem that the waterproofing property between the circuit board (300) and the board-side connector (1) is insufficient. Furthermore, this problem occurs prominently in a circuit board having a flexible plane conductor such as a flexible circuit board. Hence, it has been difficult to waterproof a connector including a circuit board having a flexible plane conductor with the related art disclosed in Registered Utility Model Publication No. 3246222 described above.

Meanwhile, U.S. Pat. No. 11,608,895 described above does not disclose a specific way of fixing the connector housing (304) to the circuit board (302). Here, if the connector housing (304) is to be fixed to the circuit board (302) by using frictional force generated between the connector housing (304) and the dispensing seal (100), the connector housing (304) continuously receives a force in a direction spreading toward the outer periphery of the connector housing (304) due to the rubber reaction force received from the dispensing seal (100). This weakens the coupling force between the circuit board (302) and the housing (304), and there has been a problem that the waterproofing property between the circuit board (302) and a connector assembly (300) is not perfect.

Additionally, in the board waterproofing connector disclosed in U.S. Pat. No. 11,608,895 described above, a seal portion between the connector housing (304) and the dispensing seal (100) is covered entirely by the connector housing (304), and therefore the seal portion cannot be viewed from the outside. That is, in the board waterproofing connector disclosed in U.S. Pat. No. 11,608,895 described above, it has been difficult to confirm whether or not the board waterproofing connector is reliably sealed by the seal portion after assembly of the board waterproofing connector.

Moreover, in both the board waterproofing connector disclosed in Registered Utility Model Publication No. 3246222 described above and the board waterproofing connector disclosed in U.S. Pat. No. 11,608,895 described above, when connecting connector-side terminals to board-side terminals, stable connection cannot be ensured unless they are connected by soldering or the like. Hence, there has been a problem that the number of man-hours increases with soldering.

In view of the foregoing, the present disclosure aims to provide a board waterproofing connector that can reliably demonstrate a waterproofing property with a simple structure. The present disclosure also aims to provide a board waterproofing connector in which it can be easily confirmed whether sealing is performed reliably after assembly.

Furthermore, the present disclosure aims to provide a board waterproofing connector that can reduce the number of man-hours required for assembly.

### SUMMARY OF THE INVENTION

A board waterproofing connector of the present disclosure includes: a circuit board having a flexible plane conductor; a fitting cover having a fitting portion into which a mating connector is fitted; and a seal member that demonstrates a sealing property by being sandwiched between the circuit board and the fitting cover. The fitting cover has a lock portion for attaching to the circuit board, the circuit board has a locked portion that is a part onto which the lock portion is locked, and a space between the circuit board and the fitting cover is waterproofed by the seal member by sandwiching the seal member between the circuit board and the fitting cover and locking the lock portion of the fitting cover onto the locked portion of the circuit board.

In other words, in the board waterproofing connector of the present disclosure, by sandwiching the seal member between the circuit board and the fitting cover and locking while pressing the fitting cover against the circuit board, the space between the circuit board and the fitting cover can be reliably waterproofed with a simple configuration. This effect of the present disclosure can be achieved stably even when the circuit board includes a flexible plane conductor.

Additionally, in the board waterproofing connector of the present disclosure, since the seal part where the seal member is sandwiched between the circuit board and the fitting cover is exposed to the outside over the entire fitting cover, the seal part where the seal member is sandwiched between the circuit board and the fitting cover can be viewed from the outside over the entire fitting cover, so that whether the board waterproofing connector is reliably sealed can be easily confirmed.

Additionally, another board waterproofing connector of the present disclosure includes: a circuit board having a flexible plane conductor; a fitting cover having a fitting portion into which a mating connector is fitted and having a holding portion that holds a metal terminal inside the fitting cover; and a seal member that demonstrates a sealing property by being sandwiched by the circuit board and the fitting cover. The fitting cover has a lock portion for attaching to the circuit board, the circuit board has a locked portion that is a part onto which the lock portion is locked, the metal terminal has a held portion held by the holding portion and a spring-like contact portion for contacting the plane conductor, and by holding the held portion of the metal terminal by the holding portion of the fitting cover, sandwiching the seal member between the circuit board and the fitting cover, and locking the lock portion of the fitting cover onto the locked portion of the circuit board, a space between the circuit board and the fitting cover is waterproofed by the seal member while maintaining contact between the contact portion of the metal terminal and the plane conductor by the spring property of the contact portion.

Additionally, in another board waterproofing connector of the present disclosure, the holding portion may be formed as a holding hole into which the metal terminal is inserted and having a hooked portion onto which the metal terminal is hooked, the held portion of the metal terminal may have a projection to be press-fitted into the holding hole and a hook portion to be hooked onto the hooked portion, and the metal terminal may be inserted into the holding hole to press-fit the projection into the holding hole and hook the hook portion onto the hooked portion, so that the metal terminal is held inside the fitting cover.

In other words, in the other board waterproofing connector of the present disclosure, since the spring property of the contact portion of the metal terminal maintains the contact between the contact portion and the circuit board, there is no need to fixedly connect the metal terminal to the circuit board by soldering or brazing in advance, and the number of man-hours required for assembly of the board waterproofing connector can be reduced.

Additionally, in another board waterproofing connector of the present disclosure, the fitting cover may be formed integrally with the holding portion.

Additionally, in another board waterproofing connector of the present disclosure, the fitting cover may include at least a fitting cover main body portion including the fitting portion, a first insulator including the holding portion, and a second insulator joined to the first insulator, and the board waterproofing connector may be formed by forming an insulator joint body in which the second insulator is joined to the first insulator with the held portion of the metal terminal held by the holding portion of the first insulator, and inserting the insulator joint body in the fitting cover main body portion.

Additionally, in another board waterproofing connector of the present disclosure, the metal terminal may have a substantial L shape, have the contact portion on one end side, and have the held portion on the other end side, and a straight portion of the metal terminal on the one end side may be sandwiched by the first insulator and the second insulator to support the metal terminal.

Additionally, in the board waterproofing connector of the present disclosure or another board waterproofing connector of the present disclosure, the circuit board may have a lining portion on a surface opposite to the surface on which the fitting cover is provided, and the locked portion may be formed in a part where the lining portion is provided.

Additionally, in the board waterproofing connector of the present disclosure or another board waterproofing connector of the present disclosure, the circuit board may have a cover member on a surface opposite to the surface on which the fitting cover is provided, and the locked portion may be formed in the cover member.

Additionally, in the board waterproofing connector of the present disclosure or another board waterproofing connector of the present disclosure, the lock portion of the fitting cover may be a lock claw having a claw shape.

Additionally, in the board waterproofing connector of the present disclosure or another board waterproofing connector of the present disclosure, the seal member may be formed of any of a rubber material, a plastic material, and an elastomeric material.

Additionally, in the board waterproofing connector of the present disclosure or another board waterproofing connector of the present disclosure, the seal member may have a through-hole into which the lock portion is insertable.

Additionally, in the board waterproofing connector of the present disclosure or another board waterproofing connector of the present disclosure, the fitting cover and the seal member may be formed as a single piece by two-color molding.

Furthermore, in the board waterproofing connector of the present disclosure or another board waterproofing connector of the present disclosure, the cover member may have a protrusion protruding toward the plane conductor, and the protrusion may press the seal member via the plane conductor.

According to the present disclosure, it is possible to provide a board waterproofing connector that can reliably demonstrate a waterproofing property with a simple structure. It is also possible to provide a board waterproofing connector in which it can be easily confirmed whether sealing is performed reliably after assembly.

Furthermore, according to the present disclosure, it is possible to provide a board waterproofing connector that can reduce the number of man-hours required for assembly.

### BRIEF DESCRIPTION OF THE DRAWINGS

FIG. 1 is a perspective view of a board waterproofing connector according to a first embodiment as viewed from the front upper side;

FIG. 2 is a perspective view of the board waterproofing connector according to the first embodiment as viewed from the back lower side;

FIG. 3 is a front view of the board waterproofing connector according to the first embodiment;

FIG. 4 is a right side view of the board waterproofing connector according to the first embodiment;

FIG. 5 is a longitudinal sectional view taken along line V-V of FIG. 3;

FIG. 6 is a longitudinal sectional view taken along line VI-VI of FIG. 4;

FIG. 7 is an exploded perspective view of the board waterproofing connector according to the first embodiment as viewed from the front upper side;

FIG. 8 is an exploded perspective view of the board waterproofing connector according to the first embodiment as viewed from the back lower side;

FIGS. 9A and 9B are diagrams, each illustrating a disassembled state of a circuit board included in the board waterproofing connector according to the first embodiment. FIG. 9A is an exploded perspective view of the circuit board as viewed from the front upper side, and FIG. 9B is an exploded perspective view of the circuit board as viewed from the back lower side;

FIGS. 10A and 10B are diagrams, each illustrating a connector assembly including the board waterproofing connector according to the first embodiment. FIG. 10A illustrates a state before the board waterproofing connector according to the first embodiment and a mating connector are fitted together, and FIG. 10B illustrates a state after the board waterproofing connector according to the first embodiment and the mating connector are fitted together;

FIG. 11 is a front view of the connector assembly including the board waterproofing connector according to the first embodiment;

FIG. 12 is a longitudinal sectional view taken along line XII −XII of FIG. 11;

FIG. 13 is a longitudinal sectional view taken along line XIII −XIII of FIG. 11;

FIGS. 14A and 14B are diagrams, each illustrating a disassembled state of a circuit board included in a board waterproofing connector according to a second embodiment. FIG. 14A is an exploded perspective view of the circuit board as viewed from the front upper side, and FIG. 14B is an exploded perspective view of the circuit board as viewed from the back lower side;

FIGS. 15A and 15B are diagrams, each illustrating the circuit board included in the board waterproofing connector according to the second embodiment. FIG. 15A is a perspective view of the circuit board as viewed from the front upper side, and FIG. 15B is a perspective view of the circuit board as viewed from the back lower side; FIG. 16 is an exploded perspective view of the board waterproofing connector according to the second embodiment as viewed from the front upper side;

FIG. 17 is an exploded perspective view of the board waterproofing connector according to the second embodiment as viewed from the back lower side;

FIG. 18 is a perspective view of the board waterproofing connector according to the second embodiment as viewed from the front upper side;

FIG. 19 is a front view of the board waterproofing connector according to the second embodiment;

FIG. 20 is a longitudinal sectional view taken along line XX −XX of FIG. 19;

FIGS. 21A and 21B are diagrams, each illustrating a possible modification example of the board waterproofing connector of the present disclosure. FIG. 21A is an exploded perspective view, and FIG. 21B is a perspective view as viewed from the front upper side;

FIGS. 22A and 22B are diagrams, each illustrating another possible modification example of the board waterproofing connector of the present disclosure. FIG. 22A is an exploded perspective view, and FIG. 22B is a perspective view as viewed from the front upper side;

FIGS. 23A to 23C are diagrams, each describing how to attach a cover member to a plane conductor according to yet another possible modification example of the board waterproofing connector of the present disclosure. FIG. 23A illustrates a state before attaching the cover member to the plane conductor, FIG. 23B illustrates a state in which the cover member is vertically raised toward the plane conductor, and FIG. 23C illustrates a state in which the cover member is slid to the right from the state of FIG. 23B to fix the cover member to the plane conductor;

FIG. 24 is a front view of a board waterproofing connector according to yet another possible modification example of the board waterproofing connector of the present disclosure;

FIG. 25 is a right side view of a board waterproofing connector according to yet another possible modification example of the board waterproofing connector of the present disclosure;

FIG. 26 is a longitudinal sectional view taken along line XXVI −XXVI of FIG. 24;

FIG. 27 is a longitudinal sectional view taken along line XXVII −XXVII of FIG. 25;

FIG. 28 is a perspective view of a board waterproofing connector according to a third embodiment as viewed from the front upper side;

FIG. 29 is a perspective view of the board waterproofing connector according to the third embodiment as viewed from the back lower side;

FIG. 30 is a front view of the board waterproofing connector according to the third embodiment;

FIG. 31 is a right side view of the board waterproofing connector according to the third embodiment;

FIG. 32 is a longitudinal sectional view taken along line XXXII −XXXII of FIG. 30;

FIG. 33 is a longitudinal sectional view taken along line XXXIII −XXXIII of FIG. 30;

FIG. 34 is a longitudinal sectional view taken along line XXXIV −XXXIV of FIG. 31;

FIG. 35 is an exploded perspective view of the board waterproofing connector according to the third embodiment as viewed from the front upper side;

FIG. 36 is an exploded perspective view of the board waterproofing connector according to the third embodiment as viewed from the back lower side;

FIGS. 37A and 37B are diagrams, each illustrating a disassembled state of a circuit board included in the board waterproofing connector according to the third embodiment, in which FIG. 37A is an exploded perspective view of the circuit board as viewed from the front upper side, and FIG. 37B is an exploded perspective view of the circuit board as viewed from the back lower side;

FIGS. 38A and 38B are diagrams, each illustrating a fitting cover and a metal terminal included in the board waterproofing connector according to the third embodiment. FIG. 38A is an exploded perspective view of the fitting cover and the metal terminal as viewed from the front upper side, and FIG. 38B is an exploded perspective view of the fitting cover and the metal terminal as viewed from the back lower side;

FIGS. 39A and 39B are diagrams, each illustrating the fitting cover included in the board waterproofing connector according to the third embodiment. FIG. 39A is a plan view and FIG. 39B is a bottom view;

FIG. 40 is a right side view of the metal terminal included in the board waterproofing connector according to the third embodiment;

FIGS. 41A and 41B are diagrams, each illustrating a connector assembly including the board waterproofing connector according to the third embodiment. FIG. 41A illustrates a state before the board waterproofing connector according to the third embodiment and a mating connector are fitted together, and FIG. 41B illustrates a state after the board waterproofing connector according to the third embodiment and the mating connector are fitted together;

FIG. 42 is a front view of the connector assembly including the board waterproofing connector according to the third embodiment;

FIG. 43 is a longitudinal sectional view taken along line XXXXIII −XXXXIII of FIG. 42;

FIG. 44 is a longitudinal sectional view taken along line XXXXIV −XXXXIV of FIG. 42;

FIGS. 45A and 45B are diagrams, each illustrating a disassembled state of a circuit board included in a board waterproofing connector according to a fourth embodiment. FIG. 45A is an exploded perspective view of the circuit board as viewed from the front upper side, and FIG. 45B is an exploded perspective view of the circuit board as viewed from the back lower side;

FIGS. 46A and 46B are diagrams, each illustrating the circuit board included in the board waterproofing connector according to the fourth embodiment. FIG. 46A is a perspective view of the circuit board as viewed from the front upper side, and FIG. 46B is a perspective view of the circuit board as viewed from the back lower side;

FIG. 47 is an exploded perspective view of the board waterproofing connector according to the fourth embodiment as viewed from the front upper side;

FIG. 48 is an exploded perspective view of the board waterproofing connector according to the fourth embodiment as viewed from the back lower side;

FIG. 49 is a perspective view of the board waterproofing connector according to the fourth embodiment as viewed from the front upper side;

FIG. 50 is a front view of the board waterproofing connector according to the fourth embodiment;

FIG. 51 is a longitudinal sectional view taken along line XXXXXI −XXXXXI of FIG. 50;

FIG. 52 is a longitudinal sectional view taken along line XXXXXII −XXXXXII of FIG. 50;

FIG. 53 is a perspective view of a board waterproofing connector according to a fifth embodiment as viewed from the front upper side;

FIG. 54 is a perspective view of the board waterproofing connector according to the fifth embodiment as viewed from the back lower side;

FIG. 55 is a front view of the board waterproofing connector according to the fifth embodiment;

FIG. 56 is a right side view of the board waterproofing connector according to the fifth embodiment;

FIG. 57 is a longitudinal sectional view taken along line XXXXXVII −XXXXXVII of FIG. 55;

FIG. 58 is a longitudinal sectional view taken along line XXXXXVIII −XXXXXVIII of FIG. 56;

FIG. 59 is an exploded perspective view of the board waterproofing connector according to the fifth embodiment as viewed from the front upper side;

FIG. 60 is an exploded perspective view of the board waterproofing connector according to the fifth embodiment as viewed from the back lower side;

FIGS. 61A and 61B are diagrams, each illustrating a fitting cover and a metal terminal included in the board waterproofing connector according to the fifth embodiment. FIG. 61A is a partially exploded perspective view of the fitting cover and the metal terminal as viewed from the front upper side, and FIG. 61B is a partially exploded perspective view of the fitting cover and the metal terminal as viewed from the back lower side;

FIGS. 62A and 62B are diagrams, each illustrating a first insulator, a second insulator, and the metal terminal included in the board waterproofing connector according to the fifth embodiment. FIG. 62A is an exploded perspective view of the first insulator, the second insulator, and the metal terminal as viewed from the front upper side, and FIG. 62B is an exploded perspective view of the first insulator, the second insulator, and the metal terminal as viewed from the back lower side;

FIGS. 63A and 63B are diagrams, each illustrating the first insulator and the second insulator included in the board waterproofing connector according to the fifth embodiment. FIG. 63A is a back view of the first insulator, and FIG. 63B is a front view of the second insulator;

FIGS. 64A and 64B are diagrams, each illustrating the metal terminal included in the board waterproofing connector according to the fifth embodiment. FIG. 64A is a perspective view of the metal terminal as viewed from the front upper side, and FIG. 64B is a right side view of the metal terminal;

FIG. 65 is a partial cross-sectional view of a connector assembly disclosed in Registered Utility Model Publication No. 3246222;

FIG. 66 is a perspective view of a board-side connector forming the connector assembly disclosed in Registered Utility Model Publication No. 3246222 as viewed from the back lower side;

FIG. 67 is an exploded perspective view of the connector assembly disclosed in Registered Utility Model Publication No. 3246222; and

FIG. 68 is a longitudinal sectional view of a board waterproofing connector disclosed in U.S. Pat. No. 11,608,895.

### DETAILED DESCRIPTION OF THE INVENTION

Hereinafter, suitable embodiments for carrying out the present disclosure will be described with reference to the drawings. Note that in the drawings, a first direction, a second direction, and a third direction are defined for the sake of description. In the present specification, the first direction is the front-rear direction. In the drawings, the front-rear direction is indicated as an X direction. In particular, the front is referred to as a +X direction and the rear is referred to as a −X direction. Additionally, in the present specification, the second direction is the left-right direction. In the drawings, the left-right direction is indicated as a Y direction. In particular, the right is referred to as a +Y direction and the left is referred to as a −Y direction. Moreover, in the present specification, the third direction is the up-down direction. In the drawings, the up-down direction is indicated as a Z direction. In particular, the upper side is referred to as a +Z direction and the lower side is referred to as a −z direction. Note, however, that the X direction as the first direction, the Y direction as the second direction, and the Z direction as the third direction defined in the present specification do not limit the directions during use of the board waterproofing connector of the present disclosure. The board waterproofing connector of the present disclosure can be used in any direction.

Moreover, the following embodiments and modification examples do not limit the inventions according to the claims, and not all of combinations of characteristics described in the embodiments and the modification examples are essential for solutions of the invention.

### First Embodiment

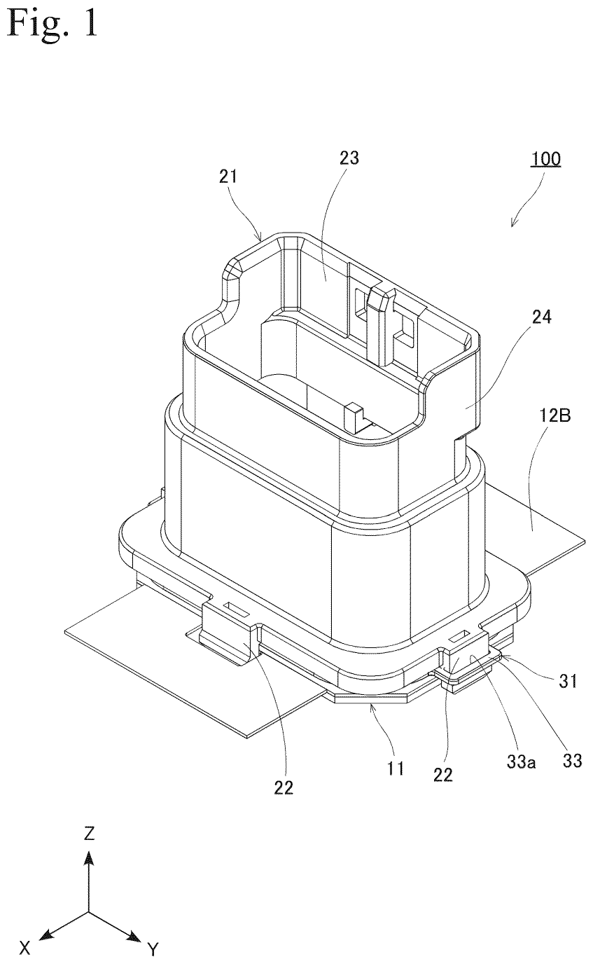

First, a configuration of a board waterproofing connector 100 according to a first embodiment will be described with reference to FIGS. 1 to 13. As illustrated in FIGS. 1 to 8, the board waterproofing connector 100 according to the first embodiment includes a circuit board 11, a terminal 41 connected to the circuit board 11, a fitting cover 21 having a fitting portion 23 into which a mating connector 110 to be described later is fitted, and a seal member 31 that demonstrates a sealing property by being sandwiched between the circuit board 11 and the fitting cover 21.

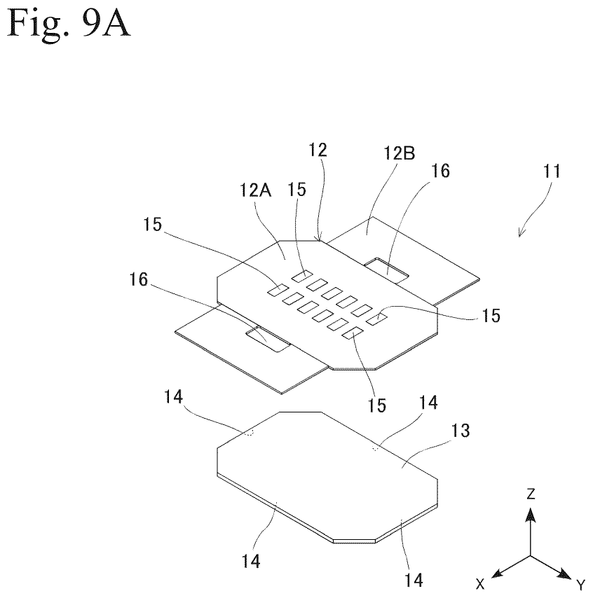

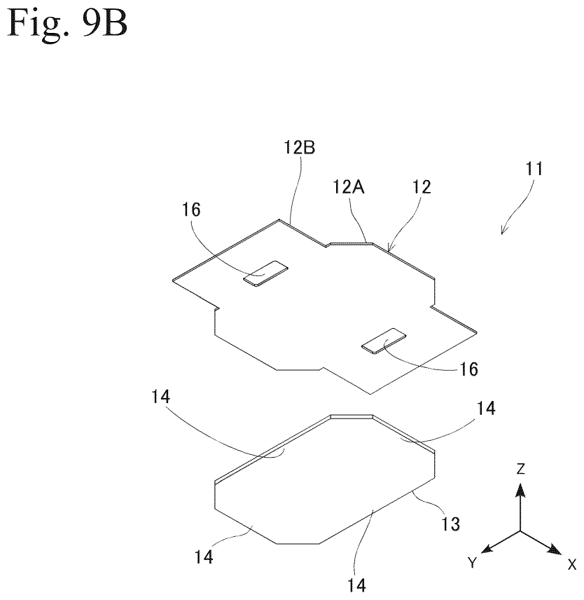

As illustrated in FIG. 9A and B, the circuit board 11 includes a flexible plane conductor 12 and a lining portion 13 on a rear surface of the plane conductor 12. In the first embodiment, the rear surface of the flexible plane conductor 12 on which the lining portion 13 is provided is a surface opposite to the surface on which the fitting cover 21 is placed on the circuit board 11. In addition, in the first embodiment, a flexible printed circuit (FPC) is used as the plane conductor 12. Note that any flexible circuit board other than the FPC, such as a flexible flat cable (FFC), can be used as the circuit board 11. Moreover, a rigid circuit board that is not flexible or any flat plate-shaped member can be used.

The plane conductor 12 includes a terminal forming portion 12A and an extension portion 12B extending in the front-rear direction (±X direction) as the first direction from the terminal forming portion 12A. The terminal forming portion 12A has a plurality of connection portions 15 at its center, and a plurality of pins 42 of the later-described terminal 41 can be connected to the plurality of connection portions 15. The extension portion 12B has a plane conductor penetration hole 16 penetrating in the up-down direction (±Z direction) as the third direction, and a lock portion of the later-described fitting cover 21 can be inserted therethrough.

The lining portion 13 is attached to the entire rear surface of the terminal forming portion 12A to prevent deformation of the flexible terminal forming portion 12A. The lining portion 13 also includes, in parts at its front center, rear center, left center, and right center, a locked portion 14 onto which a lock claw 22 as the lock portion of the later-described fitting cover 21 can be locked. Note that in the first embodiment, the lining portion 13 is attached to the entire rear surface of the terminal forming portion 12A. However, the range in which the lining portion 13 is provided only needs to include the range of the locked portion 14 onto which the lock portion of the fitting cover 21 can be locked. That is, the lining portion 13 may be provided for a partial region of the rear surface of the terminal forming portion 12A.

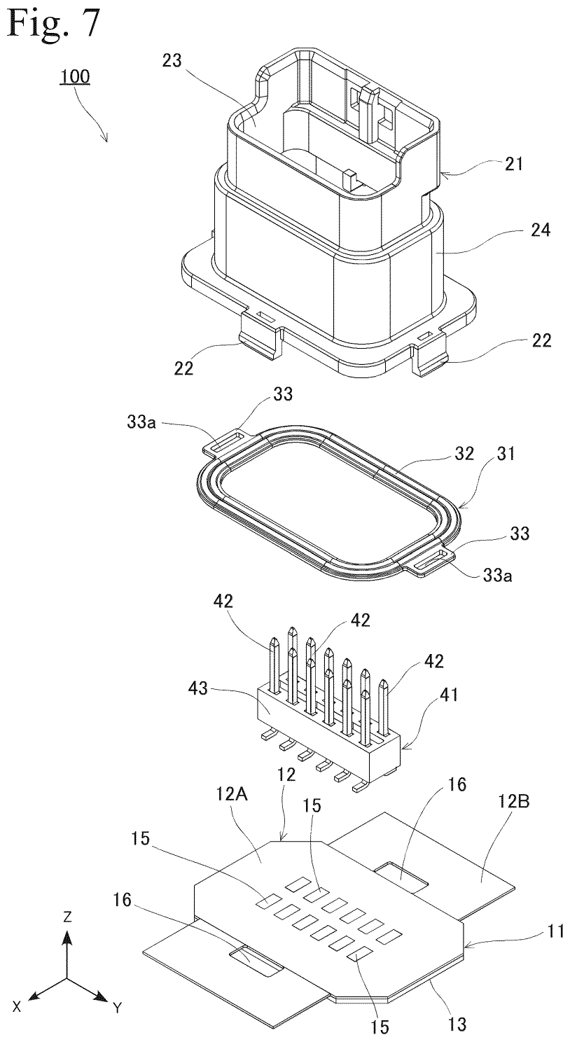

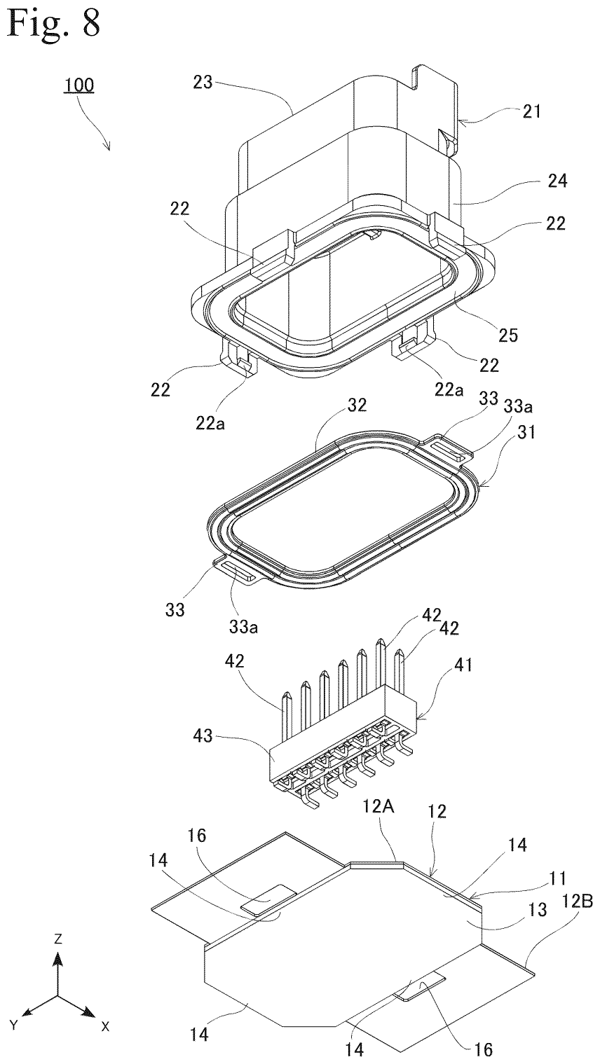

As illustrated in FIGS. 7 and 8, the fitting cover 21 includes the fitting portion 23 open in the up-down direction (±Z direction) as the third direction and into which the mating connector 110 to be described later is fitted from above the opening, a fitting cover main body portion 24 formed so as to cover the periphery of the opening, and the lock claw 22 as the lock portion formed in a central lower part of each peripheral surface of the fitting cover main body portion 24.

A seal receiving surface 25 into which the seal member 31 comes into contact is formed in a lower end surface of the fitting cover main body portion 24. The lock claw 22 extends downward and has a portion formed as a claw shape 22a protruding toward the central direction of the fitting cover main body portion 24 (toward the inside of the fitting cover main body portion 24), and the claw shape 22a can be hooked onto the locked portion 14 of the circuit board 11.

The seal member 31 can be formed of any of a rubber material, a plastic material, or an elastomeric material. The seal member 31 according to the first embodiment is formed of a rubber material, for example, and as illustrated in FIG. 8, includes a seal main body portion 32 whose upper surface comes into contact with the seal receiving surface 25 formed in the fitting cover 21, and a pair of ring-shaped through-holes 33a respectively penetrating a pair of flange portions 33 protruding in the left-right direction (±Y direction) as the second direction.

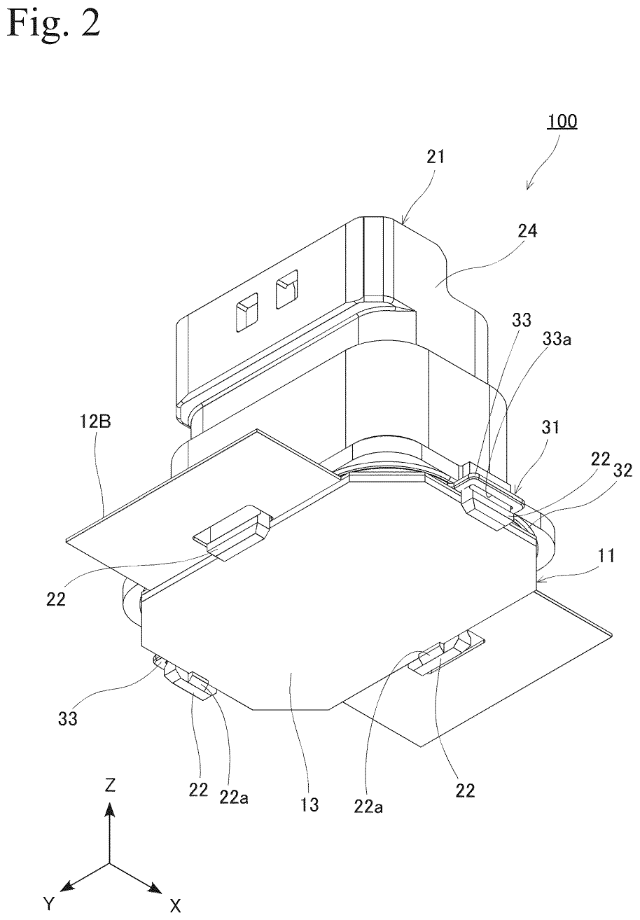

The through-hole 33a is formed at the left center and the right center of the seal main body portion 32, and allows insertion of the left and right lock claws 22 formed in the fitting cover main body portion 24 (see FIGS. 1 and 2). As describe above, by forming the through-hole 33a through which the lock claw 22 can be inserted in the seal member 31 and inserting the left and right lock claws 22 formed in the fitting cover main body portion 24 into the pair of through-holes 33a to attach the seal member 31 to the fitting cover 21 in advance, it is possible to easily position the seal member 31 when sandwiching the seal member 31 between the fitting cover 21 and the circuit board 11, and facilitate assembly of the board waterproofing connector 100. Note that while the seal member 31 includes the two through-holes 33a at the left center and the right center in the first embodiment, the through-hole 33a of the present disclosure can be formed by adopting any number and location corresponding to the number and location of the lock claws 22 of the fitting cover 21. Additionally, it is sufficient that the through-hole 33a allows insertion of one or more lock claws 22 of the fitting cover 21.

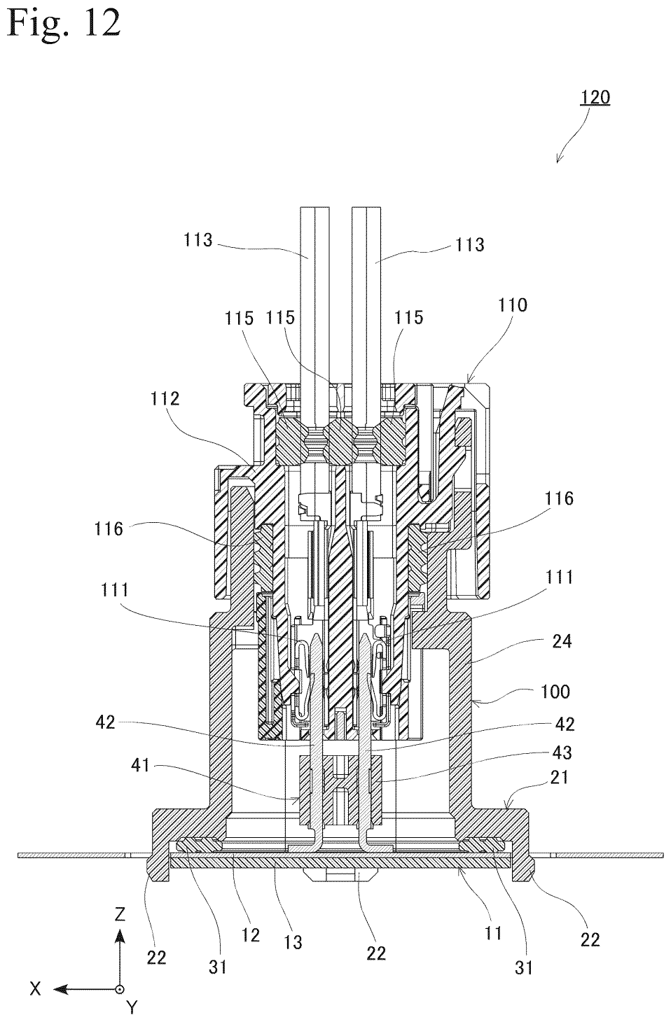

The terminal 41 includes the plurality of pins 42 and a pin holding portion 43 holding the plurality of pins 42. As illustrated in FIG. 12, the plurality of pins 42 are configured to deliver electric signals, electric power, and the like by electrically connecting with a mating terminal 111 of the mating connector 110 while being connected to the plurality of connection portions 15 of the circuit board 11.

Here, the way of assembling the board waterproofing connector 100 of the first embodiment will be described. First, as illustrated in FIGS. 7 and 8, the circuit board 11 is assembled by installing the lining portion 13 on the rear surface of the terminal forming portion 12A of the plane conductor 12. Next, the plurality of pins 42 of the terminal 41 are connected and fixed to the plurality of connection portions 15 formed in the plane conductor 12 of the circuit board 11. This connecting and fixing can be done by using a method such as soldering or brazing. Furthermore, by inserting the lock claw 22 of the fitting cover 21 into the through-hole 33a of the seal member 31, the seal member 31 is positioned and temporarily installed in the fitting cover 21. Thereafter, the lock claw 22 of the fitting cover 21 is pressed downward (in −Z direction) which is toward the circuit board 11, so that, as illustrated in FIGS. 2 to 6, the part of the claw shape 22a of the lock claw 22 is hooked onto the locked portion 14 formed in the lining portion 13 to lock the lock claw 22 and the locked portion 14 together, and assembly of the board waterproofing connector 100 of the first embodiment is completed.

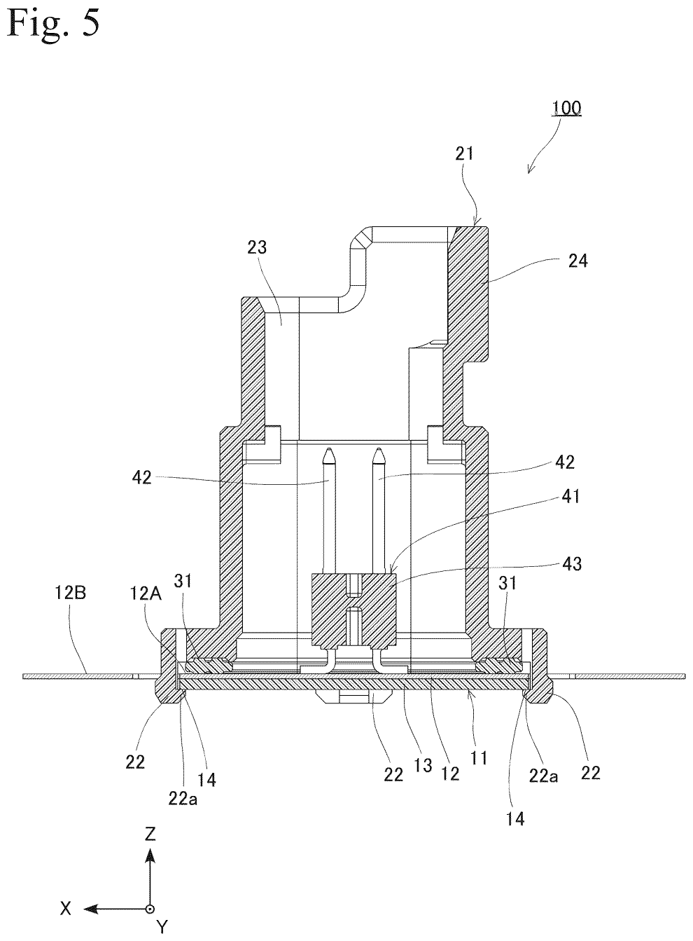

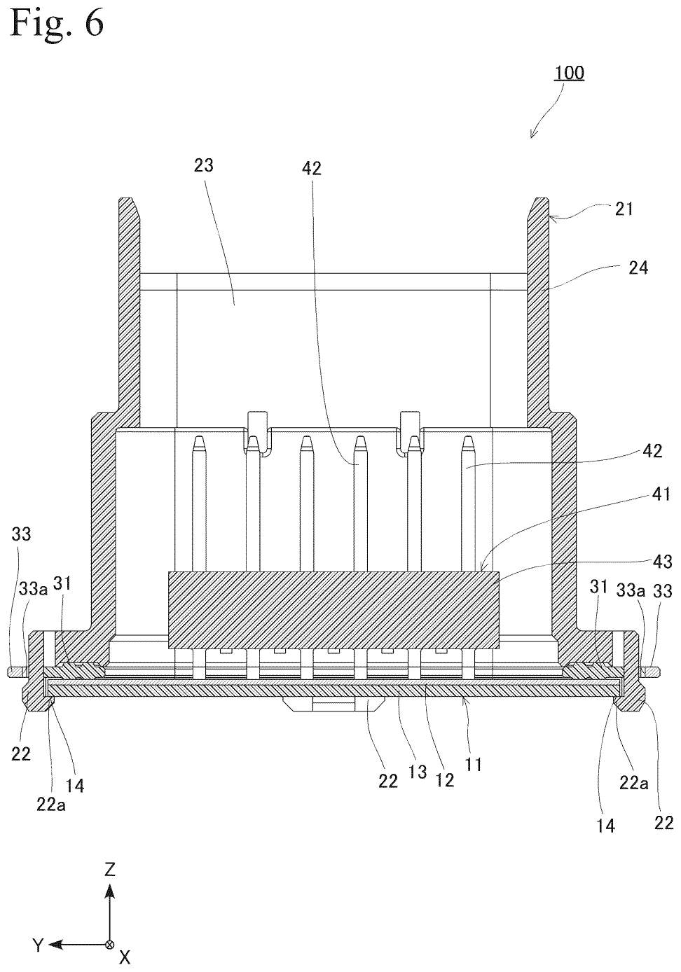

As illustrated in FIGS. 5 and 6, in the board waterproofing connector 100 of the first embodiment, since the fitting cover 21 can be locked while being pressed against the circuit board 11 with the seal member 31 sandwiched between the circuit board 11 and the fitting cover 21, it is possible to appropriately waterproof the space between the circuit board 11 and the fitting cover 21. At this time, as illustrated in FIG. 5 in particular, the parts of the claw shapes 22a of the two lock claws 22 provided at the front and the rear of the fitting cover 21 are hooked onto the parts of the locked portion 14 formed at the front and the rear of the lining portion 13 of the circuit board 11, whereby the circuit board 11 and the fitting cover 21 are reliably fixed and held in the front-rear direction and the up-down direction. Additionally, as illustrated in FIG. 6 in particular, the parts of the claw shapes 22a of the two lock claws 22 installed on the left and the right of the fitting cover 21 are hooked onto the parts of the locked portion 14 formed on the left and the right of the lining portion 13 of the circuit board 11, whereby the circuit board 11 and the fitting cover 21 are reliably fixed and held in the left-right direction and the up-down direction. As a result, the board waterproofing connector 100 that reliably waterproofs the space between the circuit board 11 and the fitting cover 21 with a simple configuration can be implemented.

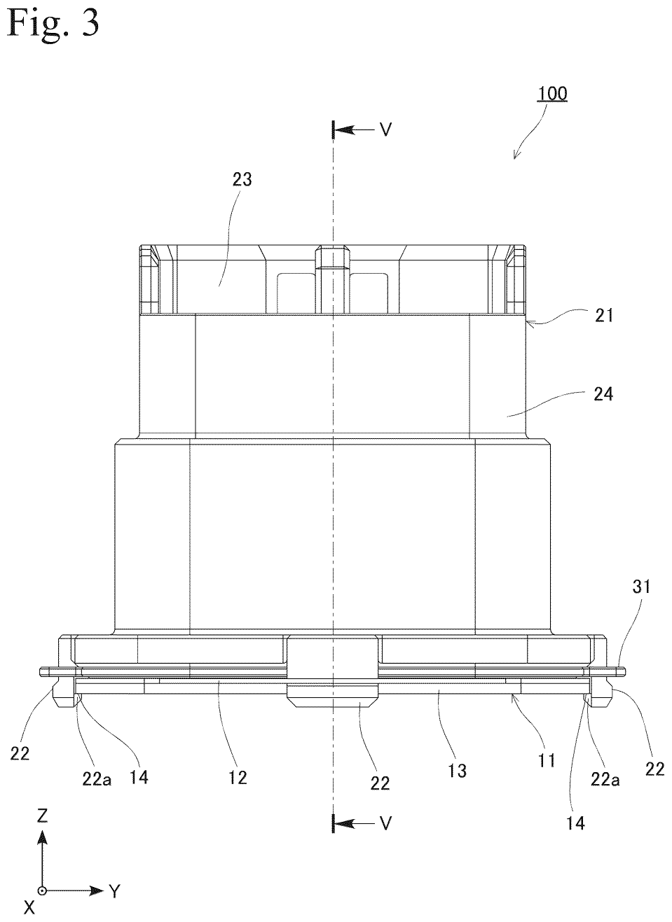

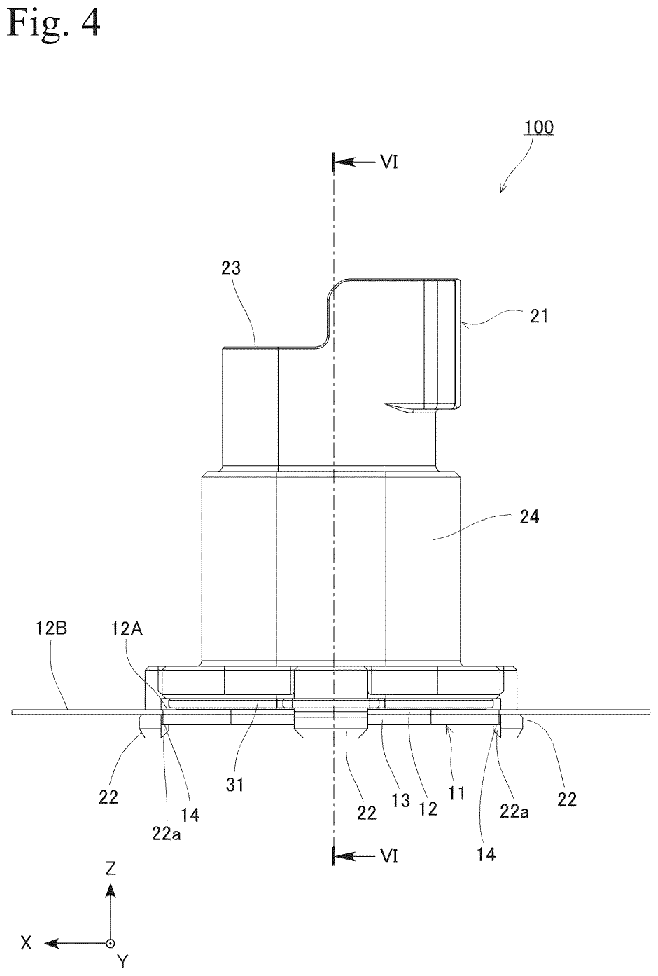

Furthermore, as is clear from FIGS. 3 and 4, in the board waterproofing connector 100 of the first embodiment, the seal member 31 is exposed over the entire fitting cover 21 except for a part where the lock claw 22 is formed. With such a configuration, according to the board waterproofing connector 100 of the first embodiment, the seal part where the seal member 31 is sandwiched between the circuit board 11 and the fitting cover 21 can be viewed from the outside over the entire fitting cover 21, so that whether the board waterproofing connector 100 is reliably sealed can be easily confirmed.

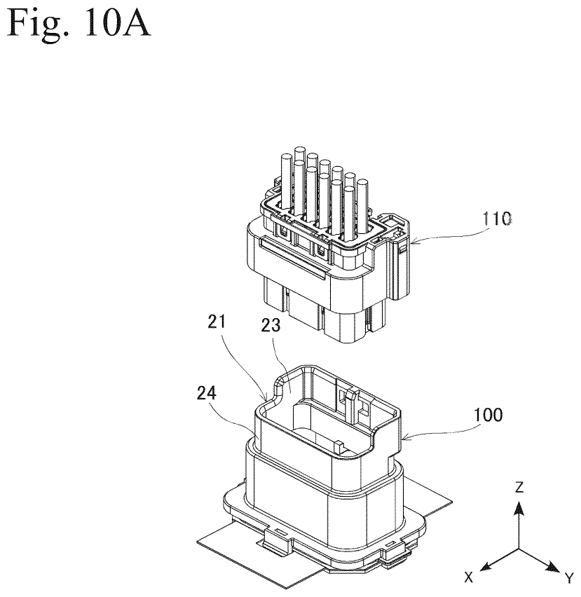

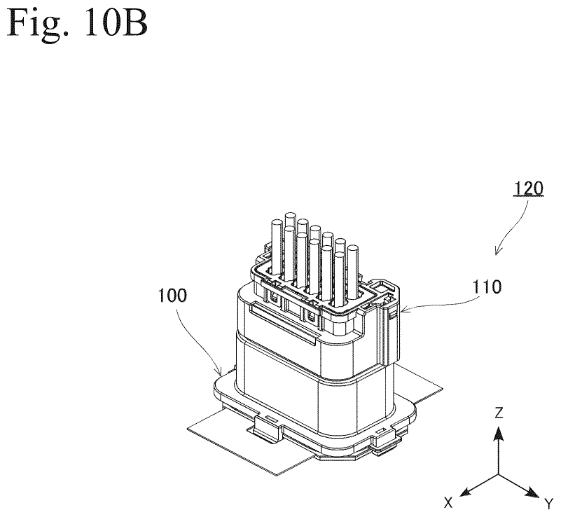

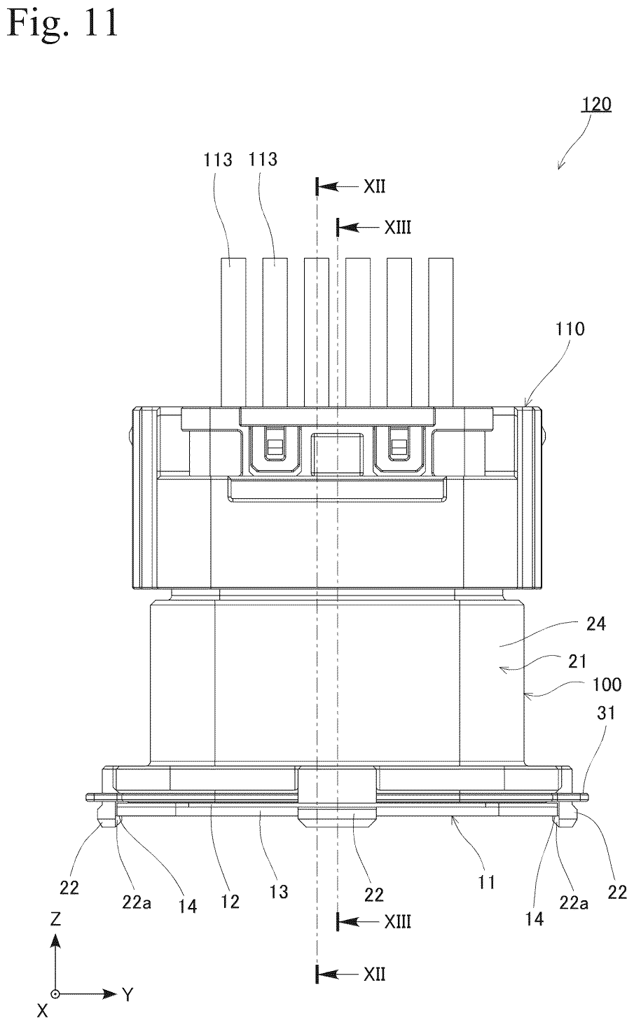

Additionally, as illustrated in FIGS. 10A to 11, in the board waterproofing connector 100 of the first embodiment, a connector assembly 120 can be formed by fitting the mating connector 110 into the fitting portion 23 of the fitting cover 21.

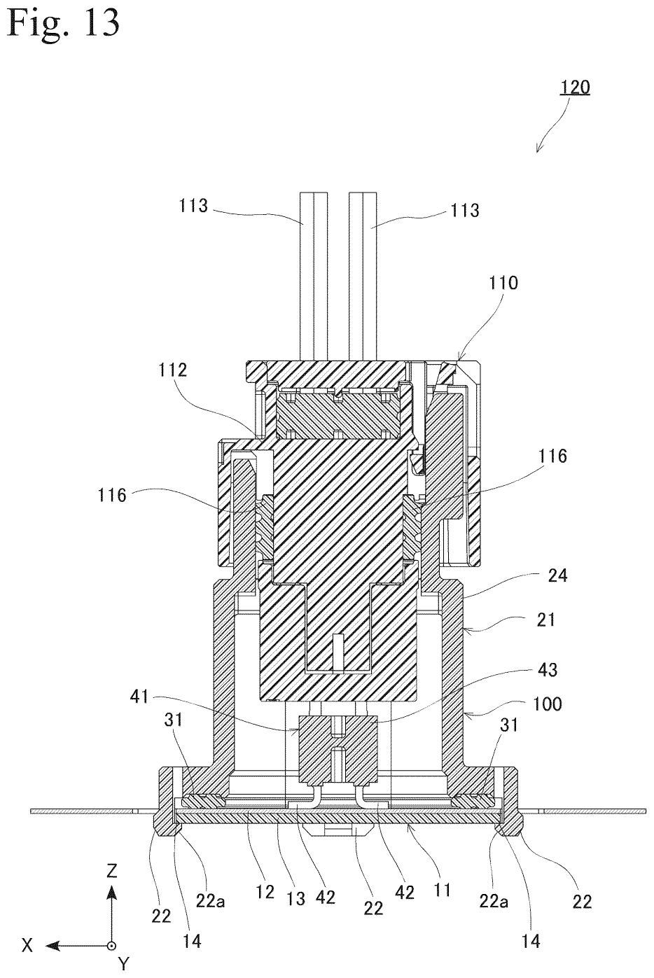

Here, as illustrated in FIG. 12, in the mating connector 110, a first waterproof member 115 is disposed between a mating cable 113 of the mating connector 110 and a mating housing 112 covering a side surface of the mating terminal 111. Additionally, the first waterproof member 115 is also disposed between a plurality of mating cables 113. Moreover, as illustrated in FIGS. 12 and 13, when the board waterproofing connector 100 according to the first embodiment and the mating connector 110 are fitted together, a second waterproof member 116 is disposed between the mating housing 112 and the fitting cover main body portion 24. That is, when the mating connector 110 is fitted into the board waterproofing connector 100 of the first embodiment, a gap formed between the board waterproofing connector 100 and the mating connector 110 can be sealed with the first waterproof member 115 and the second waterproof member 116, whereby the space between the board waterproofing connector 100 and the mating connector 110 can be waterproofed reliably. Moreover, as described above, by locking the lock claw 22 of the fitting cover 21 onto the locked portion 14 of the circuit board 11 with the seal member 31 sandwiched between the circuit board 11 and the fitting cover 21, the space between the circuit board 11 and the fitting cover 21 can be waterproofed reliably. That is, as illustrated in FIGS. 12 and 13, by fitting the mating connector 110 into the fitting portion 23 of the fitting cover 21 of the board waterproofing connector 100 of the first embodiment, the connector assembly 120 having a complete waterproofing effect can be obtained.

Hereinabove, the first embodiment which is a possible embodiment of the board waterproofing connector of the present disclosure has been described with reference to FIGS. 1 to 13. Note, however, that the technical scope of the present disclosure is not limited to the scope described in the above first embodiment. Various modifications and improvements can be made in the above first embodiment. Therefore, other embodiment examples and modification examples of the various possible embodiment examples of the board waterproofing connector of the present disclosure will be described below. Note that in the embodiments and the modification examples described below, members that are the same as or similar to the above first embodiment are assigned the same reference numerals and descriptions thereof are omitted.

### Second Embodiment

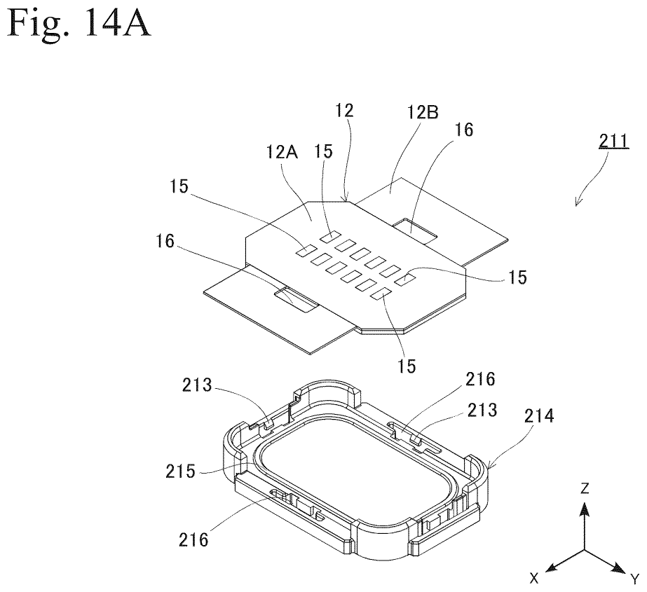

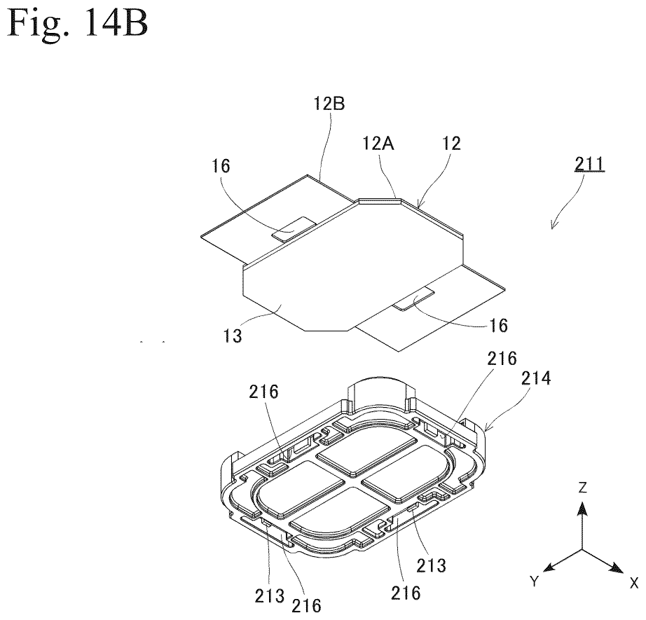

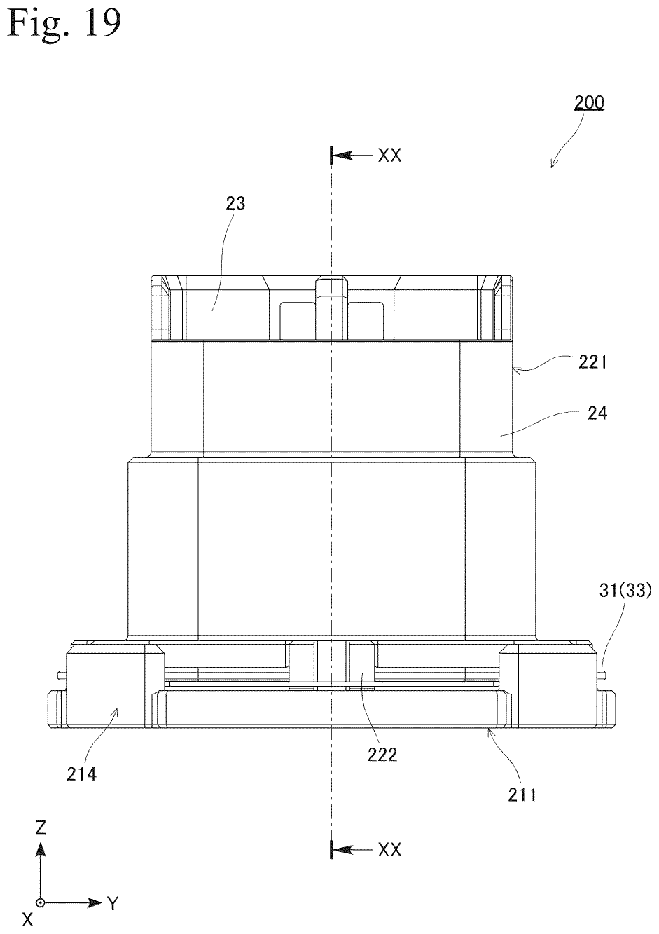

A board waterproofing connector 200 according to a second embodiment will be described with reference to FIGS. 14A to 20.

As illustrated in FIGS. 16 to 18, the board waterproofing connector 200 according to the second embodiment includes a circuit board 211, a terminal 41 connected to the circuit board 211, a fitting cover 221 having a fitting portion 23 into which a mating connector 110 is fitted, and a seal member 31 that demonstrates a sealing property by being sandwiched between the circuit board 211 and the fitting cover 221.

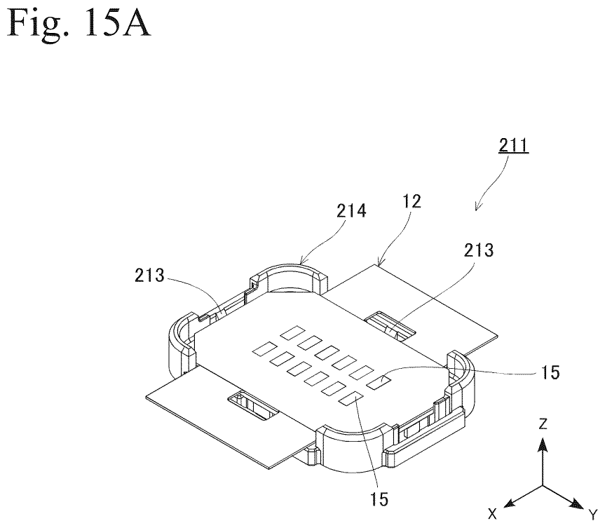

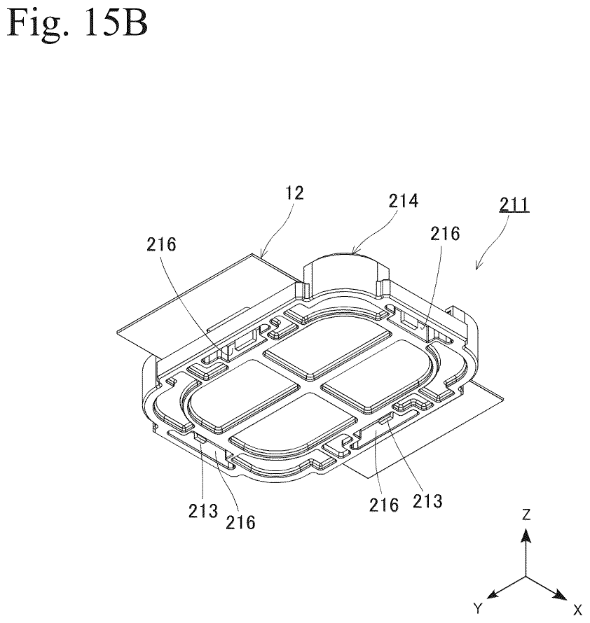

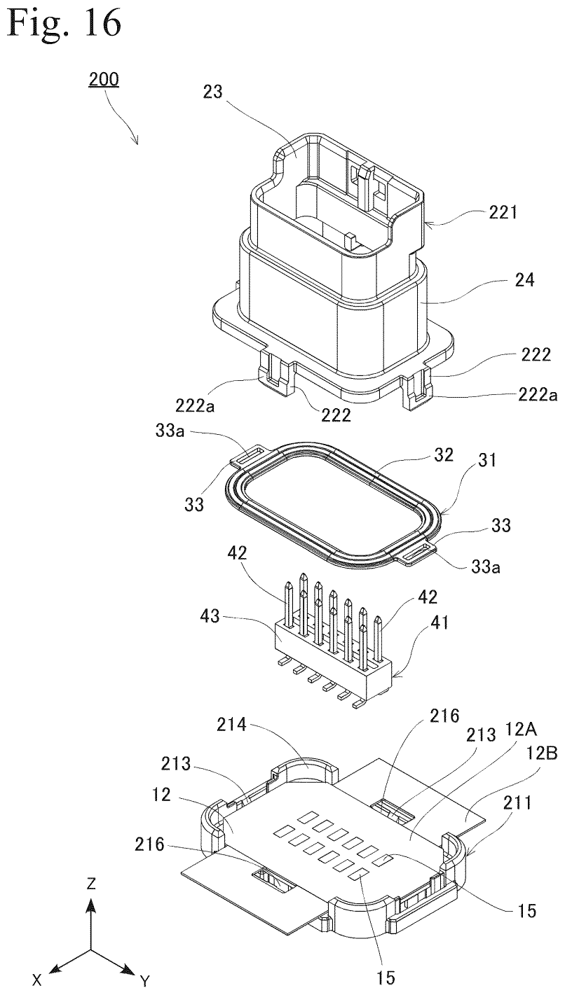

As illustrated in FIGS. 14A to 15B, the circuit board 211 includes a flexible plane conductor 12, a lining portion 13 provided on the rear side of a terminal forming portion 12A of the plane conductor 12, and a cover member 214 formed so as to cover the terminal forming portion 12A and the lining portion 13 from the rear side.

The cover member 214 includes a protrusion 215 protruding upward (in +Z direction) which toward the circuit board 211, a cover member penetration hole 216 through which a lock claw 222 of the fitting cover 221 can be inserted, and a locked portion 213 formed on an inner wall of the cover member penetration hole 216 and onto which a claw shape 222a of the lock claw 222 can be locked.

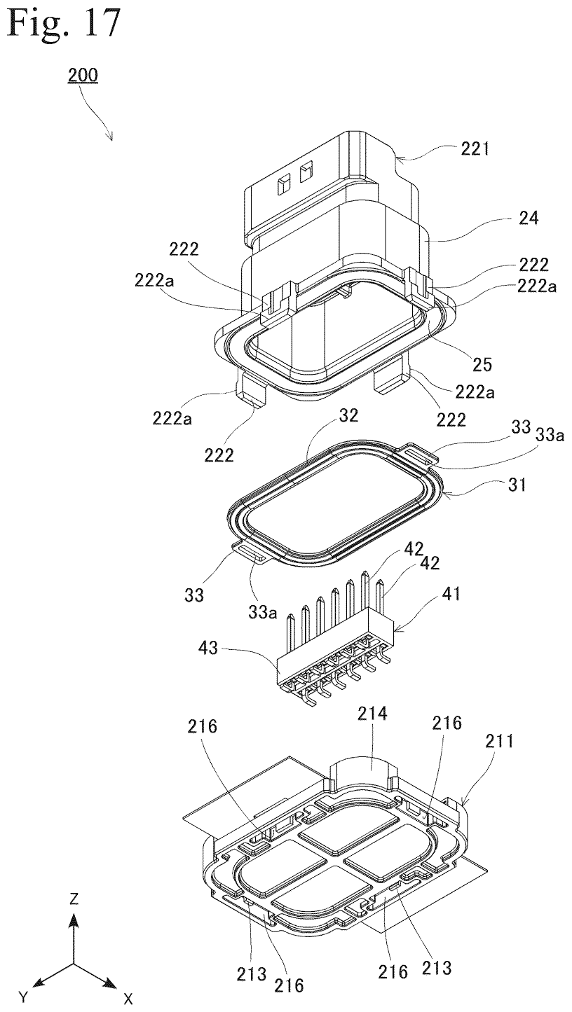

As illustrated in FIGS. 16 and 17, the fitting cover 221 includes the fitting portion 23 open in the up-down direction (±Z direction) as the third direction and into which the mating connector 110 is fitted from above the opening, a fitting cover main body portion 24 formed so as to cover the periphery of the opening, and the lock claw 222 as a lock portion formed in a central lower part of each peripheral surface of the fitting cover main body portion 24.

The lock claw 222 extends downward, and a portion formed as the claw shape 222a protrudes toward a direction opposite to the central direction of the fitting cover main body portion 24 (toward the outside of the fitting cover main body portion 24). With this configuration, the claw shape 222a can be hooked onto the locked portion 213 of the circuit board 11.

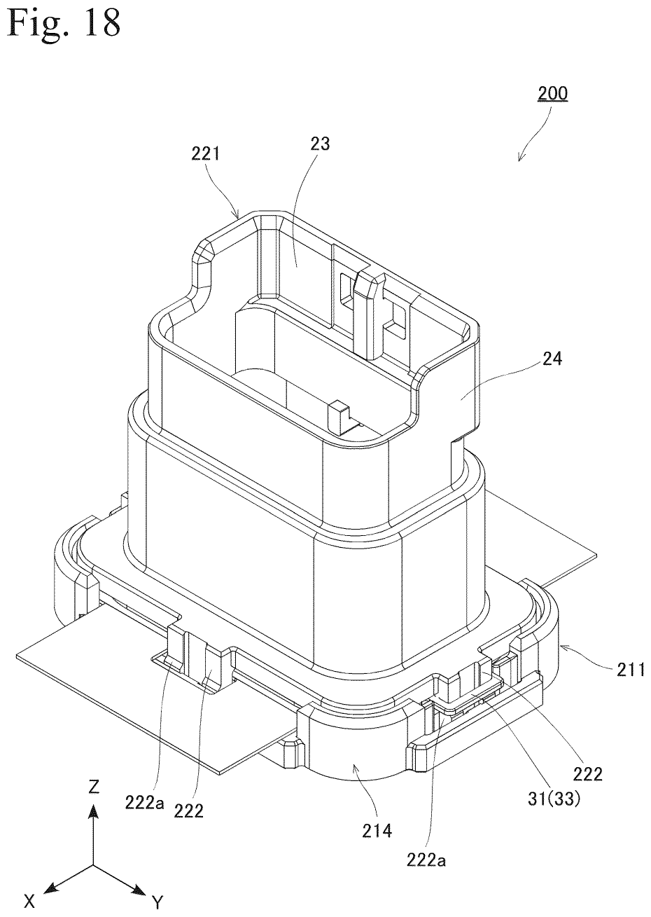

Here, the way of assembling the board waterproofing connector 200 of the second embodiment will be described. As illustrated in FIGS. 16 and 17, first, the lining portion 13 is installed on the rear surface of the terminal forming portion 12A of the plane conductor 12, and then the plane conductor 12 with the lining portion 13 is attached to the cover member 214 such that a rear surface of the lining portion 13 comes into contact with an upper surface of the cover member 214 to assemble the circuit board 211. Next, a plurality of pins 42 of the terminal 41 are connected and fixed to a plurality of connection portions 15 formed in the plane conductor 12 of the circuit board 211. This connecting and fixing can be performed by using a method such as soldering or brazing. Furthermore, by inserting the lock claw 222 of the fitting cover 221 into a through-hole 33a of the seal member 31, the seal member 31 is positioned and temporarily installed in the fitting cover 221. Thereafter, the lock claw 222 of the fitting cover 221 is pressed downward (in −Z direction) which is toward the circuit board 211, so that, as illustrated in FIGS. 18 to 20, the part of the claw shape 222a of the lock claw 222 is hooked onto the locked portion 213 formed in the cover member 214 to lock the lock claw 222 and the locked portion 213 together, and assembly of the board waterproofing connector 200 of the second embodiment is completed.

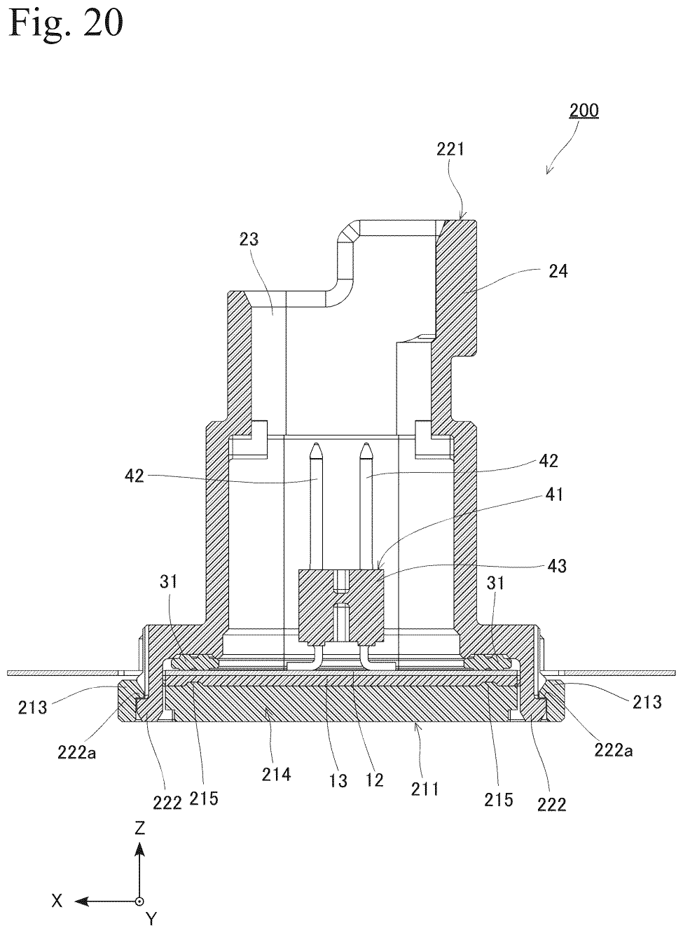

As illustrated in FIG. 20, in the board waterproofing connector 200 of the second embodiment, since the fitting cover 221 can be locked while being pressed against the circuit board 211 with the seal member 31 sandwiched between the circuit board 211 and the fitting cover 221, it is possible to waterproof the space between the circuit board 211 and the fitting cover 221. At this time, the parts of the claw shapes 222a of the four lock claws 222 provided at the front, the left, the right, and the rear of the fitting cover 221 are hooked onto the parts of the locked portions 213 formed at the front, the left, the right, and the rear of the cover member 214 of the circuit board 211, whereby the circuit board 211 and the fitting cover 221 are reliably fixed and held in the front-rear direction, the left-right direction, and the up-down direction. As a result, the board waterproofing connector 200 that reliably waterproofs the space between the circuit board 211 and the fitting cover 221 with a simple configuration can be implemented.

In addition, in the board waterproofing connector 200 according to the second embodiment, not only does the fitting cover 221 press the seal member 31 from above, but also the protrusion 215 formed in the cover member 214 presses the seal member 31 from below via the plane conductor 12 by the effect of the upwardly protruding shape (i.e., shape protruding toward the plane conductor 12) of the protrusion 215. By adopting such a configuration, in the board waterproofing connector 200 according to the second embodiment, the seal member 31 sandwiched between the circuit board 211 and the fitting cover 221 is pressed from upper and lower directions, whereby the gap between the circuit board 211 and the fitting cover 221 can be sealed reliably. Therefore, according to the board waterproofing connector 200 according to the second embodiment, the waterproofing property between the circuit board 211 and the fitting cover 221 can be improved even more.

Although suitable embodiments of the present disclosure have been described above, the technical scope of the present disclosure is not limited to the scope described in the above embodiments. Various modifications and improvements can be made in the above embodiments.

Here, in the first embodiment, the lock claw 22 included in the fitting cover 21, having the claw shape 22a, and formed toward the inner side is locked onto the locked portion 14 of the circuit board 11 with the seal member 31 sandwiched between the circuit board 11 and the fitting cover 21. Meanwhile, in the second embodiment, the lock claw 222 included in the fitting cover 221, having the claw shape 222a, and formed toward the outer side is locked onto the locked portion 213 of the circuit board 211 with the seal member 31 sandwiched between the circuit board 211 and the fitting cover 221. However, the scope of the present disclosure is not limited to the above embodiments.

### Modification Example

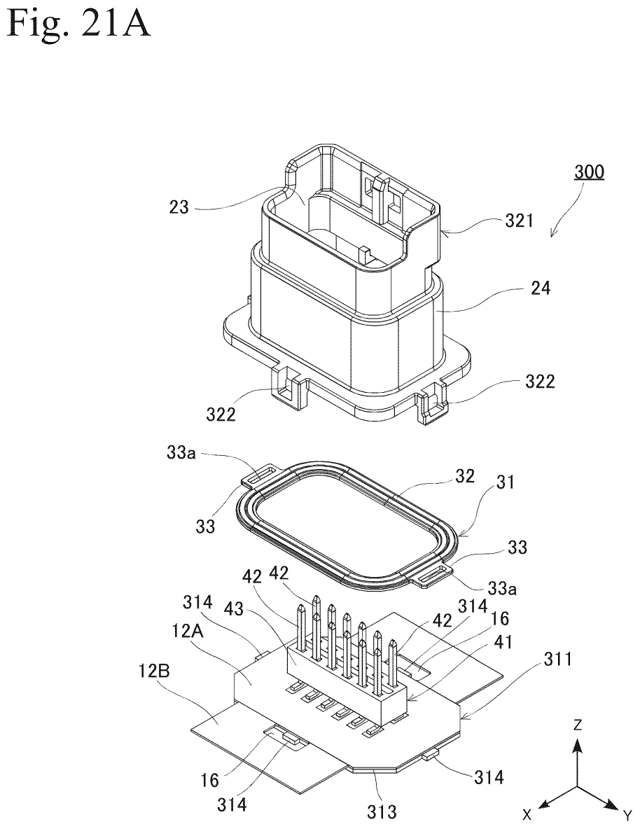

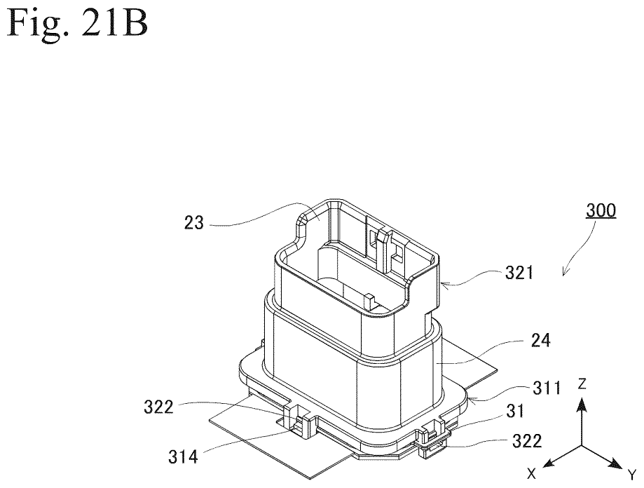

For example, a board waterproofing connector 300 illustrated in FIGS. 21A and 21B is a possible modification example of the board waterproofing connector of the present disclosure. This board waterproofing connector 300 includes a circuit board 311, a terminal 41 connected to the circuit board 311, a fitting cover 321 having a fitting portion 23 into which a mating connector 110 is fitted, and a seal member 31 that demonstrates a sealing property by being sandwiched between the circuit board 311 and the fitting cover 321.

The circuit board 311 includes a flexible plane conductor 12 and a lining portion 313 formed on a rear surface of the plane conductor 12. The lining portion 313 includes, at the center of side surfaces in the front-rear direction and the left-right direction, a locked portion 314 having a protruding shape onto which a lock hole 322 as a lock portion of the fitting cover 321 can be hooked.

The fitting cover 321 includes four lock holes 322 included in a fitting cover main body portion 24 and formed in a central lower portion of each peripheral surface. The lock hole 322 is formed so as to penetrate the fitting cover 321 from inner to outer sides thereof.

Here, the way of assembling the board waterproofing connector 300 according to the modification example will be described. First, the circuit board 311 is assembled by installing the lining portion 313 on the rear surface of a terminal forming portion 12A of the plane conductor 12. Next, a plurality of pins 42 of the terminal 41 are connected and fixed to a plurality of connection portions 15 formed in the plane conductor 12 of the circuit board 211 using means such as soldering. Furthermore, by inserting the lock hole 322 of the fitting cover 321 into a through-hole 33a of the seal member 31, the seal member 31 is positioned and temporarily fixed. Thereafter, the locked portion 314 formed in the lining portion 313 is inserted and locked onto the lock hole 322 of the fitting cover 321, whereby the board waterproofing connector 300 according to the modification example is completed.

### Another Modification Example

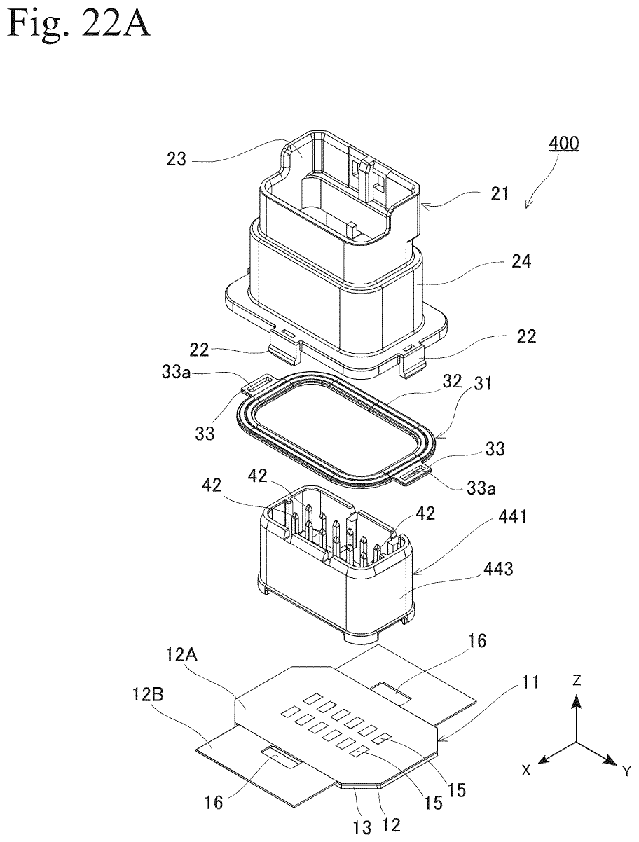

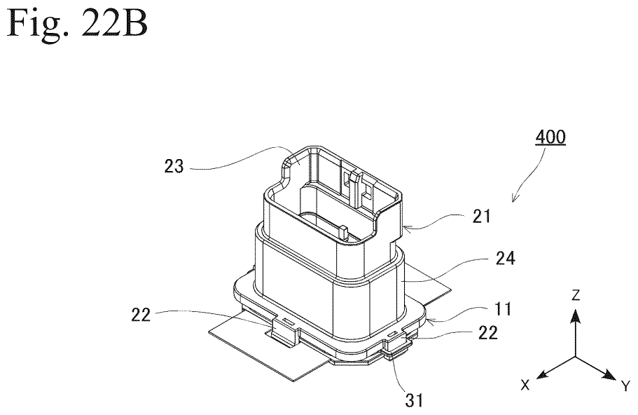

Additionally, in the first and second embodiments described above, the terminal 41 includes the plurality of pins 42 and the pin holding portion 43 holding the plurality of pins 42. However, the terminal according to the present disclosure is not limited to the above embodiments. For example, a board waterproofing connector 400 illustrated in FIGS. 22A and 22B is another possible modification example of the board waterproofing connector of the present disclosure. As illustrated in FIGS. 22A and 22B, a terminal 441 of the board waterproofing connector 400 according to another modification example includes a plurality of pins 42 and a pin holding portion 443 that holds the plurality of pins 42 and covers the entire peripheral surfaces of the plurality of pins 42. As described above, as the terminal of the present disclosure, any shape of terminal can be adopted as long as it can be accommodated in the fitting cover main body portion 24 forming the fitting cover 21.

### Yet Another Modification Example

Additionally, in the embodiments and the modification examples described above, the lock portion of the fitting cover 21, 221, 321 is formed as the lock claw 22, 222 having the claw shape 22a, 222a or the lock hole 322, and is locked onto the locked portion 14, 213, 314 of the circuit board 11, 211, 311 to waterproof the space between the circuit board 11, 211, 311 and the fitting cover 21, 221, 321. However, the board waterproofing connector according to the present disclosure can use any locking means other than the locking means described above.

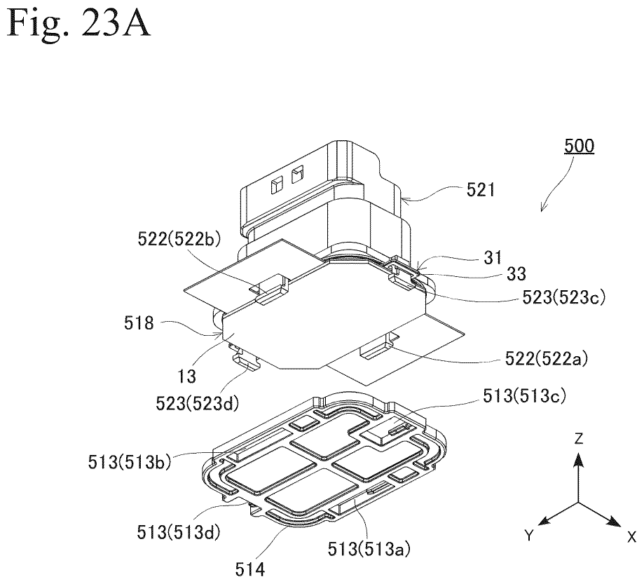

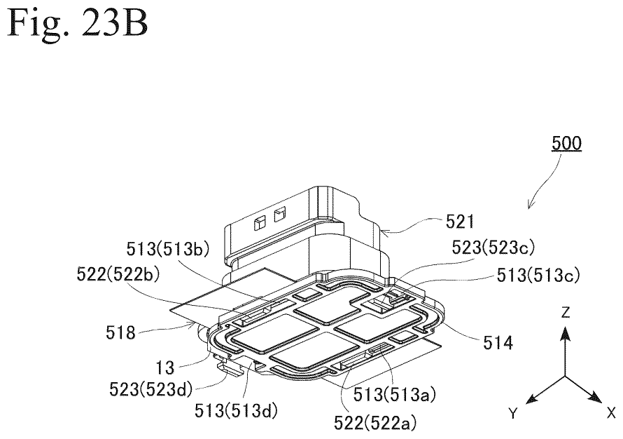

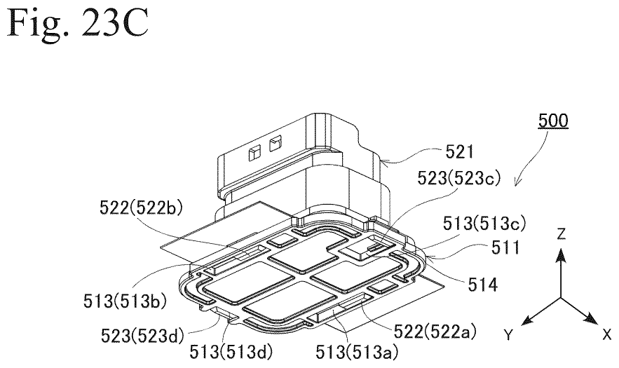

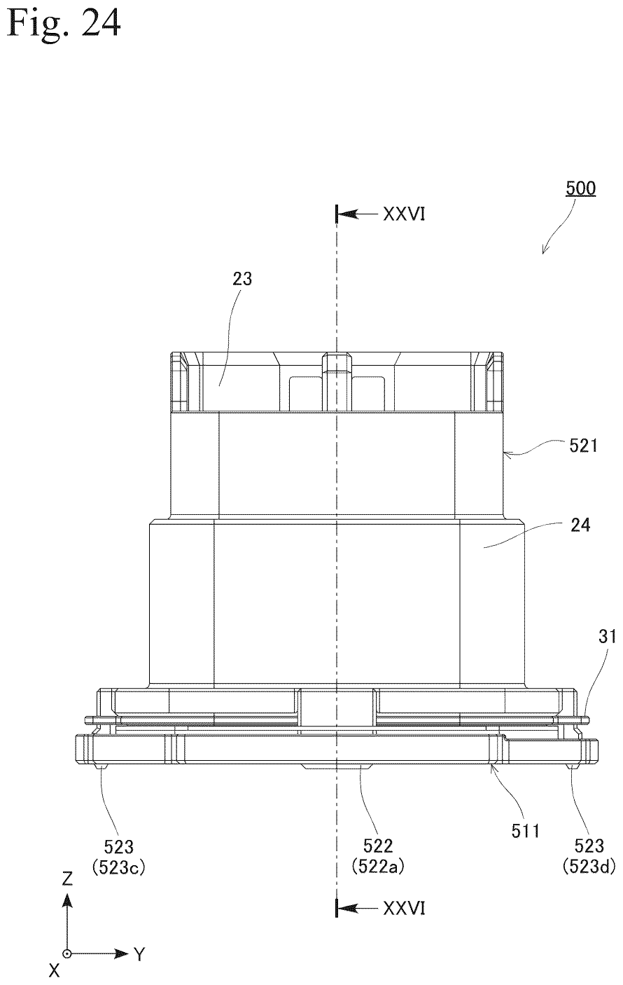

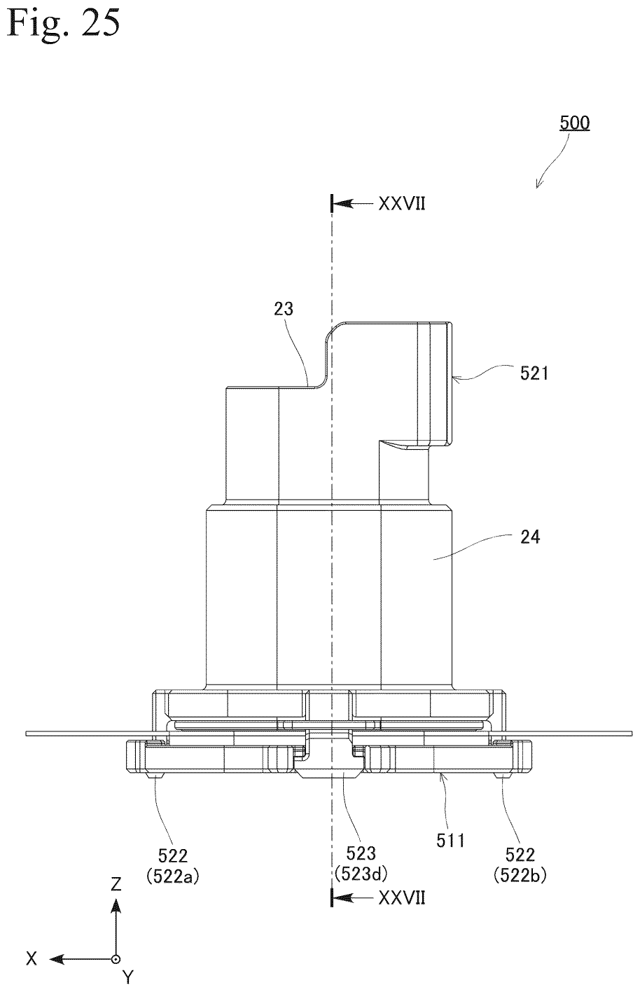

For example, a cover member of a circuit board can be slid to lock the circuit board and a fitting cover together. That is, in a board waterproofing connector 500 according to yet another modification example as illustrated in FIGS. 23A to 27, a lock portion of a fitting cover 521 includes a lock claw 522 (522a, 522b) formed at the front and the rear of the fitting cover 521, and a lock piece 523 (523c, 523d) formed on the left and the right. In addition, a locked portion 513 formed in a cover member 514 of the board waterproofing connector 500 includes rail grooves 513a, 513b formed at the front and the rear of the cover member 514, a guide hole 513c formed on the left, and a guide groove 513d formed on the right.

Here, the way of assembling the board waterproofing connector 500 according to the yet another modification example will be described. First, in a state in which the fitting cover 521 with the lock piece 523 inserted into a through-hole 33a of a seal member 31 is brought into contact, from above, with a temporary circuit board 518 in which a terminal 41 is connected to a plane conductor 12 and the plane conductor 12 and a lining portion 13 are integrated, the cover member 514 is placed below the lining portion 13 (state illustrated in FIG. 23A). Next, the cover member 514 is moved upward and brought into contact with the lining portion 13 (state illustrated in FIG. 23B). At this time, the lock claws 522 (522a, 522b) formed at the front and the rear of the fitting cover 521 are inserted and locked onto the rail grooves 513a, 513b formed at the front and the rear of the cover member 514, and the lock piece 523 (523c) formed on the left of the fitting cover 521 is inserted into the guide hole 513c formed on the left of the cover member 514. Finally, the cover member 514 is horizontally slid to the right (+Y direction) to bring a left side surface of the lock piece 523 (523d) formed on the right of the fitting cover 521 into contact with a left side surface of the guide groove 513d formed on the right of the cover member 514, and bring a left side surface of the lock piece 523 (523c) formed on the left of the fitting cover 521 into contact with a left inner wall surface of the guide hole 513c formed on the left of the cover member 514 (state illustrated in FIG. 23C). With the above operation, the board waterproofing connector 500 according to the yet another modification example can be assembled.

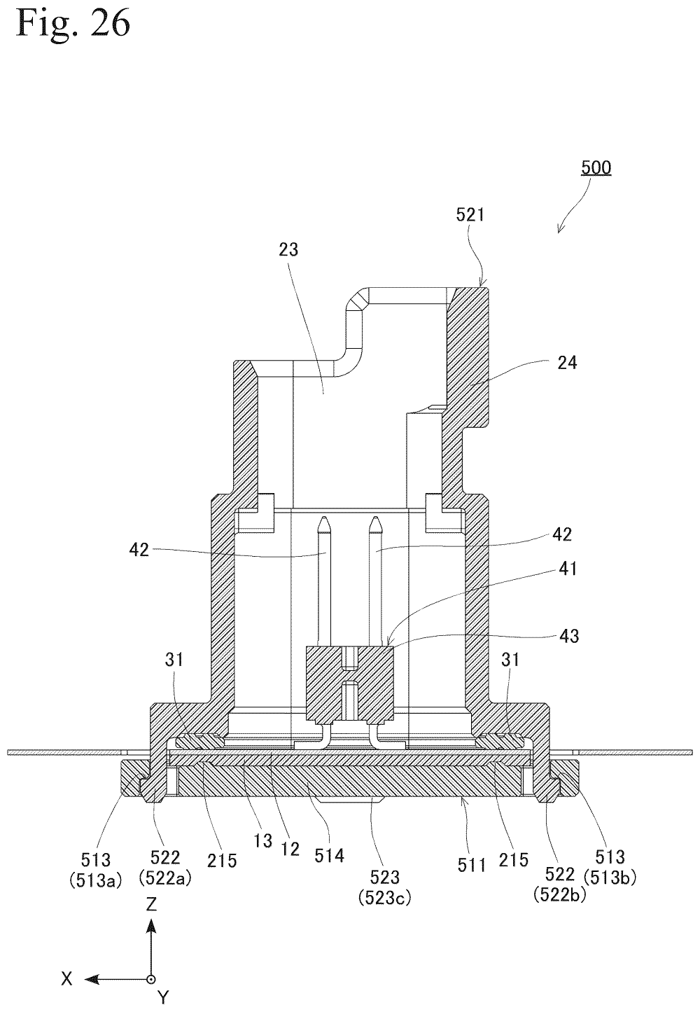

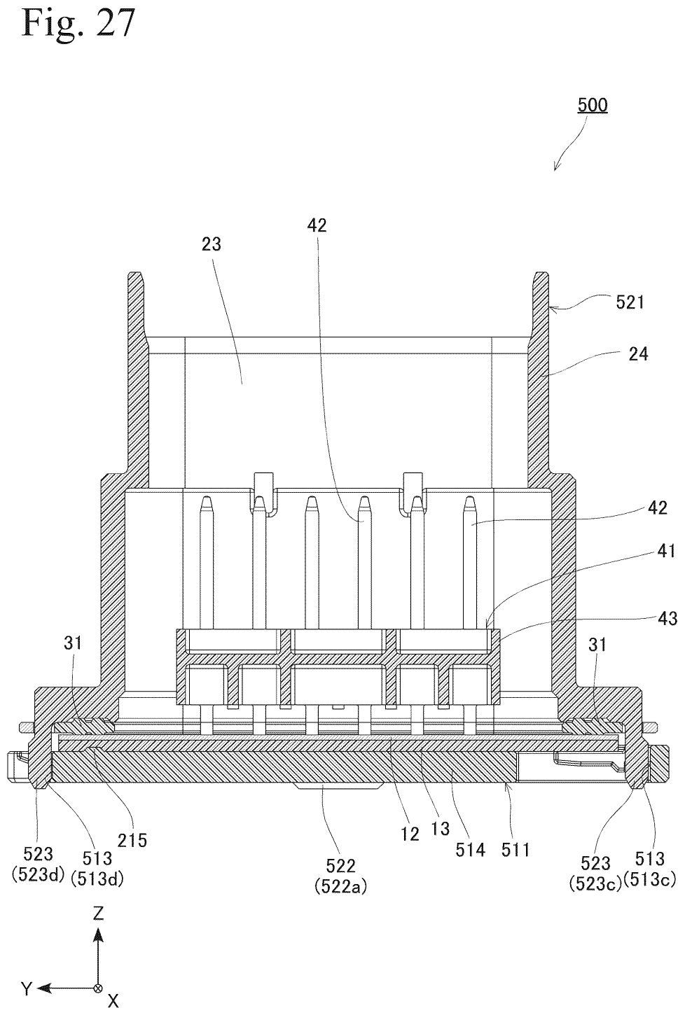

As illustrated in FIGS. 26 and 27, the board waterproofing connector 500 according to the yet another modification example can waterproof the space between a circuit board 511 and the fitting cover 521 by sandwiching the seal member 31 between the circuit board 511 and the fitting cover 521 and locking while pressing the fitting cover 521 against the circuit board 511. At this time, particularly as illustrated in FIG. 26, since the lock claws 522 (522a, 522b) formed at the front and the rear of the fitting cover 521 are hooked onto the rail grooves 513a, 513b formed at the front and the rear of the cover member 514 of the circuit board 511, the circuit board 511 and the fitting cover 521 are reliably fixed and held in the front-rear direction and the up-down direction. Moreover, particularly as illustrated in FIG. 27, since the left side surface of the lock piece 523 (523c) formed on the left of the fitting cover 521 is brought into contact with the left inner wall surface of the guide hole 513c formed on the left of the cover member 514 of the circuit board 511 and the left side surface of the lock piece 523 (523d) formed on the right of the fitting cover 521 is brought into contact with the left side surface of the guide groove 513d formed on the right of the cover member 514, the circuit board 511 and the fitting cover 521 are reliably fixed and held in the left-right direction and the up-down direction. By adopting such locking means, the board waterproofing connector 500 according to the yet another modification example can be assembled easily.

Note that in the embodiments and the modification examples described above, the fitting cover 24 and the seal member 31 are formed as different parts. However, the fitting cover and the seal member of the present disclosure may be formed as a single piece by two-color molding. With such a configuration, the operation of positioning the seal member 31 when sandwiching the seal member 31 between the fitting cover 21 and the circuit board 11 can be omitted. In this case, there is no need to form the through-hole 33a allowing insertion of the lock portion (lock claw 22) of the fitting cover 24 in the seal member 31. Hence, material required for manufacturing of the seal member 31 can be reduced, and freedom in design can be improved.

Additionally, in the first embodiment, the claw shapes 22a of all of the lock claws 22 in the fitting cover 21 are formed toward the inside of the opening of the fitting cover 21. Furthermore, in the second embodiment, the claw shapes 222a of all of the lock claws 222 in the fitting cover 221 are formed toward the outside of the opening of the fitting cover 221. However, the claw shapes of the lock claws of the fitting cover according to the present disclosure do not need to be formed in the same direction either toward the inside or the outside. For example, it is possible to form the claw shapes of the lock claws at the front and the rear of the fitting cover toward the outside and the claw shapes of the lock claws at the left and the right of the fitting cover toward the inside. Alternatively, the claw shapes of the lock claws of the present disclosure may be formed toward both the inside and the outside instead of only one of the inside and the outside.

Moreover, in the embodiments and the modification examples described above, a total of four lock portions of the fitting cover are formed at the front, the rear, the left, and the right. However, the lock portion of the present disclosure only needs to be formed in one or more any positions.

Additionally, in the second embodiment, the circuit board 211 includes the flexible plane conductor 12, the lining portion 13 provided on the rear side of the terminal forming portion 12A in the plane conductor 12, and the cover member 214 formed so as to cover the terminal forming portion 12A and the lining portion 13 from the rear side. However, in the board waterproofing connector of the present disclosure, the lining portion is not essential if the circuit board has a cover member. If the lining portion is omitted, the cover member only needs to cover the terminal forming portion from the rear side.

It is apparent from the description of the scope of claims that modes including such modifications and improvements are also included in the technical scope of the present disclosure.

### Third Embodiment

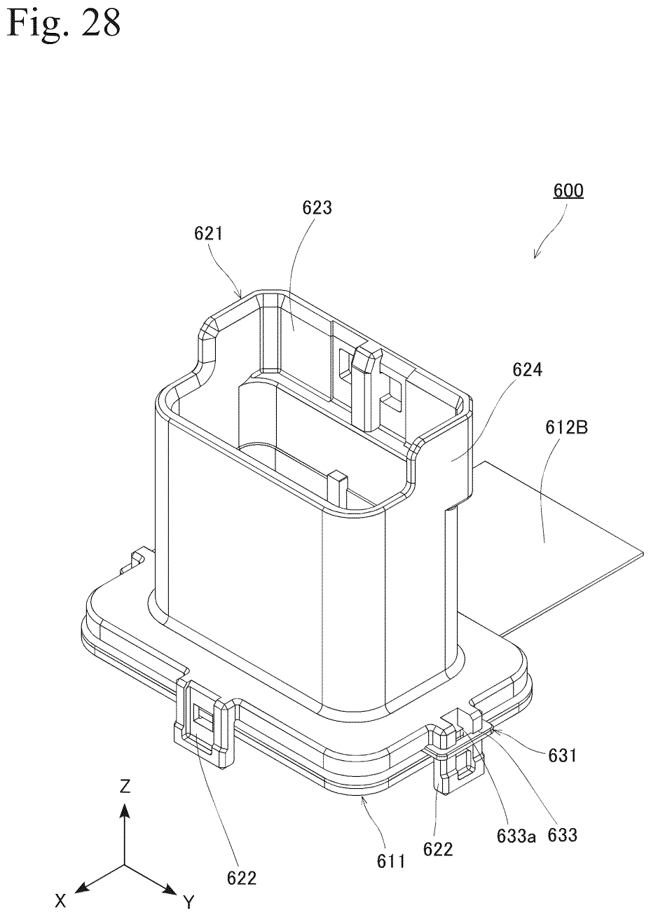

A configuration of a board waterproofing connector 600 according to a third embodiment will be described with reference to FIGS. 28 to 44. As illustrated in FIGS. 28 to 36, the board waterproofing connector 600 according to the third embodiment includes a circuit board 611, a fitting cover 621 having a fitting portion 623 into which a mating connector 910 to be describe later is fitted and including a holding hole 626 as a holding portion that holds a later-described metal terminal 650 therein, and a seal member 631 that demonstrates a sealing property by being sandwiched between the circuit board 611 and the fitting cover 621.

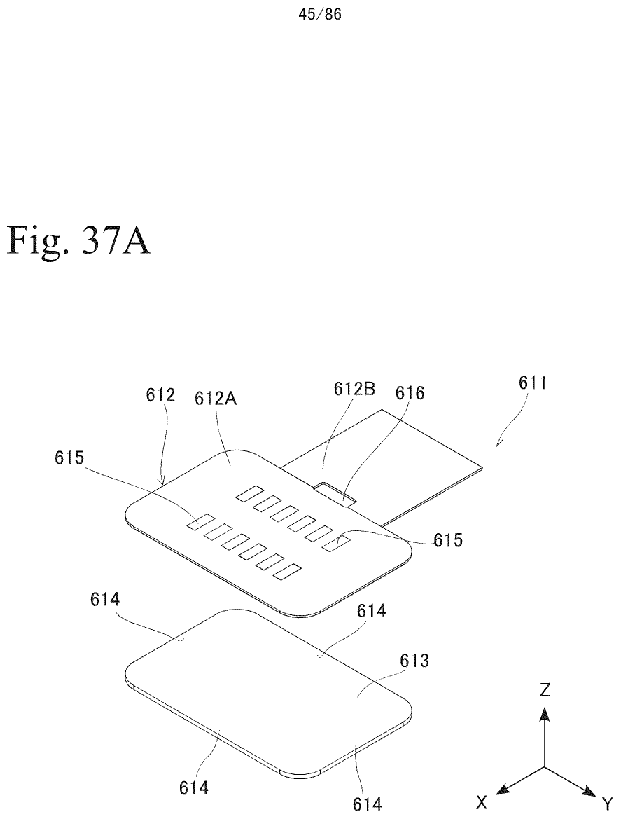

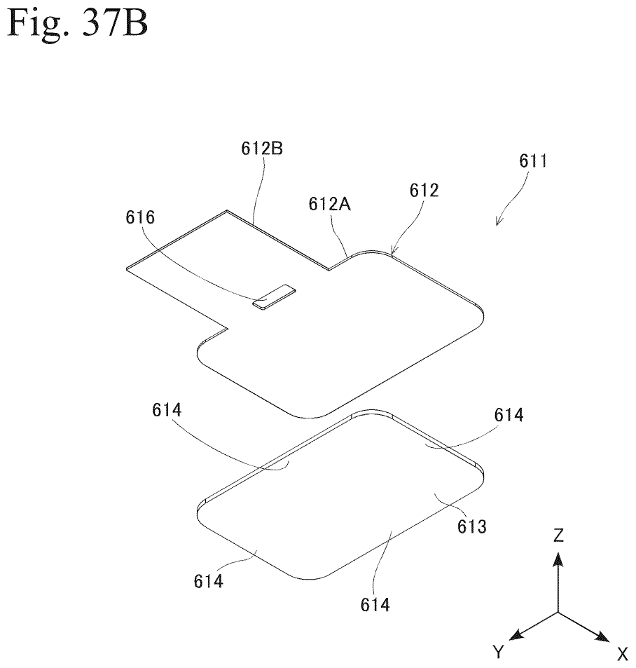

As illustrated in FIGS. 37A and 37B, the circuit board 611 includes a flexible plane conductor 612 and a lining portion 613 on a rear surface of the plane conductor 612. In the third embodiment, the rear surface of the flexible plane conductor 612 on which the lining portion 613 is provided is a surface opposite to the surface on which the fitting cover 621 is placed on the circuit board 611. In addition, in the third embodiment, a flexible printed circuit (FPC) is used as the plane conductor 612. Note that any flexible circuit board other than the FPC, such as a flexible flat cable (FFC), can be used as the circuit board 611. Moreover, a rigid circuit board that is not flexible or any flat plate-shaped member can be used.

The plane conductor 612 includes a terminal forming portion 612A and an extension portion 612B extending in the rear direction (−X direction) which is the first direction from the terminal forming portion 612A. The terminal forming portion 612A has a plurality of connection portions 615 at its center, and the plurality of connection portions 615 can respectively be connected to contact portions 651 of the metal terminal 650 described later. The extension portion 612B has a plane conductor penetration hole 616 penetrating in the up-down direction (±Z direction) which is the third direction, and a lock portion of the later-described fitting cover 621 can be inserted therethrough.

The lining portion 613 is attached to the entire rear surface of the terminal forming portion 612A to prevent deformation of the flexible terminal forming portion 612A. The lining portion 613 also includes, in parts at its front center, rear center, left center, and right center, a locked portion 614 onto which a lock claw 622 as the lock portion of the later-described fitting cover 621 can be locked. Note that in the third embodiment, the lining portion 613 is attached to the entire rear surface of the terminal forming portion 612A. However, the range in which the lining portion 613 is provided only needs to include the range of the locked portion 614 onto which the lock portion of the fitting cover 621 can be locked. That is, the lining portion 613 may be provided for a partial region of the rear surface of the terminal forming portion 612A.

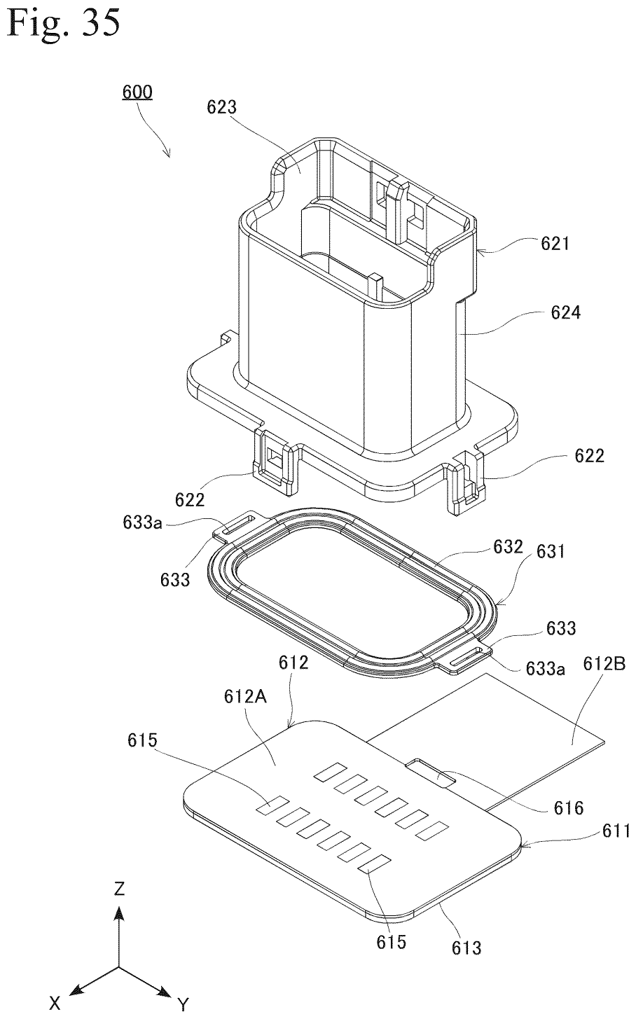

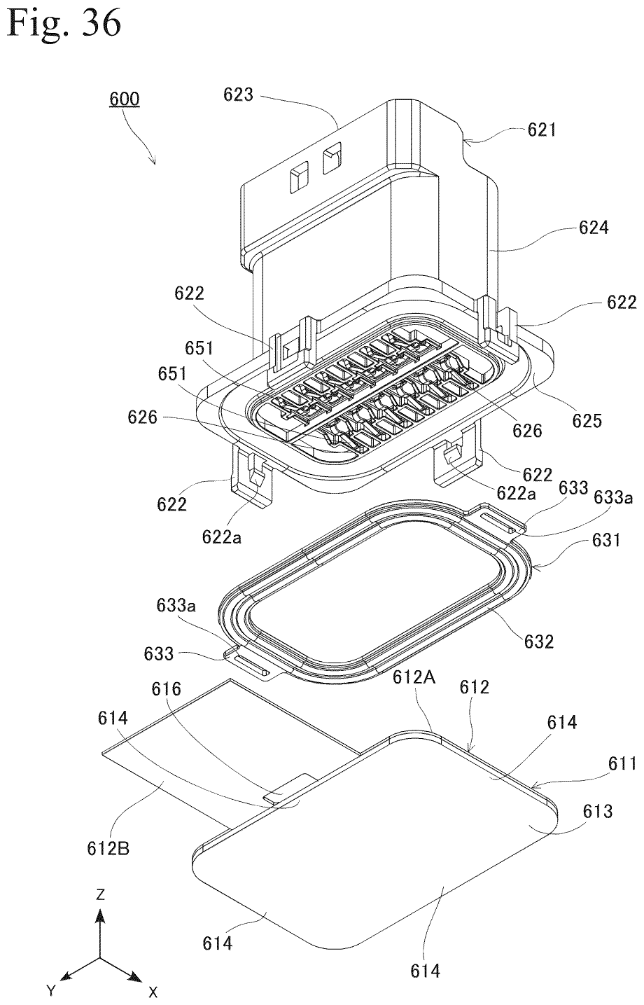

As illustrated in FIGS. 35 and 36, the fitting cover 621 includes the fitting portion 623 open to the upper side (+Z direction) which is the third direction and into which the mating connector 910 to be described later is fitted from above which is the opening side, a fitting cover main body portion 624 formed so as to cover the periphery of the opening, the lock claw 622 as the lock portion formed in a central lower part of each peripheral surface of the fitting cover main body portion 624, and the holding hole 626 that holds the metal terminal 650 inside the fitting cover main body portion 624. In the present embodiment, the fitting cover main body portion 624, the lock claw 622, and the holding hole 626 of the fitting cover 621 are formed integrally by injection molding. However, it is also possible to manufacture each part individually, or form only some of the parts integrally.

A seal receiving surface 625 into which the seal member 631 comes into contact is formed in a lower end surface of the fitting cover main body portion 624. The lock claw 622 extends downward and has a portion formed as a claw shape 622a protruding toward the central direction of the fitting cover main body portion 624 (toward the inside of the fitting cover main body portion 624), and the claw shape 622a can be hooked onto the locked portion 614 of the circuit board 611.

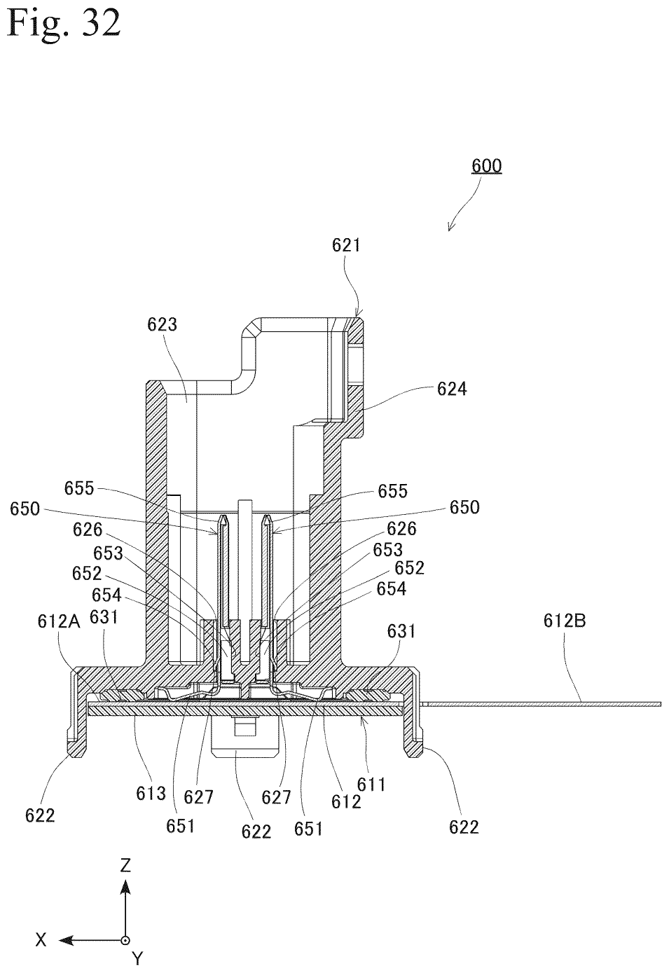

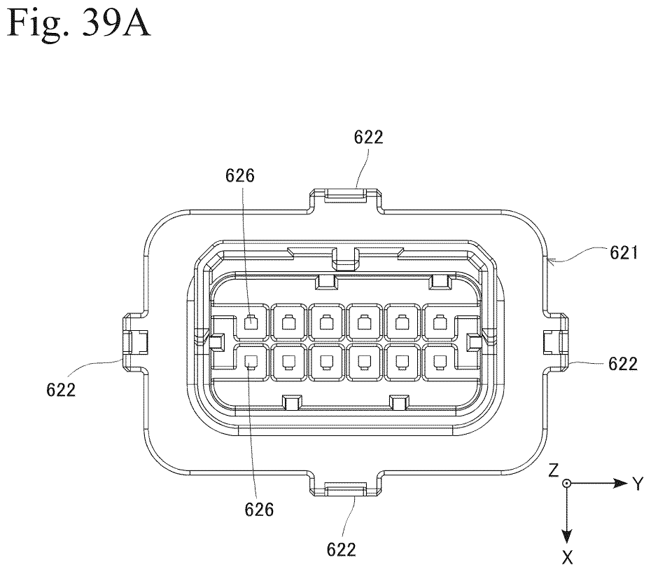

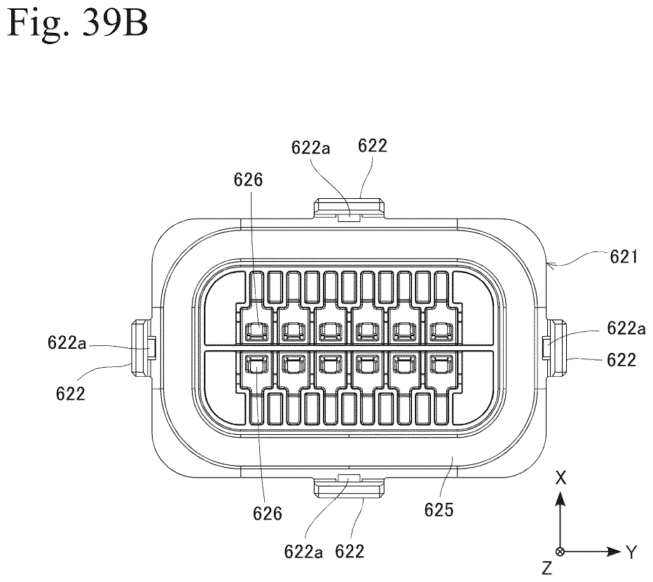

As illustrated in FIGS. 39A and 39B, the holding hole 626 is formed as a plurality of holes into which a plurality of the metal terminals 650 are inserted. As illustrated in FIG. 32, in each of the plurality of holding holes 626, a hooked portion 627 onto which a hook portion 654 (described later) formed in a held portion 652 of the metal terminal 650 is hooked when the metal terminal 650 is inserted into the holding hole 626 is formed.

The seal member 631 can be formed of any of a rubber material, a plastic material, or an elastomeric material. The seal member 631 according to the third embodiment is formed of a rubber material, for example, and as illustrated in FIG. 36, includes a seal main body portion 632 whose upper surface comes into contact with the seal receiving surface 625 formed in the fitting cover 621, and a pair of ring-shaped through-holes 633a respectively penetrating a pair of flange portions 633 protruding in the left-right direction (±Y direction) which is the second direction.

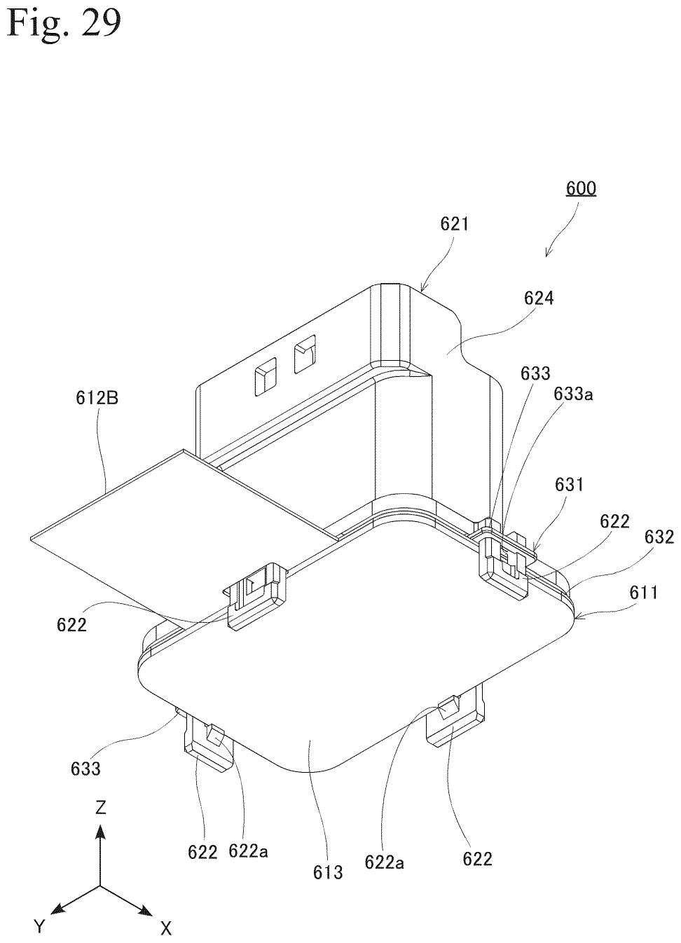

The through-hole 633a is formed at the left center and the right center of the seal main body portion 632, and allows insertion of the left and right lock claws 622 formed in the fitting cover main body portion 624 (see FIGS. 28 and 29). As described above, by forming the through-hole 633a through which the lock claw 622 can be inserted in the seal member 631 and inserting the left and right lock claws 622 formed in the fitting cover main body portion 624 into the pair of through-holes 633a to attach the seal member 631 to the fitting cover 621 in advance, it is possible to easily position the seal member 631 when sandwiching the seal member 631 between the fitting cover 621 and the circuit board 611, and facilitate assembly of the board waterproofing connector 600. Note that while the seal member 631 includes the two through-holes 633a at the left center and the right center in the third embodiment, the through-hole 633a of the present disclosure can be formed by adopting any number and location corresponding to the number and location of the lock claws 622 of the fitting cover 621. Additionally, it is sufficient that the through-hole 633a allows insertion of one or more lock claws 622 of the fitting cover 621.

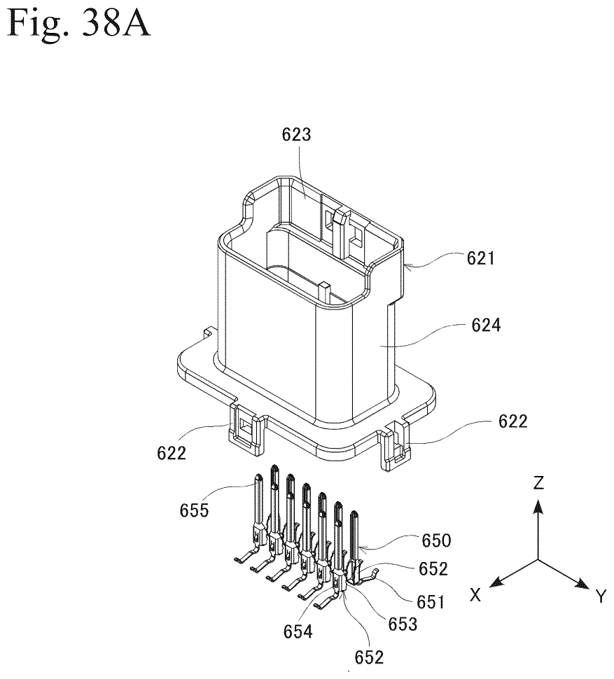

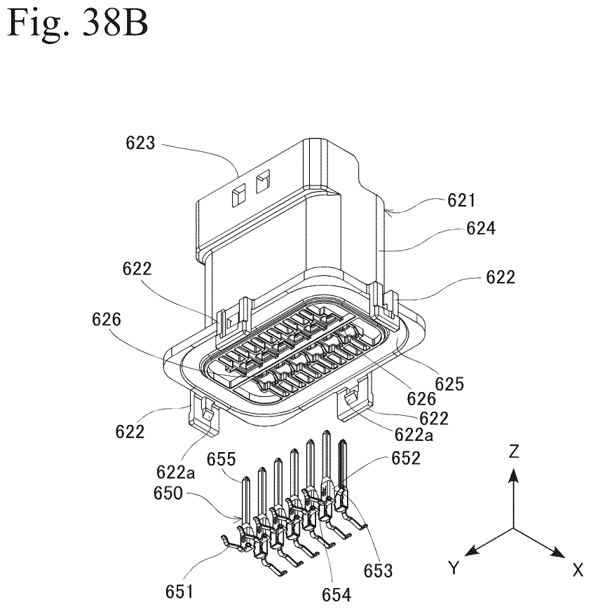

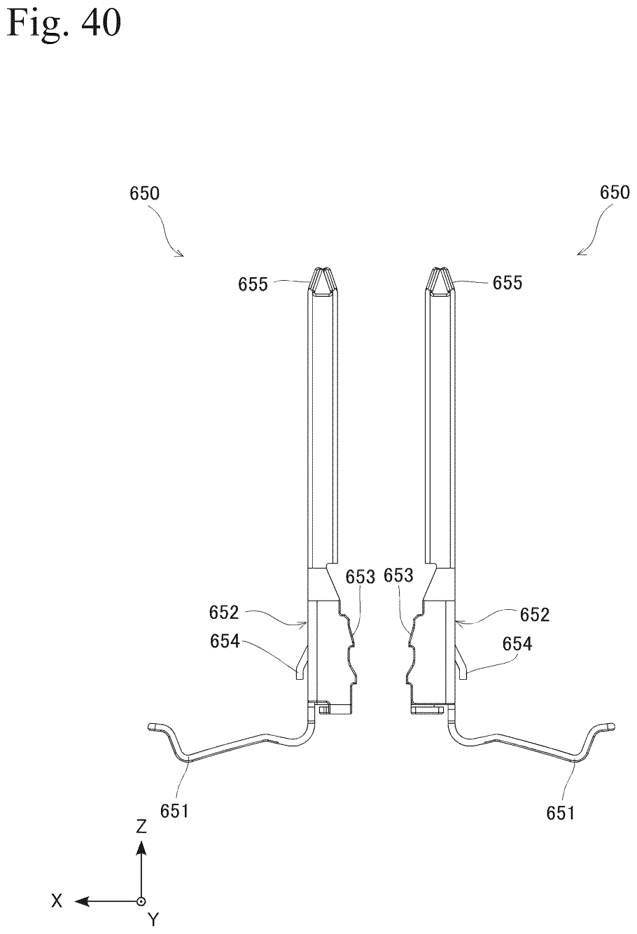

As illustrated in FIGS. 38A and 38B, the metal terminal 650 is inserted into each of the plurality of holding holes 626 of the fitting cover 621, and a plurality of the metal terminals 650 are formed corresponding to the positions of the plurality of connection portions 615 of the circuit board 611. As illustrated in FIG. 40, each metal terminal 650 includes, on the lower end side, the spring-like contact portion 651 for contacting the plane conductor 612 of the circuit board 611, the held portion 652 connected to the contact portion 651 and held in the holding hole 626 formed inside the fitting cover main body portion 624, and a mating terminal contact portion 655 that extends upward from the held portion 652 and comes into contact with a mating terminal 911 of the mating connector 910.

Each of the contact portions 651 curves and extends outward in the front-rear direction (±X direction) which is the first direction, and demonstrates a spring property acting downward when pressed upward from the lower side.

Each of the held portions 652 includes a projection 653 formed toward the inside in the front-rear direction (±X direction) which is the first direction, and the hook portion 654 formed toward the outside in the front-rear direction. The projection 653 is a projecting part that contributes to press-fitting of the held portion 652 into the holding hole 626 when the metal terminal 650 is inserted into the holding hole 626 formed inside the fitting cover main body portion 624. Meanwhile, the hook portion 654 is hooked onto the hooked portion 627 of the holding hole 626 when the metal terminal 650 is inserted into the holding hole 626. That is, the hook portion 654 and the hooked portion 627 work together to demonstrate a function of preventing the metal terminal 650 inserted into the holding hole 626 from falling out.

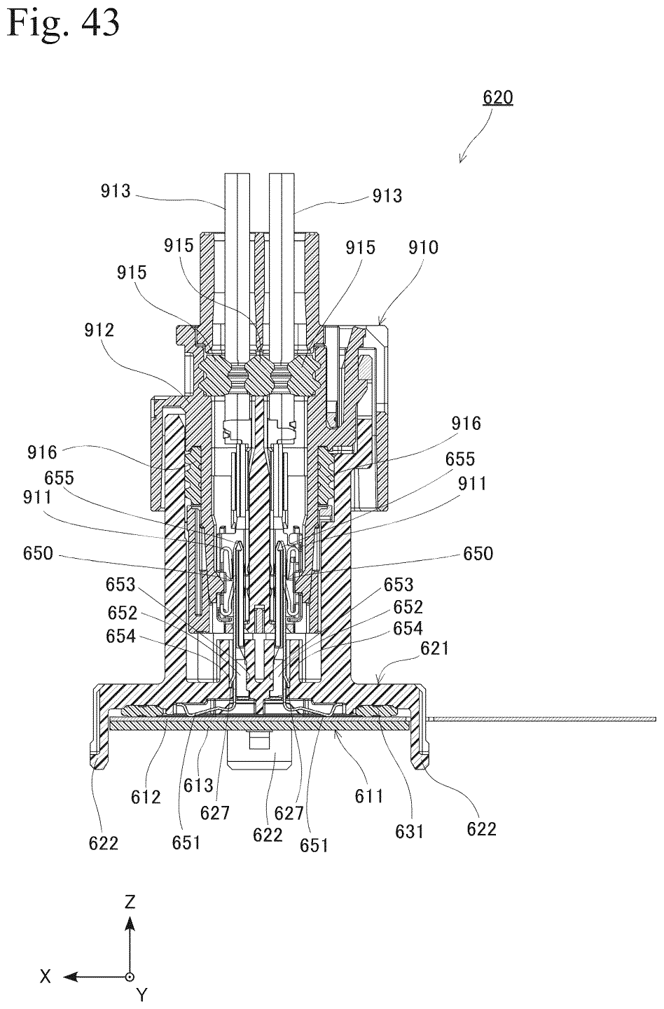

As illustrated in FIG. 43, the mating terminal contact portion 655 is configured to electrically connect with the mating terminal 911 of the mating connector 910 to deliver electric signals, electric power, and the like.

Here, the way of assembling the board waterproofing connector 600 of the third embodiment will be described. First, as illustrated in FIGS. 35 and 36, the circuit board 611 is assembled by installing the lining portion 613 on the rear surface of the terminal forming portion 612A of the plane conductor 612. Next, the metal terminal 650 is inserted into the holding hole 626 from below the fitting cover 621. At this time, the projection 653 of the metal terminal 650 is press-fitted into the holding hole 626 of the fitting cover 621, and the hook portion 654 of the metal terminal 650 is hooked onto the hooked portion 627 formed in the holding hole 626. Next, the lock claw 622 of the fitting cover 621 is inserted into the through-hole 633a of the seal member 631 to position and temporarily install the seal member 631 in the fitting cover 621. Thereafter, the lock claw 622 of the fitting cover 621 is pressed downward (in −Z direction) which is toward the circuit board 611, so that, as illustrated in FIGS. 28 to 34, the part of the claw shape 622a of the lock claw 622 is hooked onto the locked portion 614 formed in the lining portion 613 to lock the lock claw 622 and the locked portion 614 together, and assembly of the board waterproofing connector 600 of the third embodiment is completed. At this time, as illustrated in FIG. 32, pressing the fitting cover 621 downward, which is toward the circuit board 611, causes the contact portion 651 of the metal terminal 650 to be pressed upward by the circuit board 611 to demonstrate the spring property acting downward, whereby contact between the contact portion 651 and the connection portion 615 is maintained.

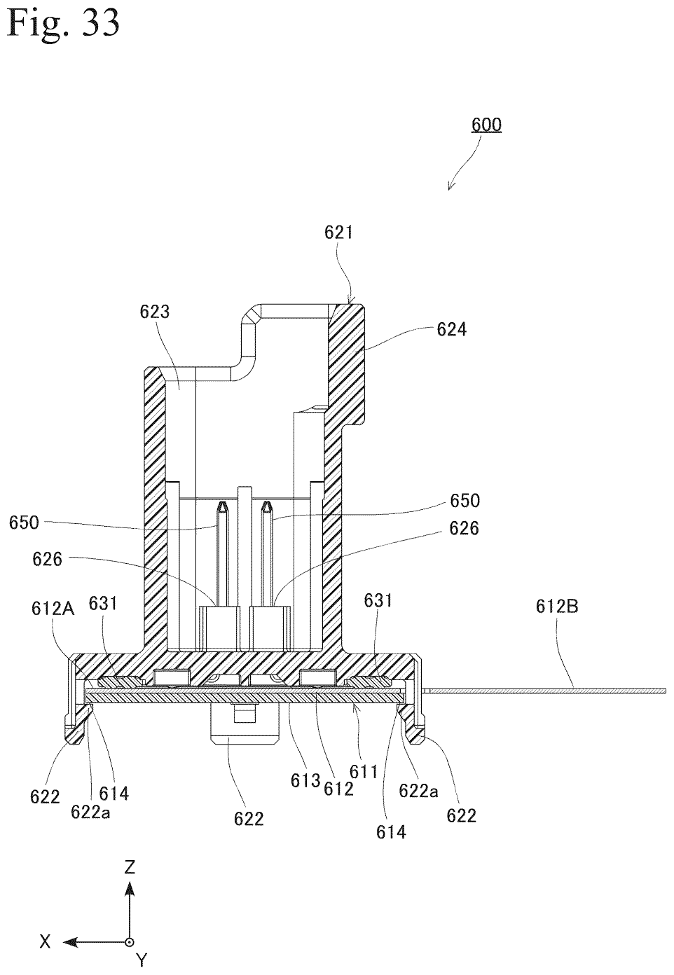

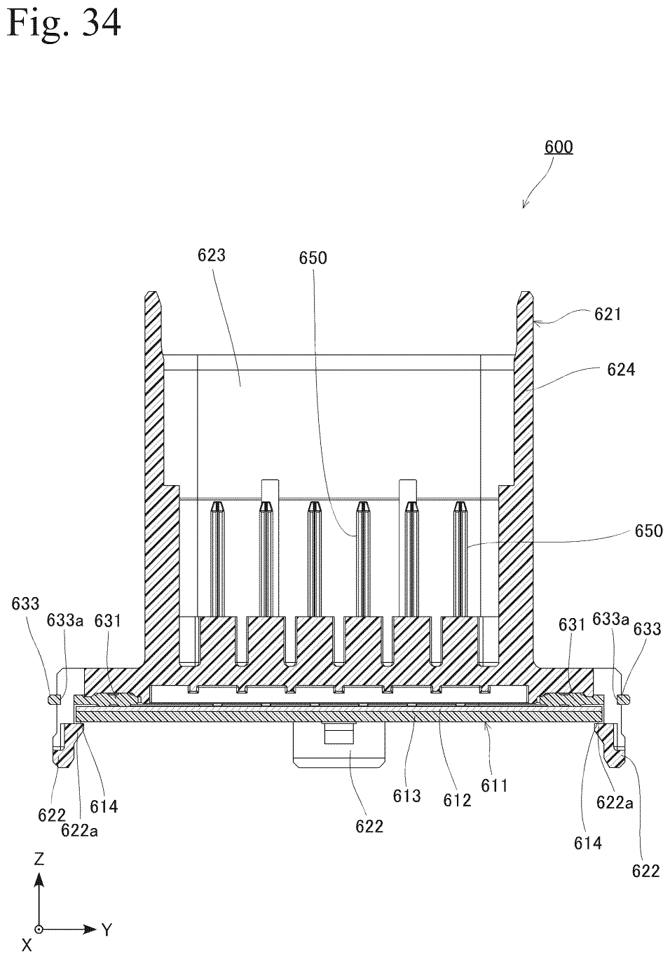

As illustrated in FIGS. 33 and 34, since the board waterproofing connector 600 of the third embodiment can sandwich the seal member 631 between the circuit board 611 and the fitting cover 621 and lock while pressing the fitting cover 621 against the circuit board 611, the space between the circuit board 611 and the fitting cover 621 can be waterproofed appropriately. At this time, particularly as illustrated in FIG. 33, the parts of the claw shapes 622a of the two lock claws 622 installed at the front and the rear of the fitting cover 621 are hooked onto the locked portions 614 formed at the front and the rear of the lining portion 613 of the circuit board 611, whereby the circuit board 611 and the fitting cover 621 are reliably fixed and held in the front-rear direction and the up-down direction. Moreover, particularly as illustrated in FIG. 34, the parts of the claw shapes 622a of the two lock claws 622 installed on the left and the right of the fitting cover 621 are hooked onto the locked portions 614 formed on the left and the right of the lining portion 613 of the circuit board 611, whereby the circuit board 611 and the fitting cover 621 are reliably fixed and held in the left-right direction and the up-down direction. As a result, the board waterproofing connector 600 that reliably waterproofs the space between the circuit board 611 and the fitting cover 621 with a simple configuration can be implemented.

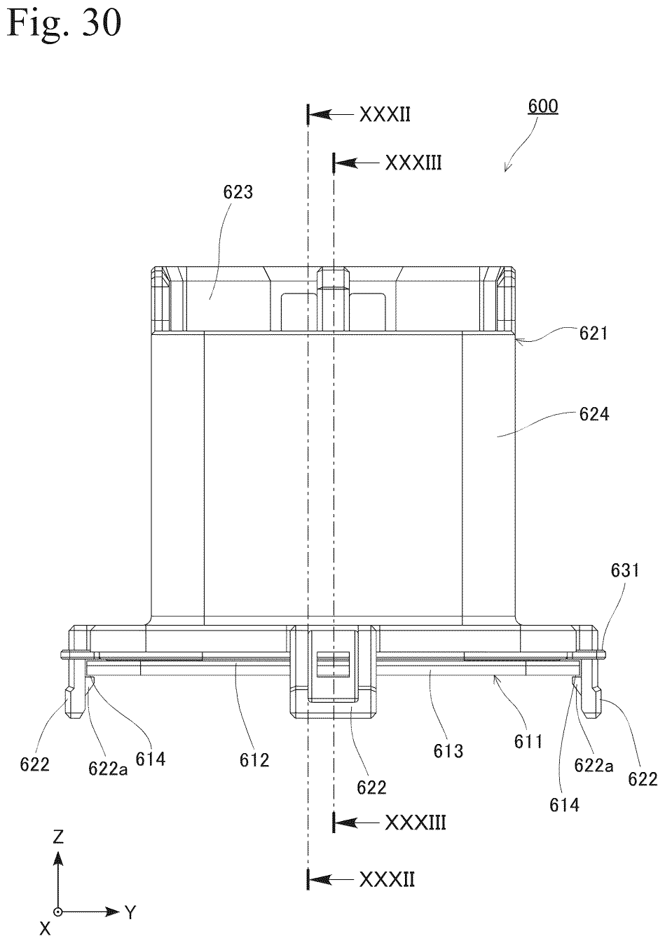

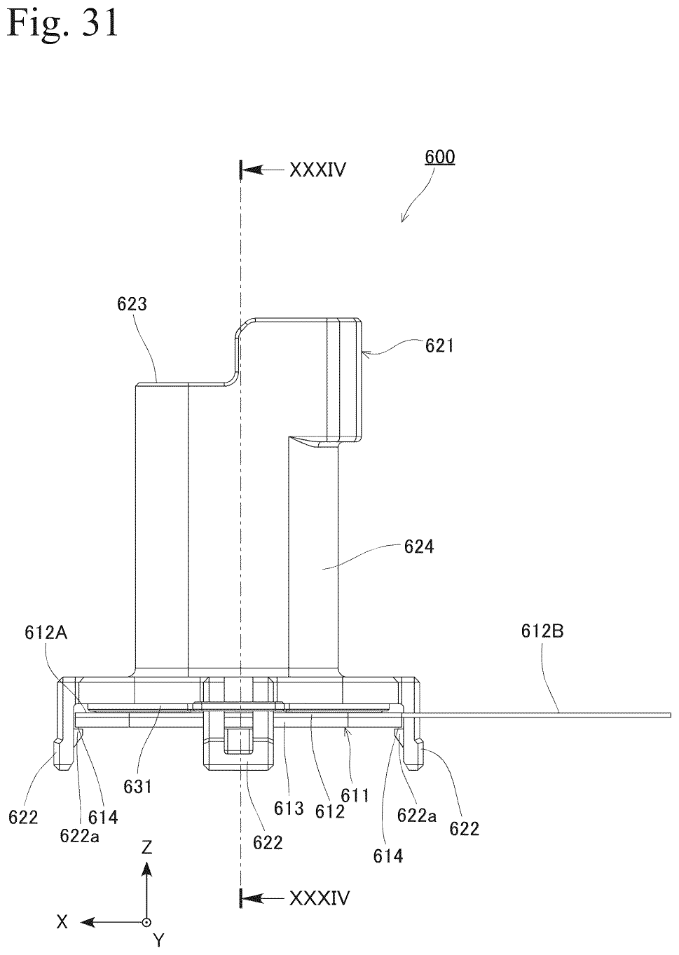

Furthermore, as is clear from FIGS. 30 and 31, in the board waterproofing connector 600 of the third embodiment, the seal member 631 is exposed over the entire fitting cover 621 except for a part where the lock claw 622 is formed. With such a configuration, according to the board waterproofing connector 600 of the third embodiment, the seal part where the seal member 631 is sandwiched between the circuit board 611 and the fitting cover 621 can be viewed from the outside over the entire fitting cover 621, so that whether the board waterproofing connector 600 is reliably sealed can be easily confirmed.

Here, in the first and second embodiments, the terminal 41 is connected to the circuit board 11, 211 by fixedly connecting the plurality of pins 42 of the terminal 41 to the plurality of connection portions 15 formed in the plane conductor 12 of the circuit board 11, 211 using methods such as soldering or brazing. Meanwhile, as illustrated in FIG. 32, the metal terminal 650 of the third embodiment maintains contact between the contact portion 651 and the connection portion 615 of the circuit board 611 by the downward spring property demonstrated by the contact portion 651. That is, according to the metal terminal 650 of the third embodiment, since the spring property of the contact portion 651 maintains the contact between the contact portion 651 and the connection portion 615 of the circuit board 611, there is no need to fixedly connect the metal terminal 650 to the circuit board 611 by soldering or brazing in advance, and the number of man-hours required for assembly of the board waterproofing connector 600 can be reduced.

Moreover, in the third embodiment, the fitting cover main body portion 624, the lock claw 622, and the holding hole 626 of the fitting cover 621 are formed integrally. With this configuration, the number of man-hours required for assembly of the fitting cover 621 can be reduced significantly compared to a case where each part is manufactured individually.

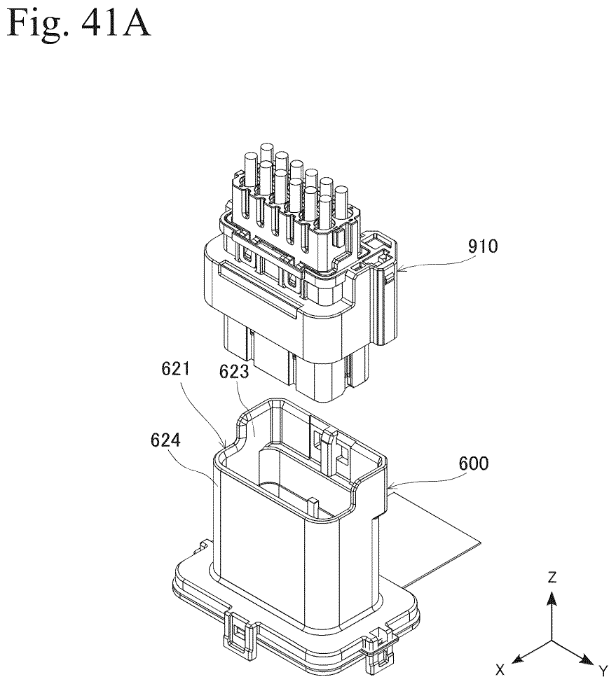

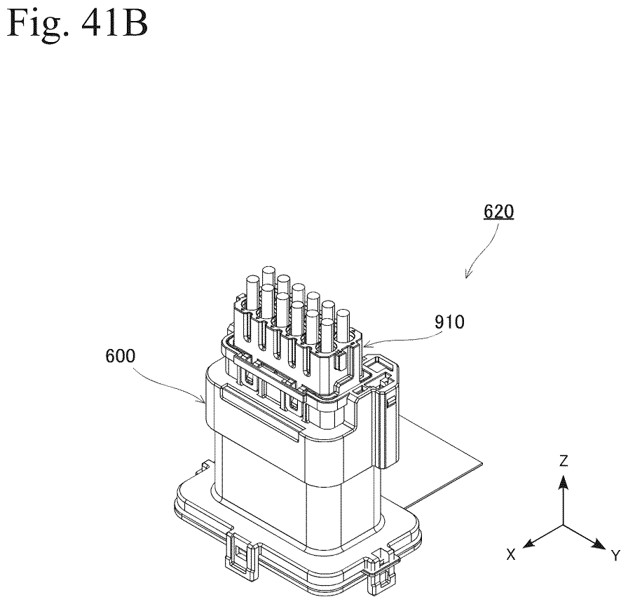

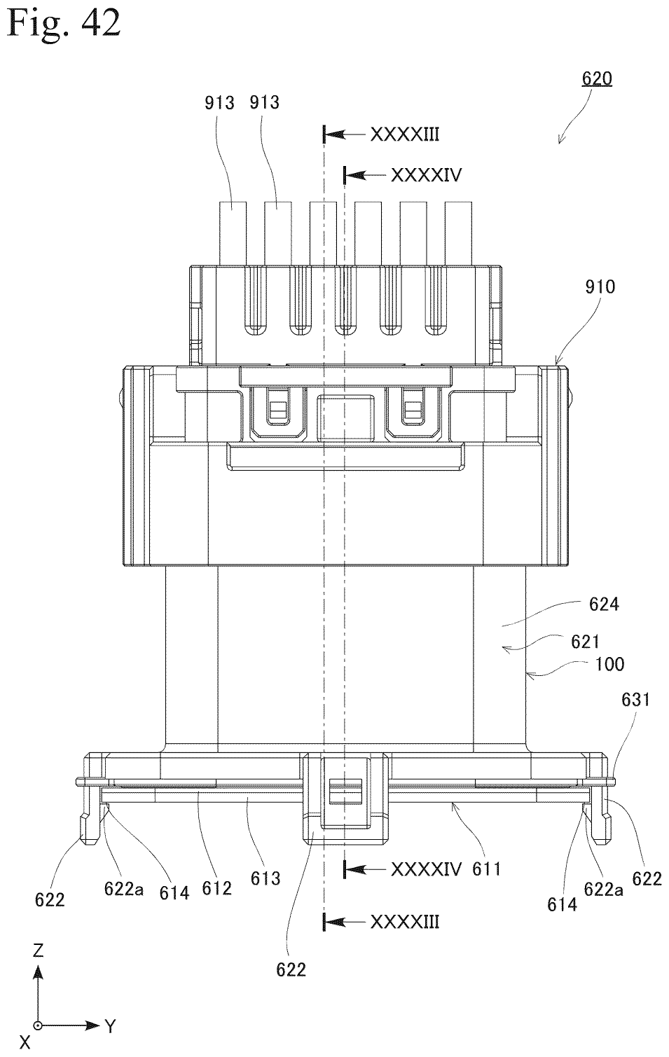

Furthermore, as illustrated in FIGS. 41A, 41B, and 42, in the board waterproofing connector 600 of the third embodiment, a connector assembly 620 can be formed by fitting the mating connector 910 into the fitting portion 623 of the fitting cover 621.

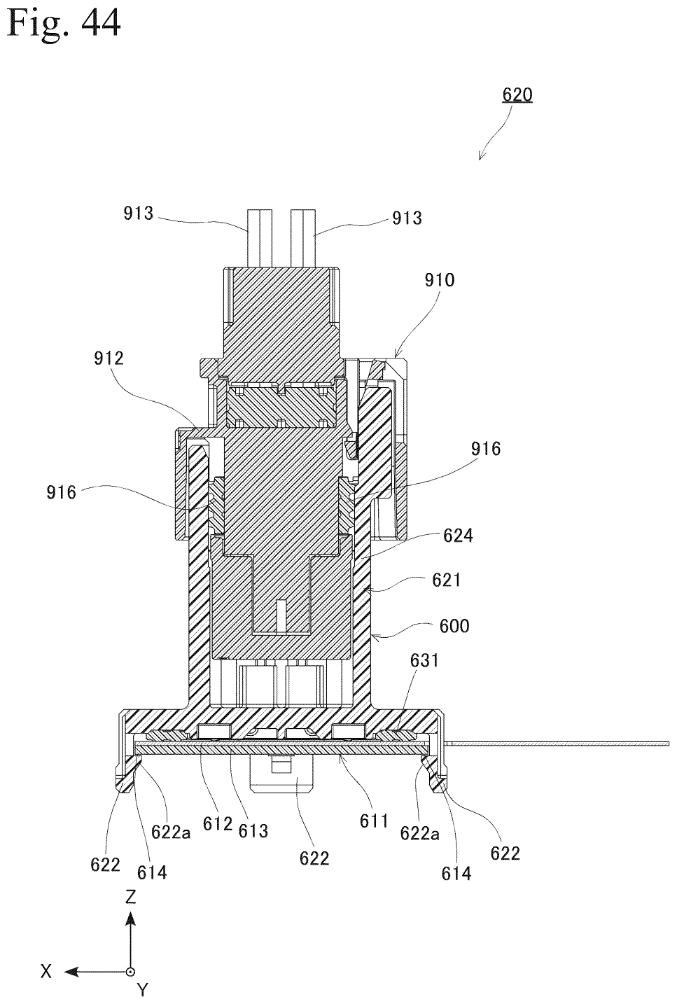

Here, as illustrated in FIG. 43, in the mating connector 910, a first waterproof member 915 is disposed between a mating cable 913 of the mating connector 910 and a mating housing 912 covering a side surface of the mating terminal 911. Additionally, the first waterproof member 915 is also disposed between a plurality of mating cables 913. Moreover, as illustrated in FIGS. 43 and 44, when the board waterproofing connector 600 according to the third embodiment and the mating connector 910 are fitted together, a second waterproof member 916 is disposed between the mating housing 912 and the fitting cover main body portion 624. That is, when the mating connector 910 is fitted into the board waterproofing connector 600 of the third embodiment, a gap formed between the board waterproofing connector 600 and the mating connector 910 can be sealed with the first waterproof member 915 and the second waterproof member 916, whereby the space between the board waterproofing connector 600 and the mating connector 910 can be waterproofed reliably. Moreover, as described above, by locking the lock claw 622 of the fitting cover 621 onto the locked portion 614 of the circuit board 611 with the seal member 631 sandwiched between the circuit board 611 and the fitting cover 621, the space between the circuit board 611 and the fitting cover 621 can be waterproofed reliably. That is, as illustrated in FIGS. 43 and 44, by fitting the mating connector 910 into the fitting portion 623 of the fitting cover 621 of the board waterproofing connector 600 of the third embodiment, the connector assembly 620 having a perfect waterproofing effect can be obtained.

Hereinabove, the third embodiment which is a possible embodiment of the board waterproofing connector of the present disclosure has been described with reference to FIGS. 28 to 44. Note, however, that the technical scope of the present disclosure is not limited to the scope described in the above third embodiment. Various modifications and improvements can be made in the above third embodiment. Note that in embodiments described below, members that are the same as or similar to the above third embodiment may be assigned the same reference numerals and descriptions thereof may be omitted.

### Fourth Embodiment

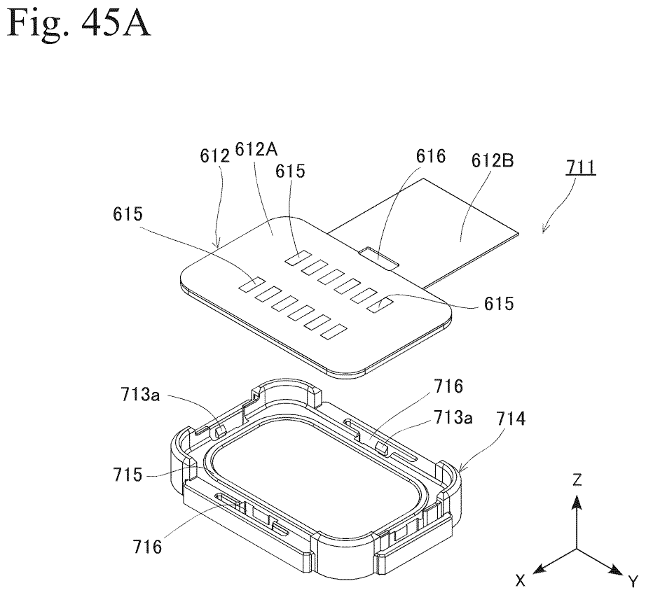

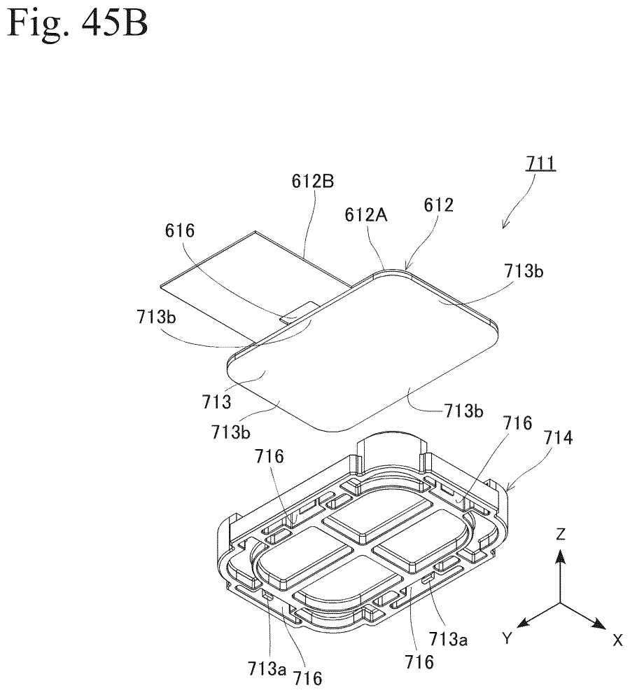

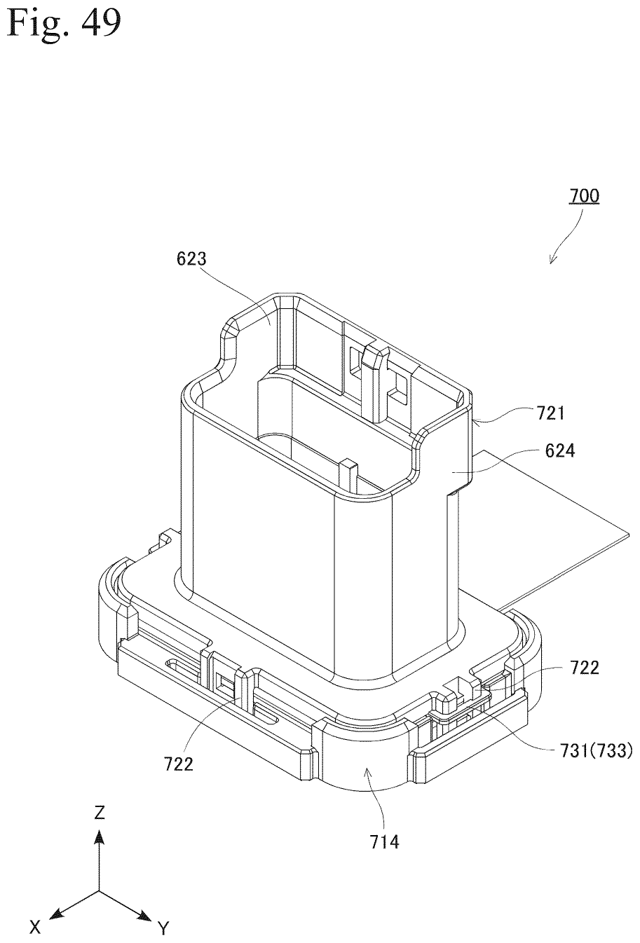

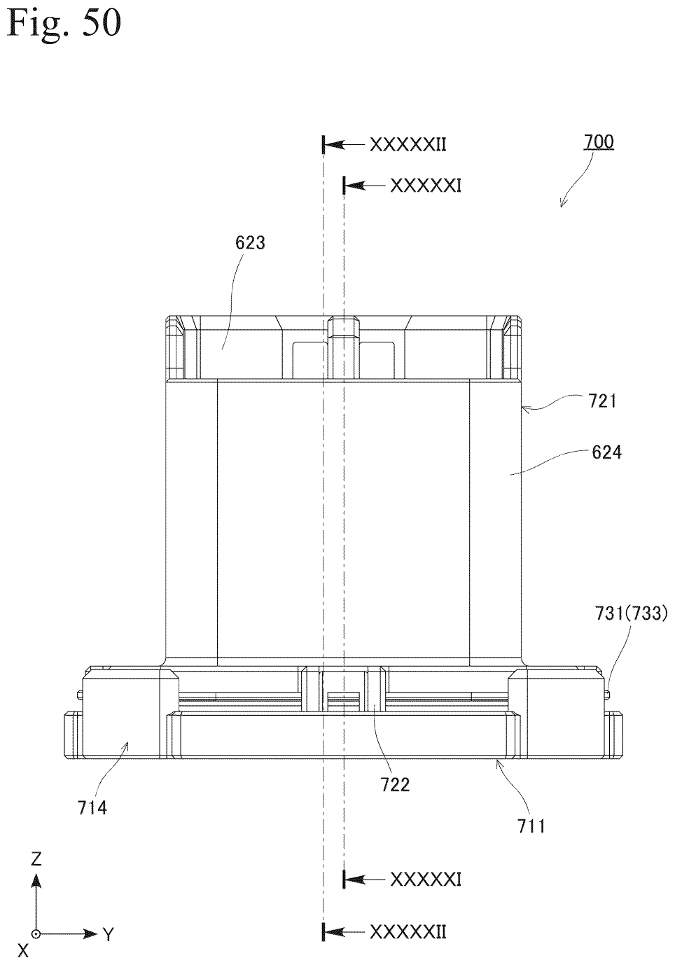

A board waterproofing connector 700 according to a fourth embodiment will be described with reference to FIGS. 45A to 52.

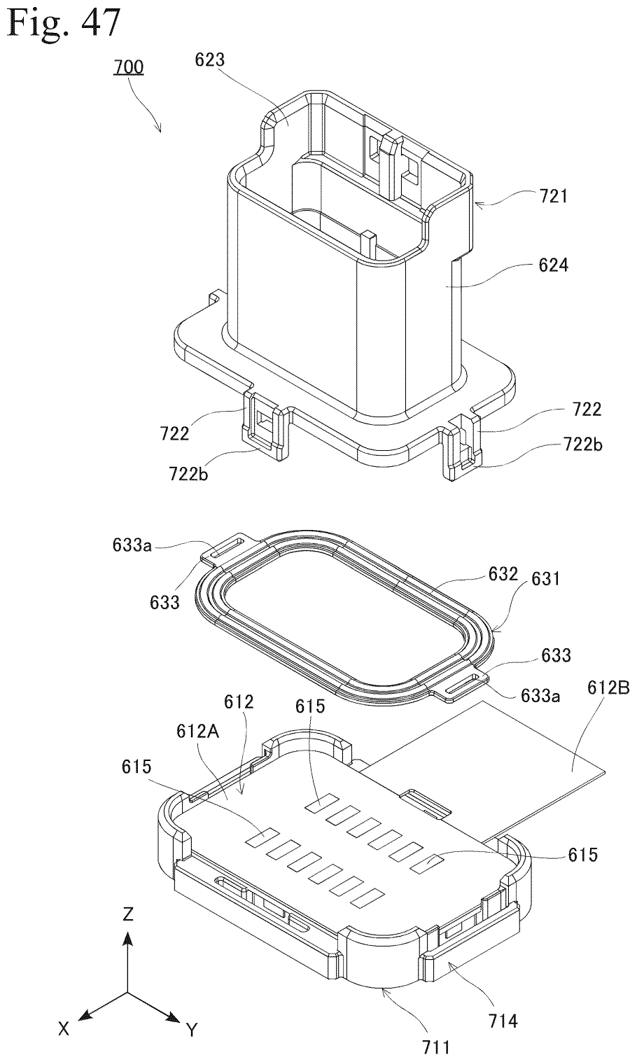

As illustrated in FIGS. 47 to 50, the board waterproofing connector 700 according to the fourth embodiment includes a circuit board 711, a fitting cover 721 having a fitting portion 623 into which a mating connector 910 is fitted and including a holding hole 626 as a holding portion that holds a metal terminal 650 therein, and a seal member 631 that demonstrates a sealing property by being sandwiched between the circuit board 711 and the fitting cover 721.

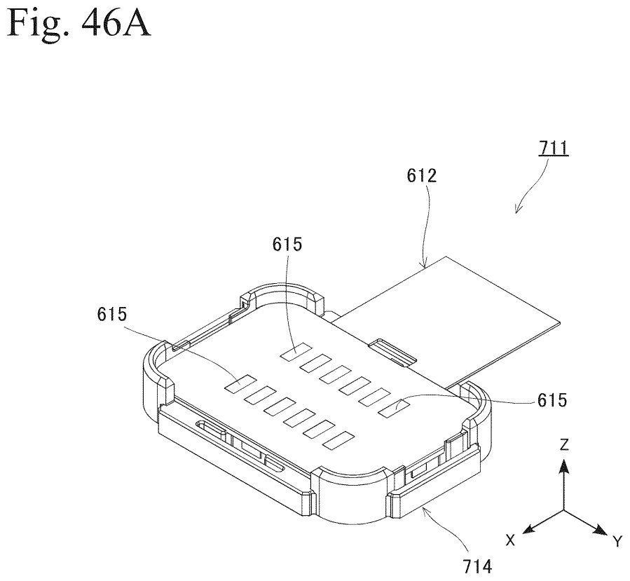

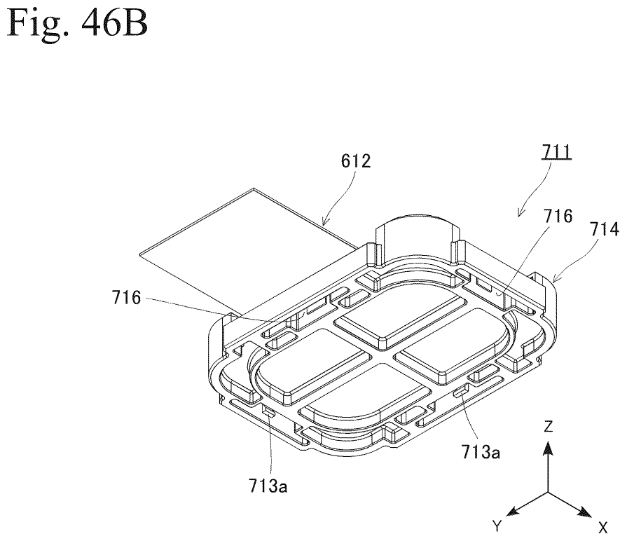

As illustrated in FIGS. 45A to 46B, the circuit board 711 includes a flexible plane conductor 612, a lining portion 713 provided on a rear side of a terminal forming portion 612A of the plane conductor 612, and a cover member 714 formed so as to cover the terminal forming portion 612A and the lining portion 713 from the rear side.

The lining portion 713 is attached to the entire rear surface of the terminal forming portion 612A to prevent deformation of the flexible terminal forming portion 612A. The lining portion 713 also includes, in parts at its front center, rear center, left center, and right center, an inner locked piece 713b which is a locked portion onto which an inner claw shape 722b formed in a lock claw 722 as a lock portion of the later-described fitting cover 721 can be locked.

The cover member 714 includes a protrusion 715 protruding upward (in +Z direction) which is toward the circuit board 711, a cover member penetration hole 716 through which the lock claw 722 of the fitting cover 721 can be inserted, and an outer locked piece 713a as a locked portion onto which an outer claw shape 722a formed in the lock claw 722 can be locked and formed on an inner wall of the cover member penetration hole 716.

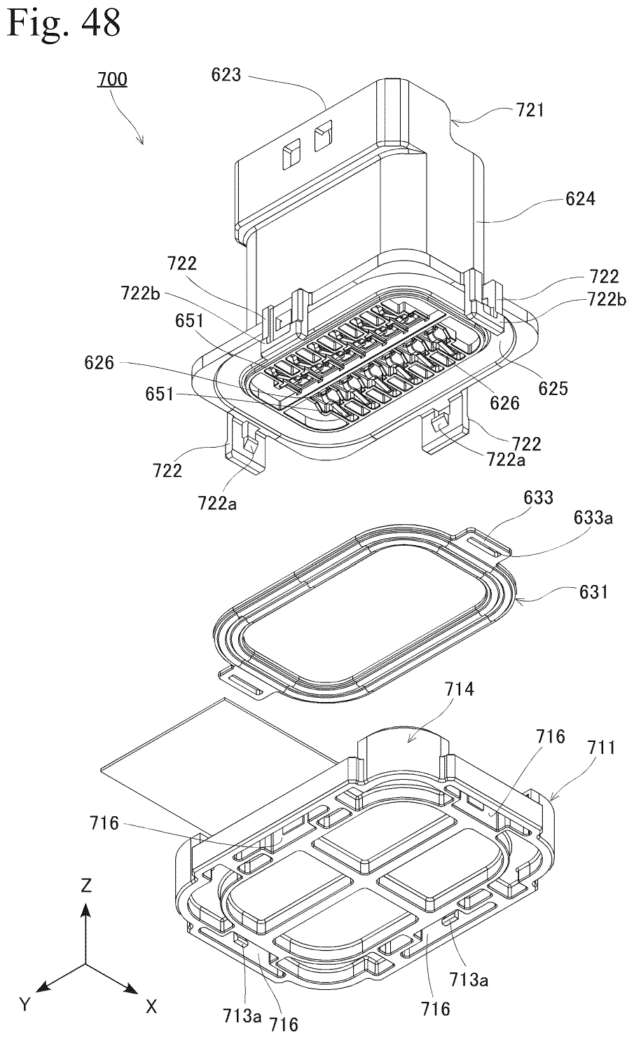

As illustrated in FIGS. 47 and 48, the fitting cover 721 includes a fitting portion 623 open in the up-down direction (±Z direction) which is the third direction and into which the mating connector 910 is fitted from above the opening, a fitting cover main body portion 624 formed so as to cover the periphery of the opening, and the lock claw 722 as a lock portion formed in a central lower part of each peripheral surface of the fitting cover main body portion 624.

The lock claw 722 extends downward, and a portion formed as the outer claw shape 722a protrudes toward a direction opposite to the central direction of the fitting cover main body portion 624 (toward the outside of the fitting cover main body portion 624). With this configuration, the outer claw shape 722a can be hooked onto the outer locked piece 713a as the locked portion of the cover member 714 of the circuit board 711. Additionally, in the lock claw 722, a portion formed as the inner claw shape 722b protrudes toward the central direction of the fitting cover main body portion 624 (toward the inside of the fitting cover main body portion 624). With this configuration, the inner claw shape 722b can be hooked onto the inner locked piece 713b as the locked portion of the lining portion 713 of the circuit board 711.

Here, the way of assembling the board waterproofing connector 700 of the fourth embodiment will be described. First, as illustrated in FIGS. 47 and 48, the circuit board 711 is assembled by installing the lining portion 713 on the rear surface of the terminal forming portion 612A of the plane conductor 612, and then attaching the plane conductor 612 with the lining portion 713 to the cover member 714 such that a rear surface of the lining portion 713 comes into contact with an upper surface of the cover member 714. Next, the metal terminal 650 is inserted into the holding hole 626 from below the fitting cover 721. At this time, a projection 653 formed in a held portion 652 of the metal terminal 650 causes the held portion 652 to be press-fitted into the holding hole 626 of the fitting cover 721 and causes a hook portion 654 of the metal terminal 650 to be hooked onto a hooked portion 627 formed in the holding hole 626. Furthermore, the lock claw 722 of the fitting cover 721 is inserted into a through-hole 633a of the seal member 631 to position and temporarily install the seal member 631 in the fitting cover 721.

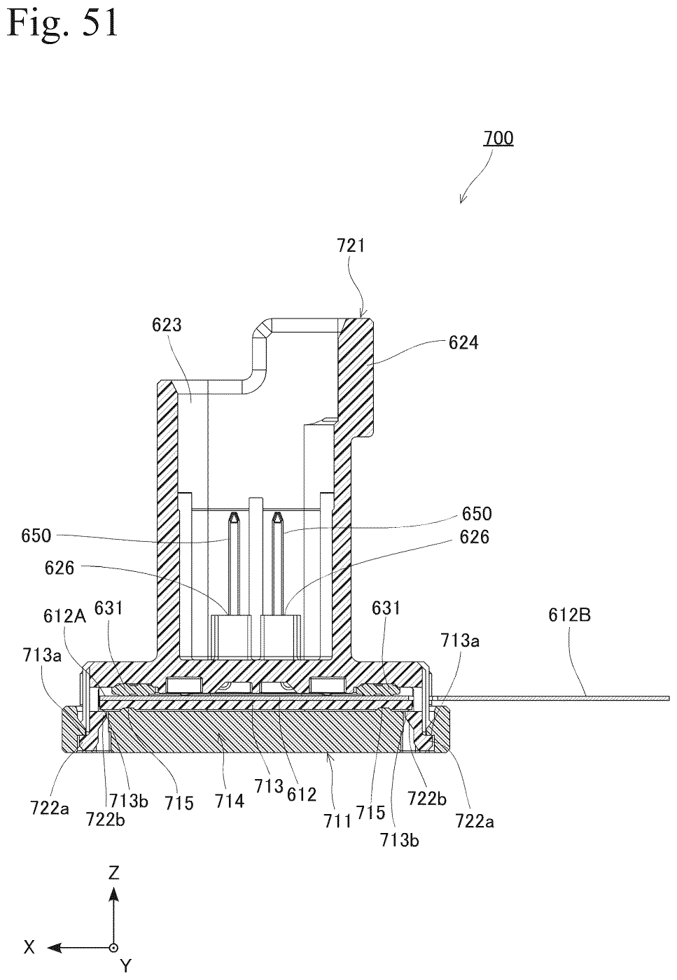

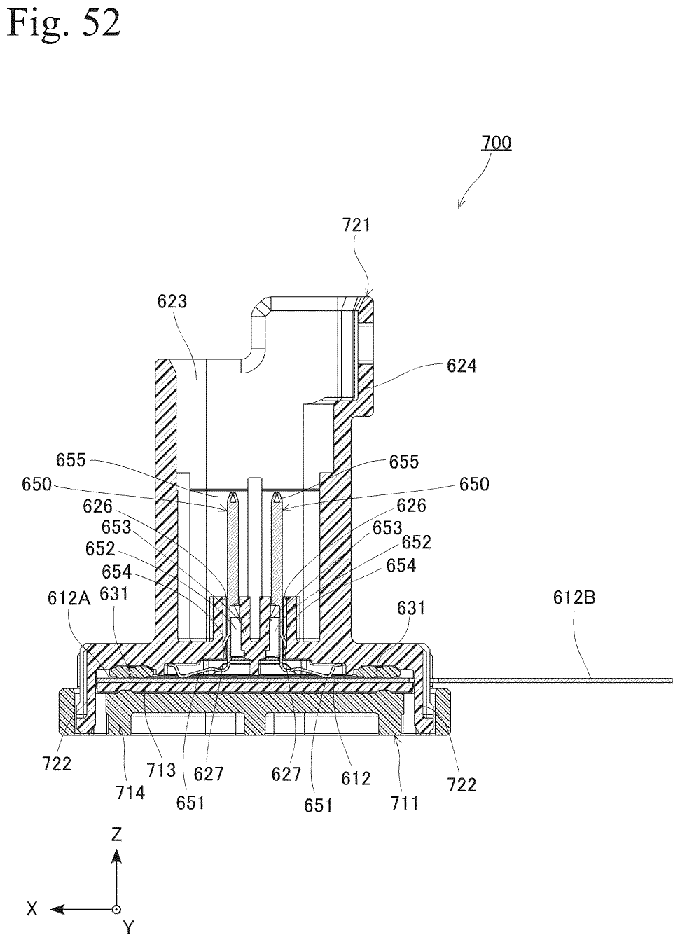

Thereafter, the lock claw 722 of the fitting cover 721 is pressed downward (in −Z direction) which is toward the circuit board 711, so that, as illustrated in FIG. 51 in particular, the part of the outer claw shape 722a of the lock claw 722 is hooked onto the outer locked piece 713a formed in the cover member 714 and the part of the inner claw shape 722b of the lock claw 722 is hooked onto the inner locked piece 713b formed in the lining portion 713 to lock the lock claw 722 and the locked portion together, and assembly of the board waterproofing connector 700 of the fourth embodiment is completed. At this time, as illustrated in FIG. 52, pressing the fitting cover 621 downward, which is toward the circuit board 611, causes a contact portion 651 of the metal terminal 650 to be pressed upward by the circuit board 711 to demonstrate the spring property acting downward, whereby contact between the contact portion 651 and the connection portion 615 is maintained.

As illustrated in FIG. 51, since the board waterproofing connector 700 of the fourth embodiment can sandwich the seal member 631 between the circuit board 711 and the fitting cover 721 and lock while pressing the fitting cover 721 against the circuit board 711, the space between the circuit board 711 and the fitting cover 721 can be waterproofed. At this time, the parts of the outer claw shapes 722a of the four lock claws 722 installed at the front, the left, the right, and the rear of the fitting cover 721 are hooked onto the outer locked pieces 713a as the locked portions installed at the front, the left, the right, and the rear of the cover member 714 of the circuit board 711, and the parts of the inner claw shapes 722b of the lock claws 722 are hooked onto the inner locked pieces 713b as the locked portions provided at the front, the left, the right, and the rear of the lining portion 713 of the circuit board 711, whereby the circuit board 711 and the fitting cover 721 are reliably fixed and held in the front-rear direction, the left-right direction, and the up-down direction. As a result, the board waterproofing connector 700 that reliably waterproofs the space between the circuit board 711 and the fitting cover 721 with a simple configuration can be implemented.

In addition, as illustrated in FIGS. 51 and 52, in the board waterproofing connector 700 according to the fourth embodiment, not only does the fitting cover 721 press the seal member 631 from above, but also the protrusion 715 formed in the cover member 714 presses the seal member 631 from below via the plane conductor 612 by the effect of the upwardly protruding shape (i.e., shape protruding toward the plane conductor 612) of the protrusion 715. By adopting such a configuration, in the board waterproofing connector 700 according to the fourth embodiment, the seal member 631 sandwiched between the circuit board 711 and the fitting cover 721 is pressed from upper and lower directions, whereby the gap between the circuit board 711 and the fitting cover 721 can be sealed reliably. Therefore, according to the board waterproofing connector 700 according to the fourth embodiment, the waterproofing property between the circuit board 711 and the fitting cover 721 can be improved even more.

### Fifth Embodiment

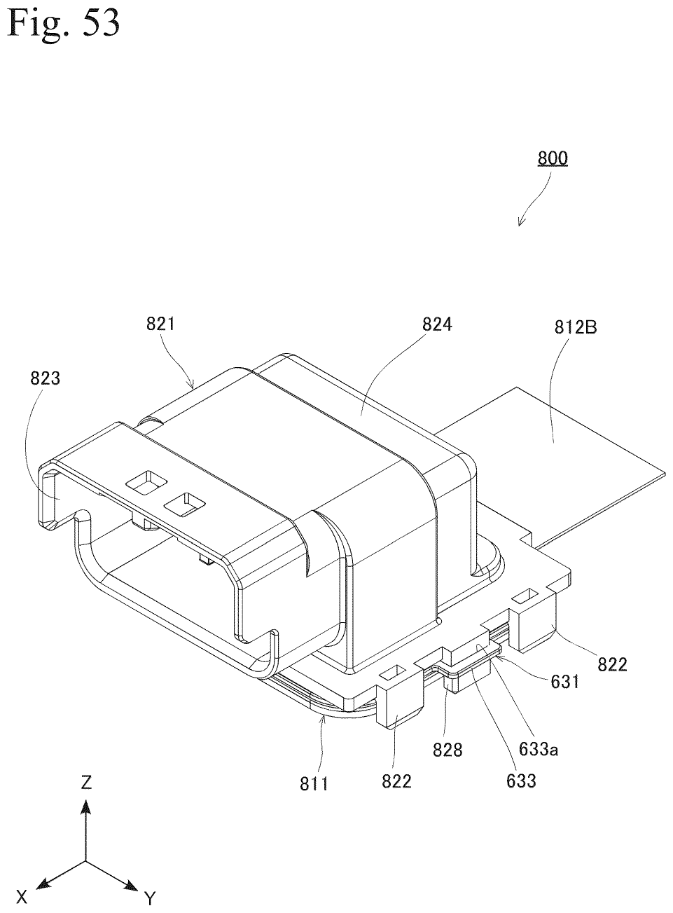

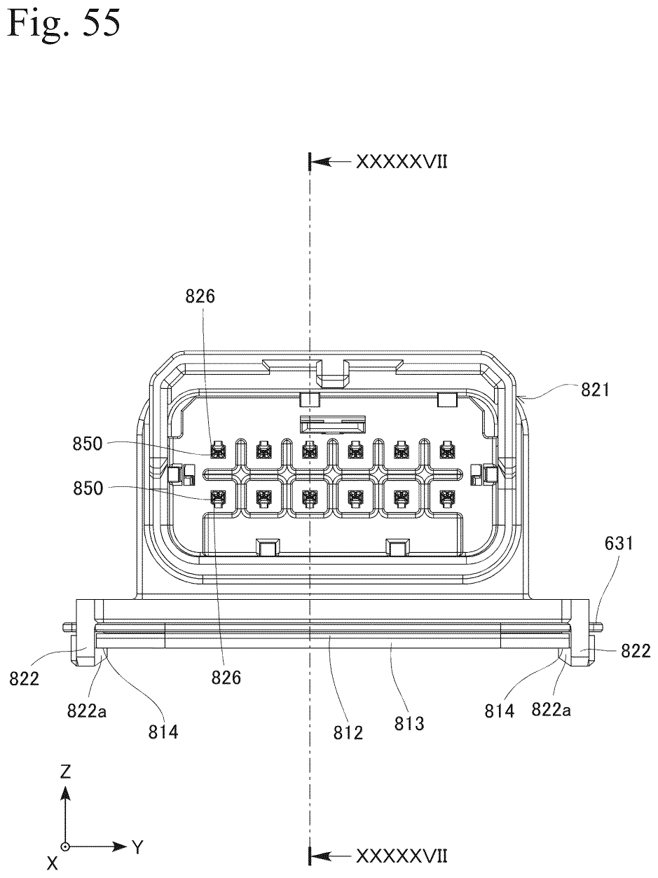

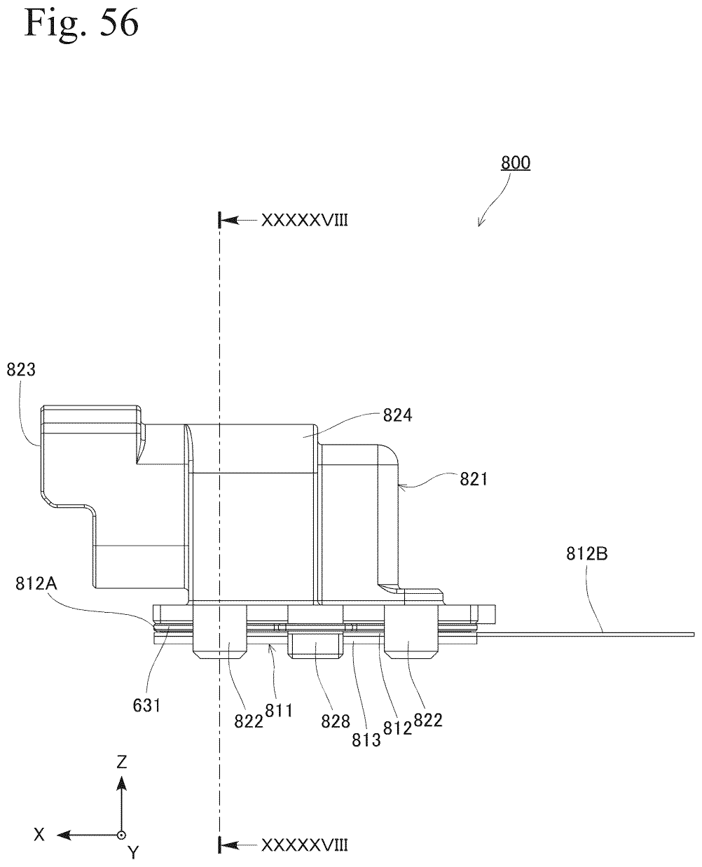

A configuration of a board waterproofing connector 800 according to a fifth embodiment will be described with reference to FIGS. 53 to 64B. As illustrated in FIGS. 53 to 60, the board waterproofing connector 800 according to the fifth embodiment includes a circuit board 811, a fitting cover 821 having a fitting portion 823 into which a mating connector 910 is fitted and including a holding hole 826 as a holding portion that holds a metal terminal 850 therein, and a seal member 631 that demonstrates a sealing property by being sandwiched between the circuit board 811 and the fitting cover 821.

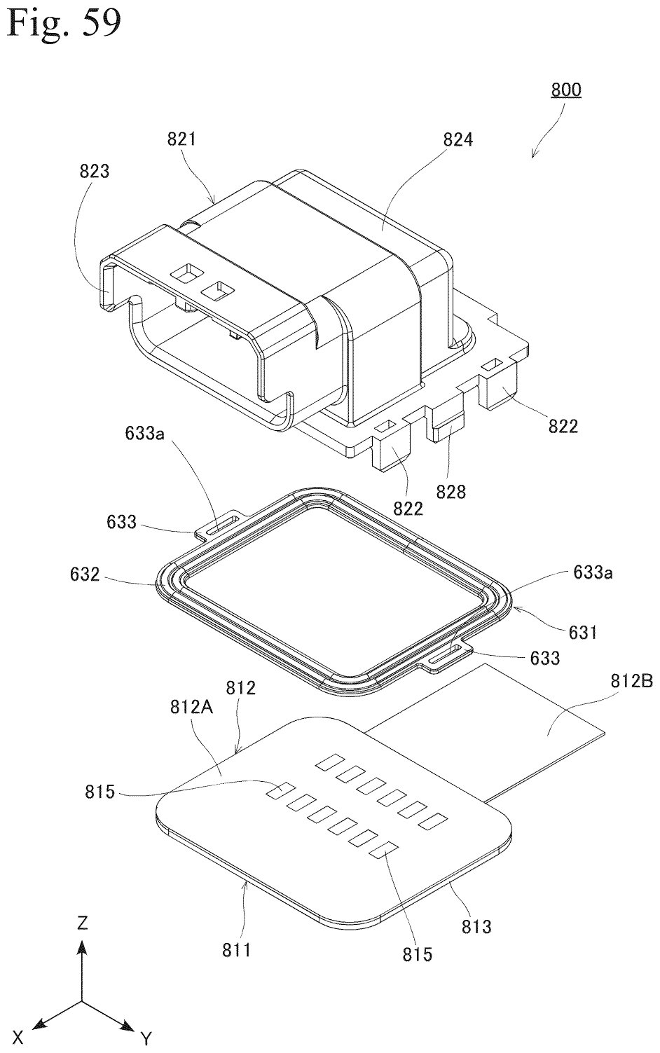

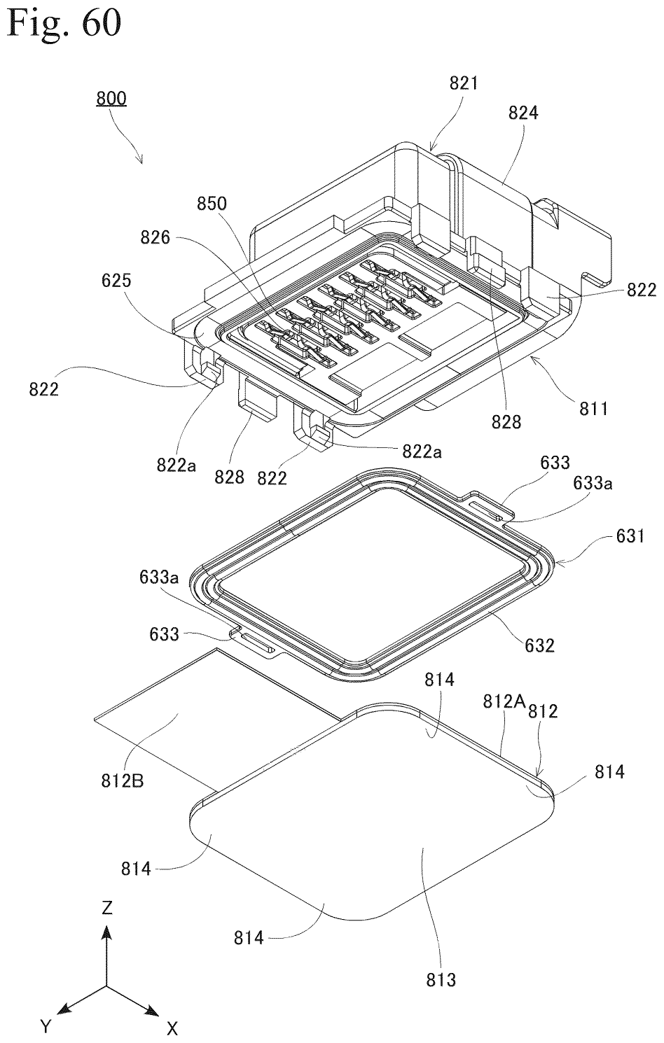

As illustrated in FIGS. 59 and 60, the circuit board 811 includes a flexible plane conductor 812 and a lining portion 813 on a rear surface of the plane conductor 812. In the fifth embodiment, the rear surface of the flexible plane conductor 812 on which the lining portion 813 is provided is a surface opposite to the surface on which the fitting cover 821 is placed on the circuit board 811. In addition, in the fifth embodiment, a flexible printed circuit (FPC) is used as the plane conductor 812.

The plane conductor 812 includes a terminal forming portion 812A and an extension portion 812B extending in the rear direction (−X direction) which is the first direction from the terminal forming portion 812A. The terminal forming portion 812A has a plurality of connection portions 815 near its center, and the plurality of connection portions 815 can respectively be connected to contact portions 851 of the metal terminal 850 described later.

The lining portion 813 is attached to the entire rear surface of the terminal forming portion 812A to prevent deformation of the flexible terminal forming portion 812A. The lining portion 813 also includes, in parts at its front left side, rear left side, front right side, and rear right side, a locked portion 814 onto which a lock claw 822 as a lock portion of the later-described fitting cover 821 can be locked.

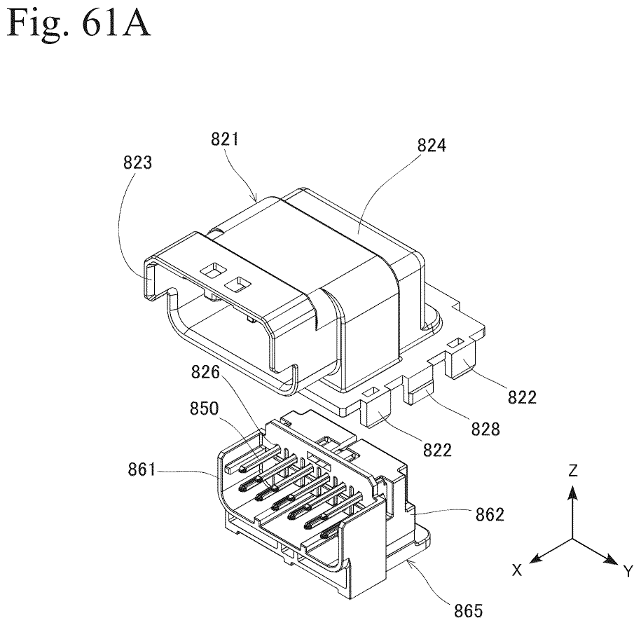

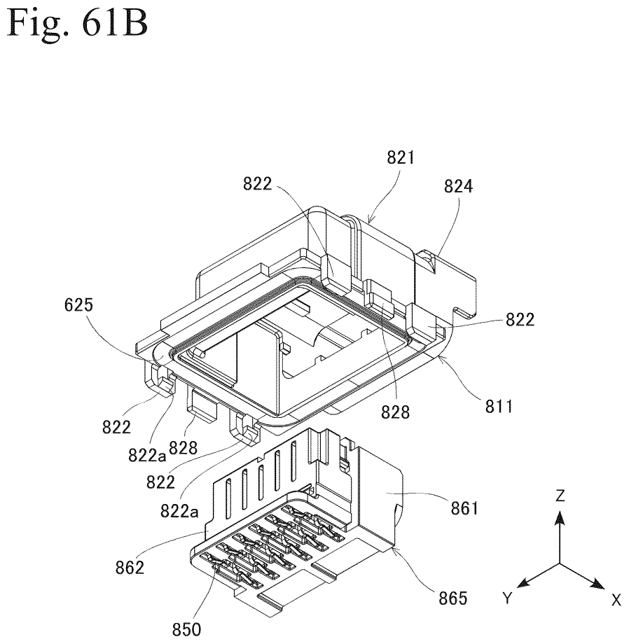

As illustrated in FIGS. 61A and 61B, the fitting cover 821 has a substantial L shape when viewed in the left-right direction (±Y direction) which is the second direction, and includes the fitting portion 823 open to the front (+X direction) which is the first direction and the lower side (−Z direction) which is the third direction and into which the mating connector 910 is fitted from the front, a fitting cover main body portion 824 formed so as to cover the periphery of the opening, the lock claw 822 as a lock portion formed in a lower part of the fitting cover main body portion 824 on the front left side, the rear left side, the front right side, and the rear right side, a positioning claw 828 formed at the left center and the right center, a first insulator 861 having the holding hole 826 holding the metal terminal 850, and a second insulator 862 joined to the first insulator 861.

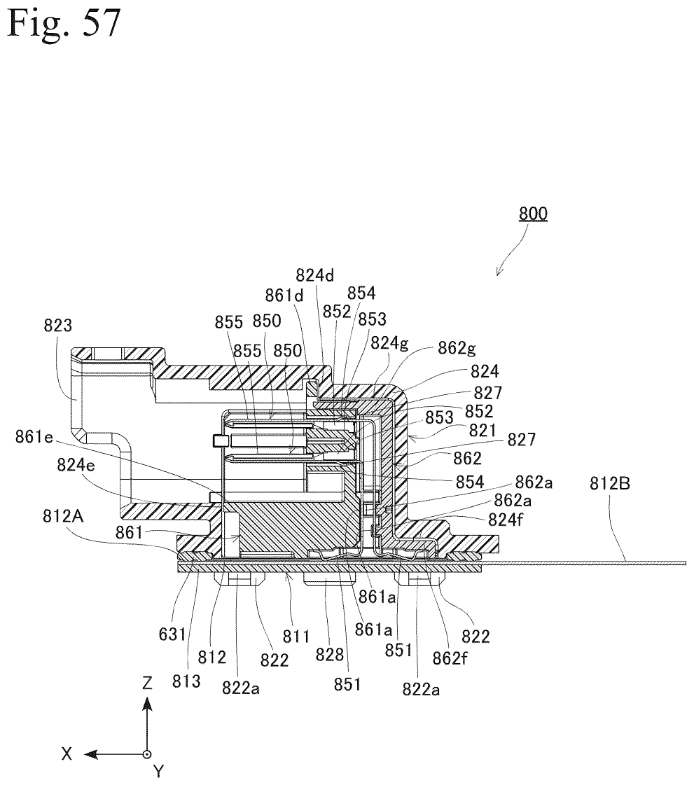

As illustrated in FIG. 57, the fitting cover main body portion 824 includes therein a first receiving portion 824d with which a first edge 861d (described later) of the first insulator 861 comes into contact from the front, a second receiving portion 824e with which a second edge 861e (described later) of the first insulator 861 comes into contact from the rear, a third receiving portion 824f with which a third edge 862f (described later) of the second insulator 862 comes into contact from below, and a fourth receiving portion 824g with which a fourth edge 862g (described later) of the second insulator 862 comes into contact from below.

The lock claw 822 extends downward and has a portion formed as a claw shape 822a protruding toward the central direction of the fitting cover main body portion 824 (toward the inside of the fitting cover main body portion 824), and the claw shape 822a can be hooked onto the locked portion 814 of the circuit board 811.

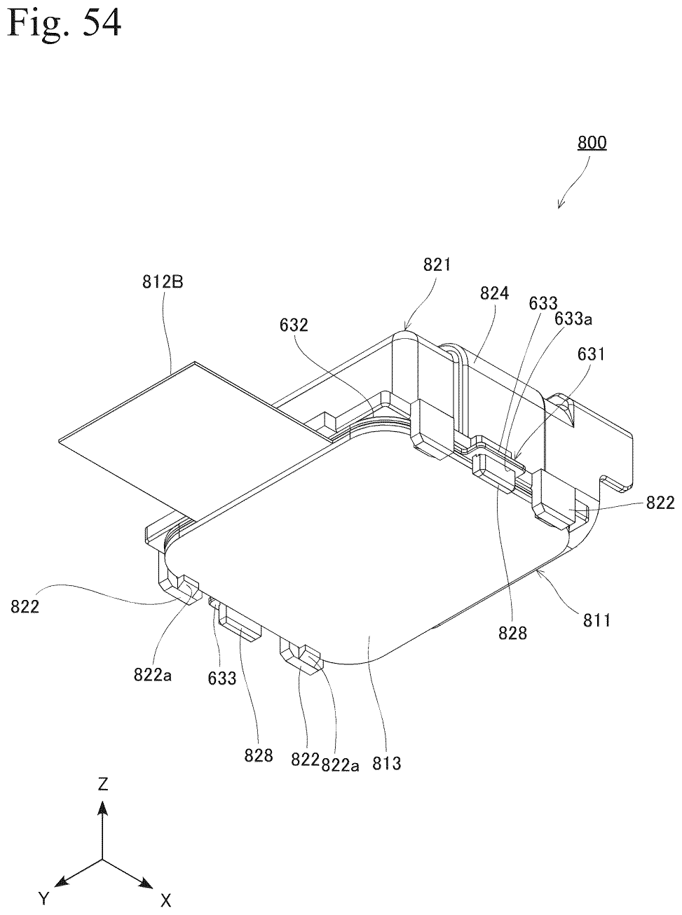

The positioning claw 828 extends downward and can be inserted into a through-hole 633a formed in the seal member 631 (see FIGS. 53 and 54).

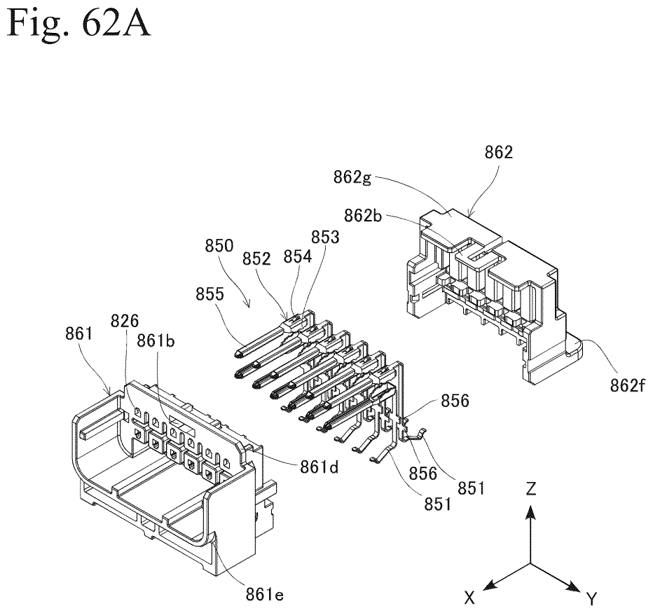

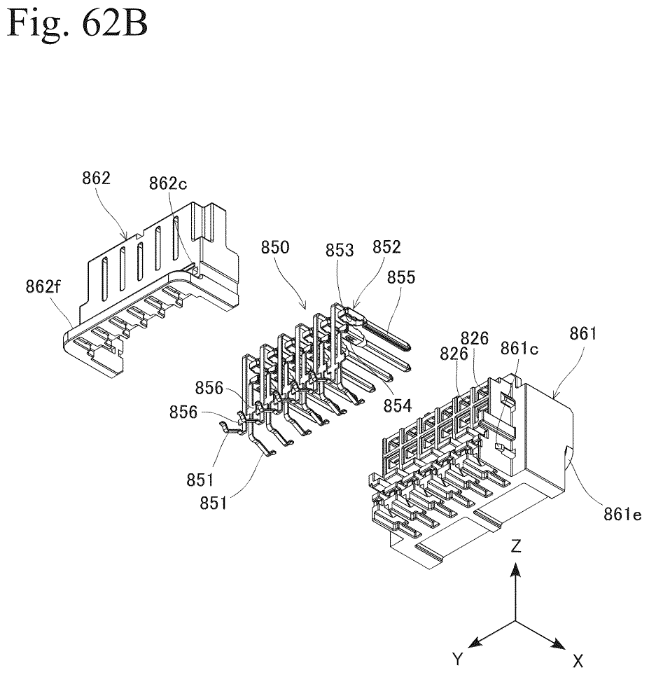

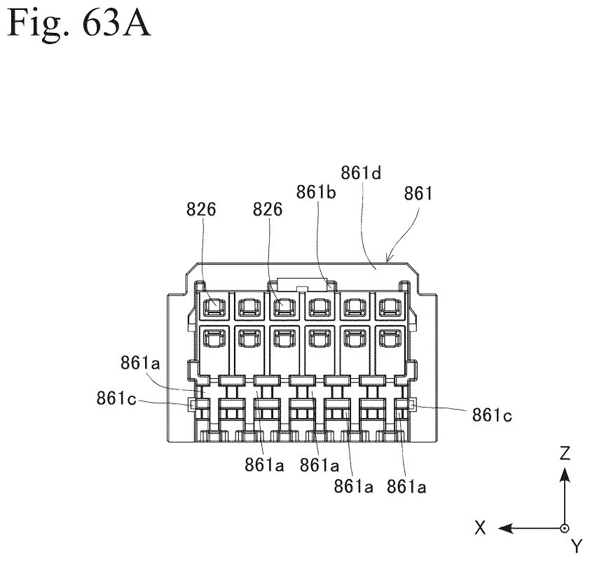

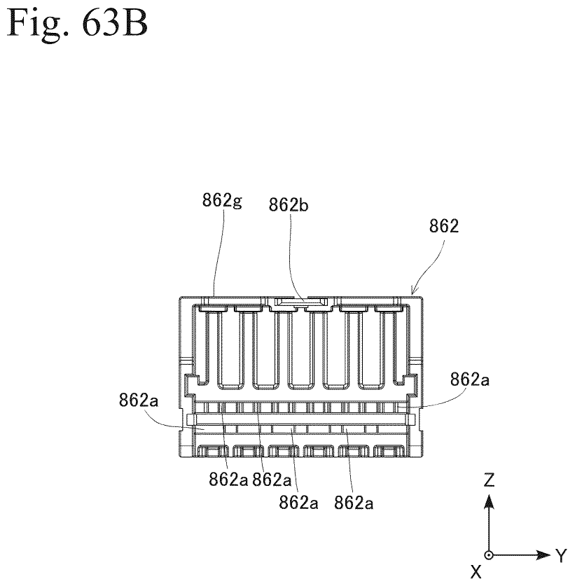

As illustrated in FIG. 57, the first insulator 861 can be joined to the second insulator and stored inside the fitting cover main body portion 824. Additionally, as illustrated in FIGS. 62A to 63B, the first insulator 861 includes the holding hole 826 into which the metal terminal 850 is inserted, a first supporting portion 861a for supporting the metal terminal 850 on a rear surface, a second insulator insertion hole 861b into which an insertion piece 862b of the second insulator 862 can be inserted at a central upper portion of the plurality of holding holes 826, and, on each of a left side surface and a right side surface, a joint piece 861c having a claw shape, the first edge 861d that comes into contact with the first receiving portion 824d of the fitting cover main body portion 824, and the second edge 861e that comes into contact with the second receiving portion 824e of the fitting cover main body portion 824.

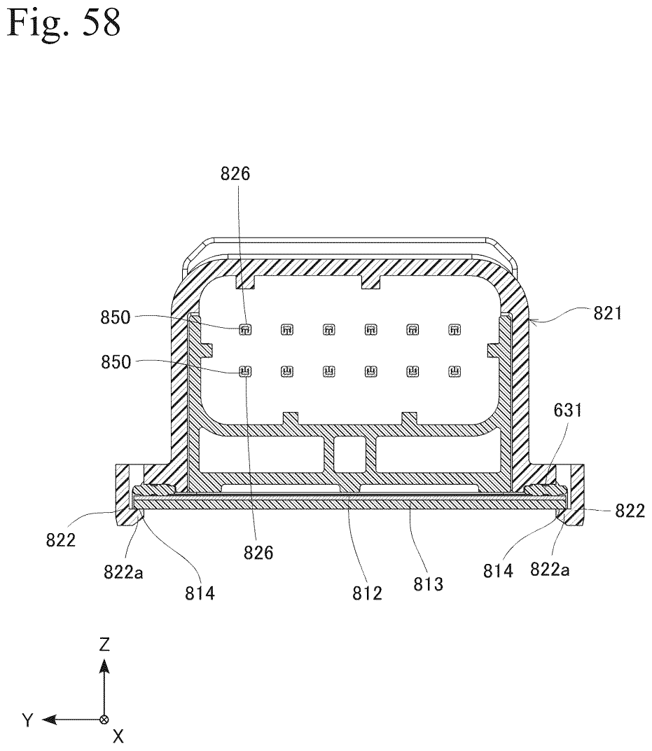

As illustrated in FIG. 58, the holding hole 826 penetrates in the front-rear direction (±x direction) which is the first direction, and is formed as a plurality of holes into which a plurality of the metal terminals 850 are inserted. As illustrated in FIG. 57, a hooked portion 827 onto which a hook portion 854 formed in a held portion 852 of the metal terminal 850 is hooked when the metal terminal 850 is inserted into the holding hole 826 is formed in each of the plurality of holding holes 826.

As illustrated in FIGS. 62A to 63B, the second insulator 862 includes a second supporting portion 862a that supports the metal terminal 850, the insertion piece 862b formed at the upper central portion and inserted into the second insulator insertion hole 861b of the first insulator 861, a joint piece receiving portion 862c formed on each of a left side surface and a right side surface and onto which the joint piece 861c of the first insulator 861 is hooked, the third edge 862f formed in a rear lower portion and coming into contact with the third receiving portion 824f of the fitting cover main body portion 824, and the fourth edge 862g formed in an upper portion and coming into contact with the fourth receiving portion 824g of the fitting cover main body portion 824.

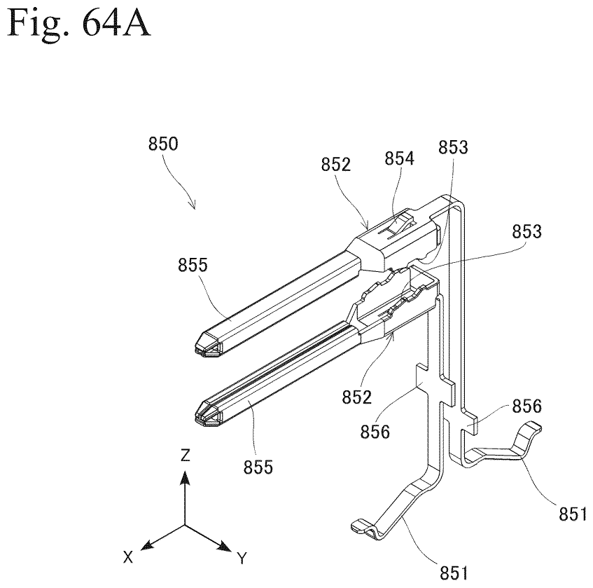

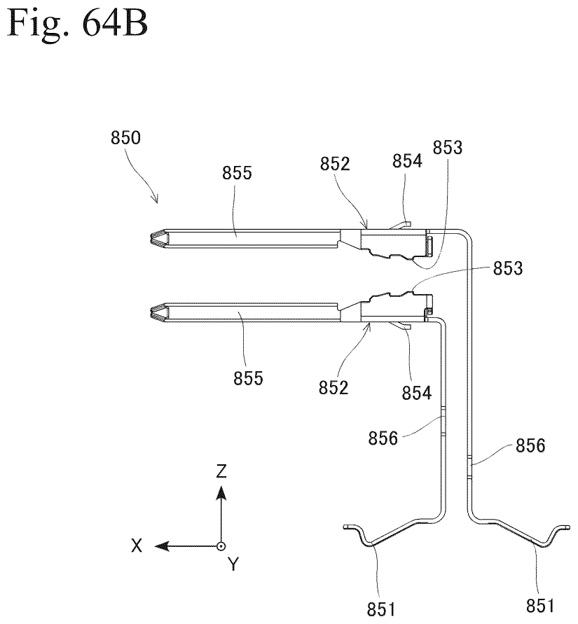

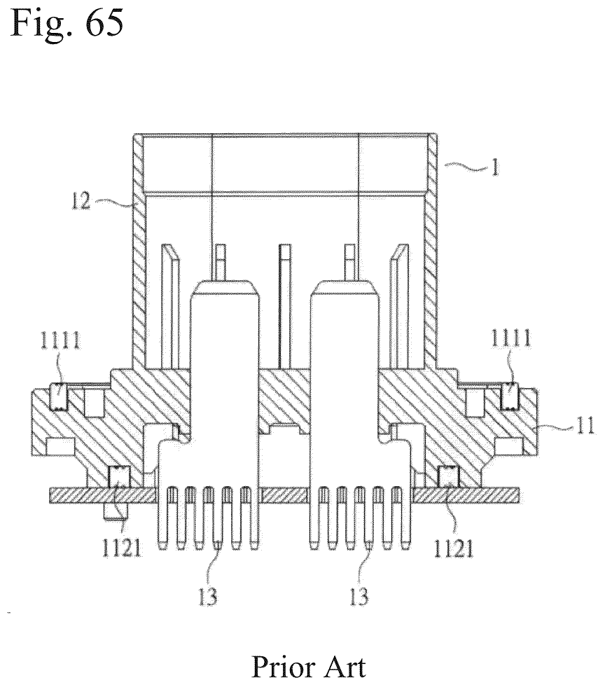

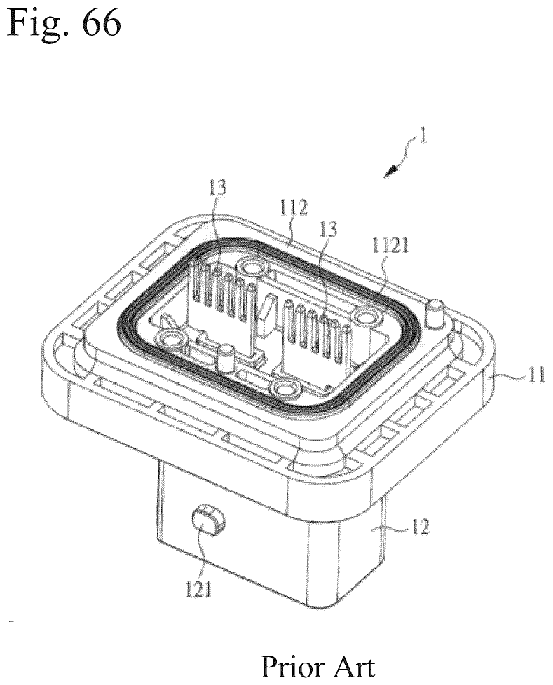

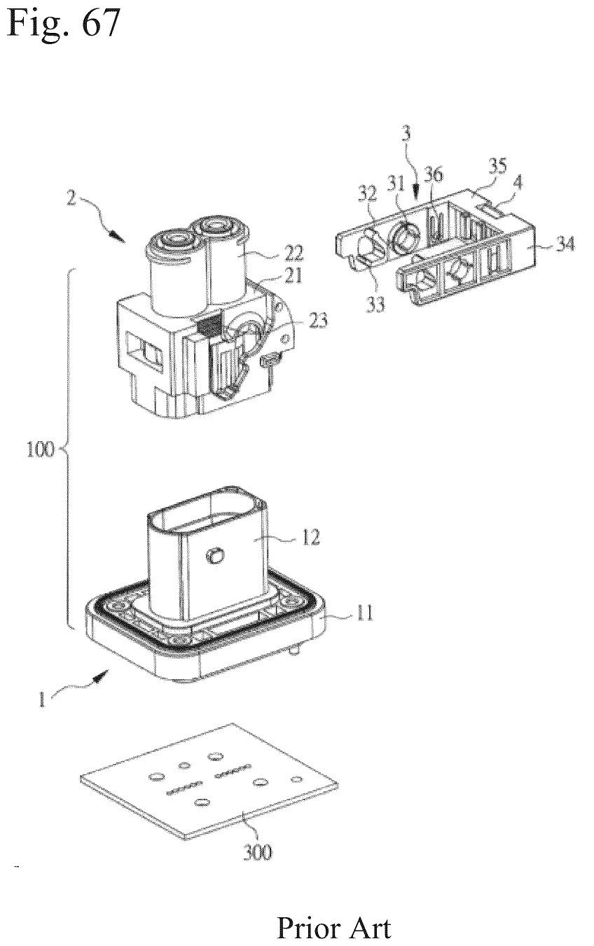

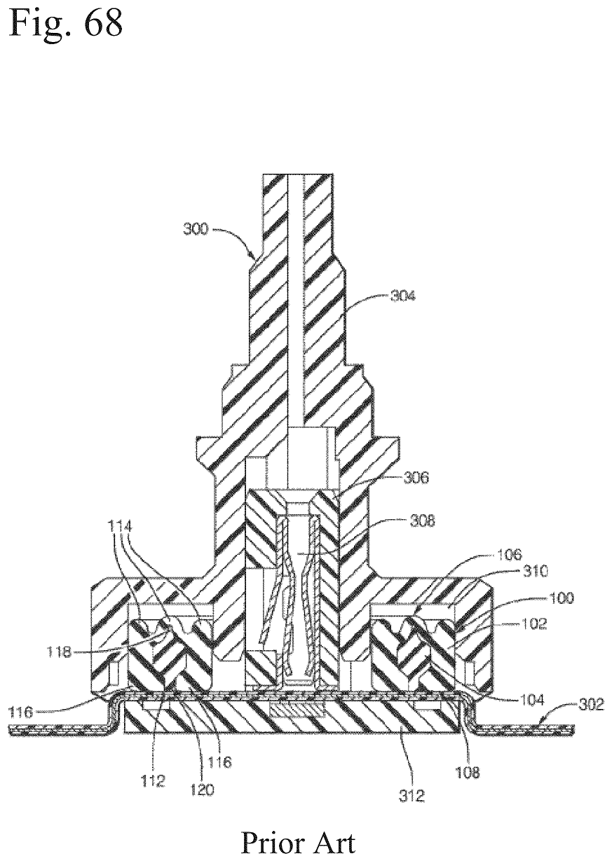

As illustrated in FIGS. 64A and 64B, the metal terminal 850 has a substantial L shape, and includes the spring-like contact portion 851 for contacting the plane conductor 812 of the circuit board 811 on the lower end side which is one end side, a wing portion 856 formed in a straight portion extending to an upper part of the contact portion 851 and extending in the left-right direction, the held portion 852 held in the holding hole 826 formed in the first insulator 861 on the front end side which is the other end side, and a mating terminal contact portion 855 extending from the held portion 852 to the front end and coming into contact with a mating terminal 911 of the mating connector 910.

Each of the contact portions 851 curves and extends toward the outside in the front-rear direction (±X direction) which is the first direction, and demonstrates a spring property acting downward when pressed upward from the lower side.

Each of the held portions 852 includes a projection 853 formed toward the inside in the up-down direction (±Z direction) which is the third direction, and the hook portion 854 formed toward the outside in the up-down direction. The projection 853 demonstrates a function of press-fitting the held portion 852 into the holding hole 826 when the held portion 852 of the metal terminal 850 is inserted into the holding hole 826 formed in the first insulator 861. Additionally, the hook portion 854 is formed so as to be hooked onto the hooked portion 827 of the holding hole 826.

The mating terminal contact portion 855 is configured to electrically connect with the mating terminal 911 of the mating connector 910 to deliver electric signals, electric power, and the like.

The wing portion 856 is formed at a part which is sandwiched between the first supporting portion 861a of the first insulator 861 and the second supporting portion 862a of the second insulator 862 when the first insulator 861 and the second insulator 862 are joined together with the metal terminal 850 inserted into the holding hole 826.

The first insulator 861 can hold the metal terminal 850 by inserting the metal terminal 850 into the holding hole 826. At this time, the first supporting portion 861a of the first insulator 861 and a front surface of the wing portion 856 of the metal terminal 850 come into contact with each other.

The second insulator 862 can form an insulator joint body 865 in which the second insulator 862 is joined to the first insulator 861 by inserting the insertion piece 862b into the second insulator insertion hole 861b of the first insulator 861 with the metal terminal 850 held by the first insulator 861. At this time, the joint piece 861c of the first insulator 861 is hooked onto the joint piece receiving portion 862c of the second insulator 862 to hold the sufficiently joined state of the first insulator 861 and the second insulator 862.

Additionally, the second supporting portion 862a of the second insulator 862 and a rear surface of the wing portion 856 of the metal terminal 850 come into contact with each other. That is, the wing portion 856 has the front surface and the rear surface sandwiched by the first supporting portion 861a of the first insulator 861 and the second supporting portion 862a of the second insulator 862, so that the straight portion on the lower end side which is the one end side of the metal terminal 850 is held stably.

Here, the way of assembling the board waterproofing connector 800 of the fifth embodiment will be described. First, as illustrated in FIGS. 59 and 60, the circuit board 811 is assembled by installing the lining portion 813 on the rear surface of the terminal forming portion 812A of the plane conductor 812. Next, the metal terminal 850 is inserted into the holding hole 826 by directing the mating terminal contact portion 855 side of the metal terminal 850 toward the rear surface side of the first insulator 861. Thus, the projection 853 formed in the held portion 852 of the metal terminal 850 is press-fitted into the holding hole 826 of the first insulator 861, and the hook portion 854 formed in the held portion 852 of the metal terminal 850 is hooked onto the hooked portion 827 formed in the holding hole 826. At this time, the first supporting portion 861a of the first insulator 861 and the front surface of the wing portion 856 of the metal terminal 850 come into contact with each other.

Next, the insulator joint body 865 in which the second insulator is joined to the first insulator is formed by inserting the insertion piece 862b of the second insulator 862 into the second insulator insertion hole 861b of the first insulator 861. At this time, the joint piece 861c of the first insulator 861 is hooked onto the joint piece receiving portion 862c of the second insulator 862 to hold the sufficiently joined state of the first insulator 861 and the second insulator 862. Additionally, the second supporting portion 862a of the second insulator 862 and the rear surface of the wing portion 856 of the metal terminal 850 come into contact with each other.

Next, the insulator joint body 865 is inserted from the lower opening of the fitting cover main body portion 824 to store the insulator joint body 865 inside the fitting cover main body portion 824. At this time, as illustrated in FIG. 57, the first edge 861d of the first insulator 861 comes into contact with the first receiving portion 824d formed in the fitting cover main body portion 824 from the front, the second edge 861e of the first insulator 861 comes into contact with the second receiving portion 824e from the rear, the third edge 862f of the second insulator 862 comes into contact with the third receiving portion 824f from below, and the fourth edge 862g of the second insulator 862 comes into contact with the fourth receiving portion 824g from below.

Furthermore, by inserting the positioning claw 828 of the fitting cover 821 into the through-hole 633a of the seal member 631, the seal member 631 is positioned and temporarily installed in the fitting cover 821. Thereafter, the lock claw 822 of the fitting cover 821 is pressed downward (in −Z direction) which is toward the circuit board 811, so that, as illustrated in FIGS. 53 to 58, the part of the claw shape 822a of the lock claw 822 is hooked onto the locked portion 814 formed in the lining portion 813 to lock the lock claw 822 and the locked portion 814 together, and assembly of the board waterproofing connector 800 of the fifth embodiment is completed. At this time, as illustrated in FIG. 57, pressing the fitting cover 821 downward, which is toward the circuit board 811, causes the contact portion 851 of the metal terminal 850 to be pressed upward by the circuit board 811 to demonstrate the spring property acting downward, whereby contact between the contact portion 851 and the connection portion 815 is maintained.

As illustrated in FIGS. 57 and 58, since the board waterproofing connector 800 of the fifth embodiment can sandwich the seal member 631 between the circuit board 811 and the fitting cover 821 and lock while pressing the fitting cover 821 against the circuit board 811, the space between the circuit board 811 and the fitting cover 821 can be waterproofed appropriately. At this time, particularly as illustrated in FIG. 58, the parts of the claw shapes 822a of the lock claws 822 installed at the front left, the rear left, the front right, and the rear right of the fitting cover 821 are hooked onto the locked portions 814 installed at the front left, the rear left, the front right, and the rear right of the lining portion 813 of the circuit board 811, whereby the circuit board 811 and the fitting cover 821 are reliably fixed and held in the left-right direction and the up-down direction. As a result, the board waterproofing connector 800 that reliably waterproofs the space between the circuit board 811 and the fitting cover 821 with a simple configuration can be implemented.

Additionally, in the fifth embodiment, the metal terminal 850 has a substantial L shape, the insulator joint body 865 is formed by sandwiching the wing portion 856 of the metal terminal 850 by the first insulator 861 and the second insulator 862, and the metal terminal 850 is stored inside the fitting cover main body portion 824. With such a configuration, even though the L-shaped metal terminal 850 cannot be stored when the holding hole is formed integrally inside the fitting cover main body portion, the metal terminal 850 can be stored inside the fitting cover main body portion 824.

Additionally, in the fifth embodiment, the front surface and the rear surface of the wing portion 856 of the metal terminal 850 are sandwiched by the first supporting portion 861a of the first insulator 861 and the second supporting portion 862a of the second insulator 862. That is, with the structure in which the metal terminal 850 is sandwiched by the first insulator 861 and the second insulator 862, the metal terminal 850 is fixedly supported, and a stable connection between the circuit board 811 and the mating connector 910 can be maintained.

Furthermore, in the fifth embodiment, in the insulator joint body 865 stored inside the fitting cover main body portion 824, the first edge 861d of the first insulator 861 comes into contact with the first receiving portion 824d formed in the fitting cover main body portion 824 from the front, the second edge 861e of the first insulator 861 comes into contact with the second receiving portion 824e from the rear, the third edge 862f of the second insulator 862 comes into contact with the third receiving portion 824f from below, and the fourth edge 862g of the second insulator 862 comes into contact with the fourth receiving portion 824g from below. That is, both the front and the rear of the insulator joint body 865 stored inside the fitting cover main body portion 824 are in contact with the fitting cover main body portion 824, so that even when the mating connector 910 is fitted into the fitting portion 823 from the front of the fitting cover 821, the insulator joint body 865 does not move inside the fitting cover main body portion 824 and can be stably connected to the mating connector 910. Additionally, since the upper part of the insulator joint body 865 stored inside the fitting cover main body portion 824 is in contact with the fitting cover main body portion 824, even when the circuit board 811 is pushed in from below the fitting cover 821, the insulator joint body 865 does not move inside the fitting cover main body portion 824 and can be stably connected to the circuit board 811.

Although suitable embodiments of the present disclosure have been described above, the technical scope of the present disclosure is not limited to the scope described in the embodiments. Various modifications and improvements can be made in the above embodiments.

For example, in the fifth embodiment, the metal terminal 850 has a substantial L shape. However, according to the board waterproofing connector of the present disclosure, any shape of a metal terminal can be applied. That is, by forming an insulator joint body in which a metal terminal is sandwiched by two insulators and storing the insulator joint body in the fitting cover main body portion, metal terminals of various shapes can be stored inside the fitting cover main body portion.

It is apparent from the description of the scope of claims that modes including such modifications and improvements are also included in the technical scope of the present disclosure.

### REFERENCE SIGNS LIST

100 board waterproofing connector (of first embodiment)
200 board waterproofing connector (of second embodiment)
300 board waterproofing connector (of modification example)
400 board waterproofing connector (of another modification example)
500 board waterproofing connector (of yet another modification example)
600 board waterproofing connector (of third embodiment)
700 board waterproofing connector (of fourth embodiment)
800 board waterproofing connector (of fifth embodiment)
11 circuit board
12 plane conductor
12A terminal forming portion
12B extension portion
13 lining portion
14 locked portion
15 connection portion
16 plane conductor penetration hole
21 fitting cover
22 lock claw (lock portion)
22a claw shape
23 fitting portion
24 fitting cover main body portion
25 seal receiving surface
31 seal member
32 seal main body portion
33 flange portion
33a through-hole
41 terminal
42 pin
43 pin holding portion
110 mating connector
111 mating terminal
112 mating housing
113 mating cable
115 first waterproof member
116 second waterproof member
120 connector assembly
211 circuit board
213 locked portion
214 cover member
215 protrusion
216 cover member penetration hole
221 fitting cover
222 lock claw (lock portion)
222a claw shape
311 circuit board
313 lining portion
314 locked portion
321 fitting cover
322 lock hole (lock portion)
441 terminal
443 pin holding portion
511 circuit board
513 locked portion
513a rail groove
513b rail groove
513c guide hole
513d guide groove
514 cover member
518 temporary circuit board
521 fitting cover
522 lock claw (lock portion)
522a (front) lock claw (lock portion)
522b (rear) lock claw (lock portion)
523 lock piece (lock portion)
523c (left) lock piece (lock portion)
523d (right) lock piece (lock portion)
611 circuit board
612 plane conductor
612A terminal forming portion
612B extension portion
613 lining portion
614 locked portion
615 connection portion
620 connector assembly
621 fitting cover
622 lock claw (lock portion)
622a claw shape
623 fitting portion
624 fitting cover main body portion
625 seal receiving surface
626 holding hole (holding portion)
627 hooked portion
631 seal member
632 seal main body portion
633 flange portion
633a through-hole
650 metal terminal
651 contact portion
652 held portion
653 projection
654 hook portion
655 mating terminal contact portion
711 circuit board
713 lining portion
713a outer locked piece (locked portion)
713b inner locked piece (locked portion)
714 cover member
715 protrusion
716 cover member penetration hole
721 fitting cover
722 lock claw (lock portion)
722a outer claw shape
722b inner claw shape
811 circuit board
812 plane conductor
812A terminal forming portion
812B extension portion
813 lining portion
814 locked portion
815 connection portion
821 fitting cover
822 lock claw (lock portion)
822a claw shape
823 fitting portion
824 fitting cover main body portion
824d first receiving portion
824e second receiving portion
824f third receiving portion
824g fourth receiving portion
826 holding hole (holding portion)
827 hooked portion
828 positioning claw
850 metal terminal
851 contact portion
852 held portion
853 projection
854 hook portion
855 mating terminal contact portion
856 wing portion
861 first insulator
861a first supporting portion
861b second insulator insertion hole
861c joint piece
861d first edge
861e second edge
862 second insulator
862a second supporting portion
862b insertion piece
862c joint piece receiving portion
862f third edge
862g fourth edge
910 mating connector
911 mating terminal
912 mating housing
913 mating cable
915 first waterproof member
916 second waterproof member

1. A board waterproofing connector comprising:
a circuit board having a flexible plane conductor;
a fitting cover having a fitting portion into which a mating connector is adapted to be fitted; and
a seal member that demonstrates a sealing property and that is sandwiched between the circuit board and the fitting cover, wherein:
the fitting cover has a lock portion attached to the circuit board;
the circuit board has a locked portion onto which the lock portion is locked; and
in a state wherein the seal member is sandwiched between the circuit board and the fitting cover, the lock portion of the fitting cover is locked onto the locked portion of the circuit board such that the seal member waterproofs a space between the circuit board and the fitting cover.

2. The board waterproofing connector according to claim 1, wherein
the circuit board has a lining portion on a surface opposite to another surface on which the fitting cover is arranged, and
the locked portion is formed at a side where the lining portion is arranged.

3. The board waterproofing connector according to claim 1, wherein
the circuit board has a cover member on a surface opposite to another surface on which the fitting cover is arranged, and
the locked portion is formed in the cover member.

4. The board waterproofing connector according to claim 1, wherein
the lock portion of the fitting cover is a lock claw having a claw shape.

5. The board waterproofing connector according to claim 1, wherein
the seal member is formed of a rubber material, a plastic material, or an elastomeric material.

6. The board waterproofing connector according to claim 1, wherein
the seal member has a through-hole into which the lock portion is inserted.

7. The board waterproofing connector according to claim 1, wherein
the fitting cover and the seal member are formed as a single piece by two-color molding.

8. The board waterproofing connector according to claim 3, wherein
the cover member has a protrusion protruding toward the plane conductor, and
the protrusion presses the seal member against the plane conductor.

9. A board waterproofing connector comprising:
a circuit board having a flexible plane conductor;
a metal terminal contacting the plane conductor;
a fitting cover having a fitting portion into which a mating connector is adapted to be fitted, and having a holding portion that holds the metal terminal inside the fitting cover; and
a seal member that demonstrates a sealing property and that is sandwiched between the circuit board and the fitting cover, wherein:
the fitting cover has a lock portion attached to the circuit board;
the circuit board has a locked portion onto which the lock portion is locked;
the metal terminal has a held portion held by the holding portion, and a contact portion having a spring property and contacting the plane conductor; and
in a state wherein the held portion of the metal terminal is held by the holding portion of the fitting cover and the seal member is sandwiched between the circuit board and the fitting cover, the lock portion of the fitting cover is locked onto the locked portion of the circuit board such that the seal member waterproofs a space between the circuit board and the fitting cover while maintaining contact between the contact portion of the metal terminal and the plane conductor through the spring property of the contact portion.

10. The board waterproofing connector according to claim 9, wherein:
the holding portion is a holding hole, into which the metal terminal is inserted and having a hooked portion onto which the metal terminal is hooked;
the held portion of the metal terminal has a projection press-fitted into the holding hole and a hook portion hooked onto the hooked portion; and
the metal terminal is inserted into the holding hole to press-fit the projection into the holding hole and to hook the hook portion onto the hooked portion, so that the metal terminal is held inside the fitting cover.

11. The board waterproofing connector according to claim 9, wherein
the fitting cover is formed integrally with the holding portion.

12. The board waterproofing connector according to claim 9, wherein
the fitting cover includes at least a fitting cover main body portion including the fitting portion, a first insulator including the holding portion, and a second insulator joined to the first insulator, and
in a state wherein the held portion of the metal terminal is held by the holding portion of the first insulator, the second insulator is jointed to the first insulator to form an insulator joint body, and the insulator joint body is inserted in the fitting cover main body portion.

13. The board waterproofing connector according to claim 12, wherein
the metal terminal substantially has an L shape, has the contact portion on one end side, and has the held portion on another end side, and
a straight portion of the metal terminal on the one end side is sandwiched between the first insulator and the second insulator to support the metal terminal.

14. The board waterproofing connector according to claim 9, wherein
the circuit board has a lining portion on a surface opposite to another surface on which the fitting cover is arranged, and
the locked portion is formed at a side where the lining portion is arranged.

15. The board waterproofing connector according to claim 9, wherein
the circuit board has a cover member on a surface opposite to another surface on which the fitting cover is arranged, and
the locked portion is formed in the cover member.

16. The board waterproofing connector according to claim 9, wherein
the lock portion of the fitting cover is a lock claw having a claw shape.

17. The board waterproofing connector according to claim 9, wherein
the seal member is formed of a rubber material, a plastic material, or an elastomeric material.

18. The board waterproofing connector according to claim 9, wherein
the seal member has a through-hole into which the lock portion is inserted.

19. The board waterproofing connector according to claim 9, wherein
the fitting cover and the seal member are formed as a single piece by two-color molding.

20. The board waterproofing connector according to claim 15, wherein
the cover member has a protrusion protruding toward the plane conductor, and
the protrusion presses the seal member against the plane conductor.
